(19) United States
(12) Patent Application Publication
(10) Pub. No.: US 2025/0333241 A1
(43) Pub. Date: Oct. 30, 2025

(54) RADAR-BASED IN-CABINET WASTE-RECEIVING SYSTEM

(71) Applicant: simplehuman, LLC, Torrance, CA (US)

(72) Inventors: Jay PATEL, Buena Park, CA (US); Yan Pui CHAN, Alhambra, CA (US)

(21) Appl. No.: 19/190,514

(22) Filed: Apr. 25, 2025

Related U.S. Application Data
(60) Provisional application No. 63/639,519, filed on Apr. 26, 2024.

(51) Int. Cl. B65F 1/14; B65F 1/16

(52) U.S. Cl. CPC B65F 1/1421; B65F 1/1436; B65F 1/1638; B65F 2210/168

(57) ABSTRACT

A waste-receiving system positioned inside a cabinet can include a radar sensor and a proximity sensor to detect movement or the presence of an individual to determine whether to automatically move the waste-receiving system from a retracted or closed position inside the cabinet to an open or extended position that is at least partially outside the cabinet. For example, the radar sensor may be positioned to emit signals underneath the waste-receiving system. In response to the detection of an object, the waste-receiving system may move to an open or extended position. In response to the proximity sensor not detecting an object once the waste-receiving system is in the open or extended position, the waste-receiving system may move to a closed or retracted position.

### CROSS-REFERENCE

This application claims priority to U.S. Provisional Patent Application No. 63/639,519, filed Apr. 26, 2024 and titled “CONTAINER WITH RADAR AND MAGNET-BASED LID TRACKING.” In some aspects, this application relates to U.S. patent application Ser. No. 17/456,460, filed Nov. 24, 2021 and titled “BUILT-IN ELECTRONICALLY MOVABLE WASTE RECEPTACLES,” to U.S. Pat. No. 9,856,080, issued on Jan. 2, 2018 and titled “CONTAINERS WITH MULTIPLE SENSORS,” to U.S. Pat. No. 9,586,755, issued on Mar. 7, 2017 and titled “DUAL SENSING RECEPTACLES,” to U.S. Provisional Patent Application No. 62/304,076, filed Mar. 4, 2016 and titled “DUAL SENSING RECEPTACLES,” to U.S. Pat. No. 9,751,692, issued on Sep. 5, 2017 and titled “DUAL SENSING RECEPTACLES,” and to U.S. Provisional Patent Application No. 61/953,402, filed Mar. 14, 2014 and titled “DUAL SENSING RECEPTACLE.” The disclosures of each of the aforementioned applications are considered part of, and are incorporated by reference in, this application in their entireties.

### BACKGROUND

### Field

The present disclosure relates to a receptacle assembly or waste-receiving system, particularly to a trashcan assembly having a radar sensor for detecting movement or proximity of a user to activate a powered function, such as the opening or closing of a power-operated lid and/or the movement of a waste receptacle from a closed position inside a cabinet to an open position at least partially outside the cabinet. and the present disclosure also relates to tracking the position of the power-operated lid.

### Description of the Related Art

Receptacles that have a lid or that need to move from one location to another are used in a variety of different settings. For example, in both residential and commercial settings, trashcans often have lids for preventing the escape of contents or odors from the trashcan. Recently, trashcans with power-operated lids have become commercially available. Such trashcans can include a sensor that can trigger the trashcan lid to open.

### SUMMARY

A typical receptacle with a power-operated lid can automatically open or close the lid based on whether an individual is detected in proximity to the receptacle. For example, some typical receptacles use infrared sensors to detect the presence of a nearby individual. Specifically, the typical receptacle may include an infrared transmitter and an infrared receiver. The infrared transmitter may emit infrared light. If an individual is present near the receptacle and in front of the infrared transmitter (e.g., at a location that intersects the transmission path of the emitted infrared light), the emitted infrared light may be reflected off the individual and the reflected infrared light may be detected by the infrared receiver. Detection of the reflected infrared light by the infrared receiver may then cause the receptacle to open the lid (e.g., if the lid is already closed) or keep the lid open (e.g., if the lid is already open). Conversely, if the infrared receiver does not detect reflected infrared light subsequent to the infrared transmitter emitting infrared light, then the receptacle may take no action (e.g., if the lid is already closed) or close the lid (e.g., if the lid is already open).

Infrared transmitters and receivers used in receptacles, however, have limited capabilities. Specifically, infrared transmitters generally emit infrared light over a narrow spatial range (e.g., 5°, 10°, 15°, etc.). If an infrared transmitter and receiver is placed on a front face of the receptacle such that light is emitted perpendicular to the front face of the receptacle, the infrared receiver may be able to detect infrared light reflected off individuals in front of the front face of the receptacle. However, infrared light emitted by the infrared transmitter may not reflect off an individual standing to the side of the receptacle, standing behind the receptacle, or who has placed a hand above a top face of the receptacle, and therefore the infrared receiver may not detect reflected infrared light in such circumstances. It may be desirable to open the lid of the receptacle even when an individual is not standing directly in front of the front face of the receptacle. To achieve this functionality, a typical receptacle may need to be equipped with multiple infrared transmitters and/or receivers that are pointed in different directions and/or angles (e.g., perpendicular to a front face of the receptacle, at a 45° to a front face and/or top face of the receptacle, perpendicular to a top face of the receptacle, etc.).

In some circumstances, the form factor of a receptacle, an expected placement of a receptacle, an expected usage of a receptacle, or other design considerations may limit the dimensions of the receptacle. If the receptacle relies on infrared light to detect individuals to open or close a lid, the limited dimensions of the receptacle may reduce the amount of space within the receptacle that can be allocated to infrared transmitters and/or receivers. As a result, a receptacle may be equipped with a limited number of infrared transmitters and/or receivers, and therefore the receptacle may only be able to detect individuals that are located in certain locations. Ultimately, users of the receptacle may experience performance issues if such users attempt to cause the receptacle to detect their presence while standing or sitting in a location in which infrared light coverage is limited.

Accordingly, described herein is an improved receptacle that uses a radar sensor in place of infrared transmitters and receivers to detect the presence or movement of an individual in close proximity to the receptacle. The radar sensor may include a signal processing unit, a single transmit antenna and one or more receive antennas (e.g., 1, 2, 3, 4, etc.) on a single chip or printed circuit board (PCB). The transmit antenna of the radar sensor may be capable of emitting a signal in some or all directions outward from the PCB, and the receive antenna(s) may be positioned to detect reflected signals originating from different angles and/or directions. Thus, when inserted into a receptacle, the receive antenna(s) of the radar sensor may be capable of detecting the presence or movement of an individual in front of the front face of the receptacle, in front of a side face of the receptacle, in a corner zone in front of and to the side of the receptacle, above a top face of the receptacle, in front of the back face of the receptacle, and/or any position in between. The improved receptacle with the radar sensor described herein may therefore be capable of more accurately and more completely identifying the presence or movement of an individual compared to receptacles that include infrared transmitters and receivers, especially when space inside the receptacle dedicated to presence detection is limited. In fact, because a single radar sensor may be sufficient to detect the presence or movement of an individual in a three-dimensional space that surrounds the receptacle, design considerations that result in a receptacle with constrained dimensions may not hinder the ability of the receptacle to accurately identify the presence or movement of an individual that desires to open a lid of the receptacle.

In some cases, an individual may accidentally or intentionally try to manually close or open the lid of a typical receptacle with a power-operated lid. However, manually closing the lid when the motor has opened or is in the process of opening the lid acts against the operation of the motor and can damage components of the lid driver of a typical receptacle. For example, when the motor is opening the lid, the motor encourages arms in a typical receptacle to abut against and turn flanges in a first direction. Yet, when a user manually attempts to close the lid, the lid and the flanges are encouraged to rotate in a second direction opposite the first direction. In this scenario, the arms are being encouraged to rotate in opposite directions concurrently, which can damage a clutch member, a shaft, and/or a motor that work to open and close the lid.

To avoid such damage, one option implemented in a typical receptacle is to have a clutch member be configured to rotate relative to an end member or other component, such that manual operation of the lid in theory does not damage (e.g., strip or wear down) components of the lid driver. Another option for avoiding such damage implemented in a typical receptacle is to have the driver drive the lid movement with an electronic dynamic position detector like a potentiometer instead of with the clutch member.

While using a clutch member or a potentiometer should in theory reduce the likelihood of damage to the motor or other components of the driver in a situation in which the lid is moved manually, the clutch member or potentiometer are sometimes themselves damaged due to their direct or indirect contact with the lid and the force by which an individual holds, closes, or opens the lid. The potentiometer in particular may be in mechanical communication with the shaft, which directly or indirectly engages with the lid to open or close the lid. Rotation of the shaft may cause an internal resistance of the potentiometer to change. Thus, when the shaft is rotated to cause movement of the lid and the lid moves in turn, this also results in an internal resistance of the potentiometer changing and a voltage output by the potentiometer changing. As a result, the voltage values produced by the potentiometer correlate with the position of the lid. Thus, even if an individual manually moves the lid, the controller can use the voltage values produced by the potentiometer to determine when to activate or deactivate the motor when opening or closing the lid. Damage to the clutch member or potentiometer, however, may cause the potentiometer to output incorrect voltage values and/or to no longer output any voltage values, thereby preventing the controller of a typical receptacle from accurately identifying a location of a lid. This can result in the motor being engaged to open or close the lid and continue operation even when the lid is already fully opened or closed. Continuous operation of the motor to close the lid while the lid is already fully closed or to open the lid while the lid is already fully opened can damage the motor, the driver, the lid, and/or other components of the receptacle.

Accordingly, described herein is an improved receptacle that uses a contactless method for identifying the location of the lid. Specifically, the improved receptacle can include a magnet that resides in a lid lifter. A clutch may be internal to the lid lifter and coupled to the motor. The clutch may rotate based on a command received to open or close the lid. Based on a rotation of the clutch, the lid lifter may turn and open or close the lid of the receptacle. Given that the lid lifter turns during the opening or closing of the lid, the magnet that resides internal to the lid lifter may turn or rotate as well. The improved receptacle may further include a magnetic sensor in the controller that detects the magnetic field generated by the magnet. The magnetic sensor and the magnet may not be coupled to each other. In other words, there may be no contact between the magnetic sensor and the magnet. The magnetic sensor may remain stationary when the lid lifter turns and opens or closes the lid. Thus, as the magnet turns, the magnetic sensor may detect changes in the magnetic field given the changing positions of the magnet relative to the magnetic sensor. The value of the magnetic field generated by the magnet and detected by the magnetic sensor may correlate with a position of the lid, and therefore the controller can use measurements captured by the magnetic sensor to determine accurately the position of the lid. The magnet and magnetic sensor themselves may not be in contact, and the magnetic sensor may not be coupled in any way to the lid. Thus, the component that is used to detect the position of the lid—the magnetic sensor—is not in contact with or coupled to the lid or any other component that moves in response to a command to open or close the lid. Accordingly, any force applied to the lid by an individual who manually moves the lid would not cause damage to the magnetic sensor given the lack of contact between the two components, and therefore the magnetic sensor can continue to generate magnetic field measurements that provide an accurate indication of the location of the lid no matter how and with what force an individual interacts with the lid.

Another aspect of the disclosure provides a trashcan assembly comprising: a body portion; a lid portion pivotably coupled with the body portion; a radar sensor; and a controller comprising a hardware processor and memory, wherein instructions stored in the memory, when executed by the hardware processor, cause the hardware processor to: cause a first level of power to be supplied to the radar sensor; instruct the radar sensor to enter a ready mode, wherein the radar sensor emits a first radar signal in response to the instruction to enter the ready mode; process an input received from the radar sensor that indicates that the radar sensor detects a movement or a presence of an object; and transmit an instruction to a power-operated driver, wherein the instruction causes the power-operated driver to move the lid portion from a first position to a second position.

The trashcan assembly of the preceding paragraph can include any sub-combination of the following features: where the instructions, when executed, further cause the hardware processor to: cause a second level of power to be supplied to the radar sensor, and instruct the radar sensor to enter a hyper mode, wherein the radar sensor emits a second radar signal that, at a first position external to the trashcan assembly, has a higher signal strength than the first radar signal; where the instructions, when executed, further cause the hardware processor to: process a second input received from the radar sensor that indicates that the radar sensor does not detect the movement or the presence of the object subsequent to emission of the second radar signal, and transmit a second instruction to the power-operated driver, wherein the second instructions causes the power-operated driver to move the lid portion from the second position to the first position; where the instructions, when executed, further cause the hardware processor to: process a second input received from the radar sensor that indicates that the radar sensor detects the movement or the presence of the object subsequent to emission of the second radar signal, and transmit the instruction to the power-operated driver in response to reception of the second input; where the trashcan assembly further comprises a backside enclosure coupled with a rear of the body portion, wherein the backside enclosure includes the radar sensor and the controller; where the backside enclosure comprises a center portion and a right portion, wherein the right portion is to the right of the center portion with respect to a front face of the trashcan assembly, and wherein the radar sensor is positioned in the right portion; where a bottom surface of the radar sensor is positioned at an angle between 40 degrees to 50 degrees with respect to an axis that is parallel to ground; where the radar sensor comprises a transmit antenna and a plurality of receive antennas; where each receive antenna in the plurality of receive antennas is oriented in a different direction; where the input comprises one of a high signal or an indication of a location of the object; where the first position comprises a closed position, and wherein the second position comprises an open position; and where the first position comprises an open position, and wherein the second position comprises a closed position; where the instructions, when executed, further cause the hardware processor to: cause the radar sensor to lower a minimum signal strength used to determine whether to process a reflected signal, and instruct the radar sensor to enter a hyper mode, wherein the radar sensor uses the lowered minimum signal strength to determine whether the radar sensor detects the movement or the presence of the object.

Another aspect of the disclosure provides a method for operating a lid portion of a trashcan assembly. The method comprises: causing a first level of power to be supplied to a radar sensor of the trashcan assembly, wherein the trashcan assembly further comprises a body portion, a lid portion pivotably coupled with the body portion, and a controller, and wherein the controller comprises a hardware processor and memory; instructing the radar sensor to enter a ready mode, wherein the radar sensor emits a first radar signal in response to the instruction to enter the ready mode; processing an input received from the radar sensor that indicates that the radar sensor detects a movement or a presence of an object; and transmitting an instruction to a power-operated driver, wherein the instruction causes the power-operated driver to move the lid portion from a first position to a second position, said method performed under control of instructions executed by the hardware processor.

The method of the preceding paragraph can include any sub-combination of the following features: where the method further comprises: causing a second level of power to be supplied to the radar sensor, and instructing the radar sensor to enter a hyper mode, wherein the radar sensor emits a second radar signal that, at a first position external to the trashcan assembly, has a higher signal strength than the first radar signal; where the method further comprises: processing a second input received from the radar sensor that indicates that the radar sensor does not detect the movement or the presence of the object subsequent to emission of the second radar signal, and transmitting a second instruction to the power-operated driver, wherein the second instructions causes the power-operated driver to move the lid portion from the second position to the first position; where transmitting an instruction to a power-operated driver further comprises: processing a second input received from the radar sensor that indicates that the radar sensor detects the movement or the presence of the object subsequent to emission of the second radar signal, and transmitting the instruction to the power-operated driver in response to reception of the second input; where the trashcan assembly further comprises a backside enclosure coupled with a rear of the body portion, wherein the backside enclosure includes the radar sensor and the controller; where the backside enclosure comprises a center portion and a right portion, wherein the right portion is to the right of the center portion with respect to a front face of the trashcan assembly, and wherein the radar sensor is positioned in the right portion; where a bottom surface of the radar sensor is positioned at an angle between 40 degrees to 50 degrees with respect to an axis that is parallel to ground; where the radar sensor comprises a transmit antenna and a plurality of receive antennas; where each receive antenna in the plurality of receive antennas is oriented in a different direction; where the input comprises one of a high signal or an indication of a location of the object; where the first position comprises a closed position, and wherein the second position comprises an open position; where the first position comprises an open position, and wherein the second position comprises a closed position; and where the method further comprises: causing the radar sensor to lower a minimum signal strength used to determine whether to process a reflected signal, and instructing the radar sensor to enter a hyper mode, wherein the radar sensor uses the lowered minimum signal strength to determine whether the radar sensor detects the movement or the presence of the object.

Another aspect of the disclose provides a trashcan assembly comprising: a body portion; a lid portion pivotably coupled with the body portion; a power-operated driver; a magnet coupled to the power-operated driver; and a controller comprising a magnetic sensor, a hardware processor, and memory, wherein the magnetic sensor does not directly contact the magnet, and wherein instructions stored in the memory, when executed by the hardware processor, cause the hardware processor to: process an input received from the magnetic sensor that comprises a measured magnetic field value, determine, based on a mapping stored in memory, a position of the lid portion that corresponds with the measured magnetic field value, and transmit an instruction to a power-operated driver in response to a determination that the position of the lid portion does not match a desired position of the lid portion, wherein the instruction causes the power-operated driver to move the lid portion from the position of the lid portion toward the desired position of the lid portion.

The trashcan assembly of the preceding paragraph can include any sub-combination of the following features: where the power-operated driver comprises a motor, and wherein the magnet is coupled to a portion of the motor that rotates when the motor is active; where the portion of the motor that rotates when the motor is active and the magnet are generally coaxial; where the power-operated driver further comprises a lid lifter and a spring pin, wherein a clutch is internal to the lid lifter; where the spring pin couples the clutch to the portion of the motor that rotates; where the lid lifter rotates in response to a rotation of the portion of the motor that rotates; where the lid lifter aligns with and mates to the lid portion, and wherein the lid lifter causes the lid portion to move in response to the rotation of the portion of the motor that rotates; where the magnet rotates in response to rotation of the portion of the motor that rotates; where the magnetic sensor remains stationary when the magnet rotates; where the magnetic sensor measures the magnetic field value based on a magnetic field generated by the magnet; where the instructions, when executed, further cause the hardware processor to: process a second input received from the magnetic sensor that comprises a second measured magnetic field value, wherein the second measured magnetic field value is measured by the magnetic sensor subsequent to the magnet rotating in response to movement of the lid portion, determine, based on the mapping stored in memory, a second position of the lid portion that corresponds with the second measured magnetic field value, and transmit a second instruction to the power-operated driver in response to a determination that the second position of the lid portion matches the desired position of the lid portion, wherein the second instruction causes the power-operated driver to cease movement of the lid portion; and where the instructions, when executed, further cause the hardware processor to process the input in response to a determination that the lid portion is to be moved to the desired position.

Another aspect of the disclosure provides a method for moving a lid portion of a trashcan assembly. The method comprises: receiving an input from a magnetic sensor that comprises a measured magnetic field value, wherein the trashcan assembly comprises a power-operated driver, a magnet coupled to the power-operated driver, and a controller that comprises the magnetic sensor, a hardware processor, and memory; determining, based on a mapping stored in memory, a position of the lid portion that corresponds with the measured magnetic field value; and transmitting an instruction to a power-operated driver in response to a determination that the position of the lid portion does not match a desired position of the lid portion, wherein the instruction causes the power-operated driver to move the lid portion from the position of the lid portion toward the desired position of the lid portion, said method performed under control of instructions executed by the hardware processor.

The method of the preceding paragraph can include any sub-combination of the following features: where the power-operated driver comprises a motor, and wherein the magnet is coupled to a portion of the motor that rotates when the motor is active; where the portion of the motor that rotates when the motor is active and the magnet are generally coaxial; where the power-operated driver further comprises a lid lifter and a spring pin, wherein a clutch is internal to the lid lifter; where the spring pin couples the clutch to the portion of the motor that rotates; where the lid lifter rotates in response to a rotation of the portion of the motor that rotates; where the lid lifter aligns with and mates to the lid portion, and wherein the lid lifter causes the lid portion to move in response to the rotation of the portion of the motor that rotates; where the magnet rotates in response to rotation of the portion of the motor that rotates; where the magnetic sensor remains stationary when the magnet rotates; where the magnetic sensor measures the magnetic field value based on a magnetic field generated by the magnet; where the method further comprises: receiving a second input from the magnetic sensor that comprises a second measured magnetic field value, wherein the second measured magnetic field value is measured by the magnetic sensor subsequent to the magnet rotating in response to movement of the lid portion, determining, based on the mapping stored in memory, a second position of the lid portion that corresponds with the second measured magnetic field value, and transmitting a second instruction to the power-operated driver in response to a determination that the second position of the lid portion matches the desired position of the lid portion, wherein the second instruction causes the power-operated driver to cease movement of the lid portion; and where receiving the input further comprises receiving the input in response to a determination that the lid portion is to be moved to the desired position.

Another aspect of the disclosure provides waste-receiving system comprising a waste receptacle. The waste-receiving system further comprises an electric drive system comprising a motor, the drive system configured to move the waste receptacle between a retracted position within a cabinet to an extended position at least partially outside of the cabinet. The waste-receiving system further comprises a radar sensor. The waste-receiving system further comprises a proximity sensor. The waste-receiving system further comprises a processor in electronic communication with the radar sensor, the proximity sensor, and the motor, wherein computer-executable code, when executed by the processor, causes the processor to: obtain a signal from the radar sensor indicating that an object is detected by the radar sensor; actuate the motor to move the waste receptacle to the extended position; determine that the proximity sensor does not detect a second object; and actuate the motor to move the waste receptacle to the retracted position.

The waste-receiving system of the preceding paragraph can include any sub-combination of the following features: where the waste-receiving system further comprises an outer door and a mount, wherein the mount is coupled to the outer door, the processor, and the proximity sensor; where the radar sensor comprises a transmit antenna and a receive antenna, and wherein the transmit antenna is oriented to emit a signal below the outer door when the waste receptacle is in the retracted position; where the waste-receiving system further comprises a casing positioned interior to the cabinet and a base coupled to the casing, wherein the radar sensor is coupled to a front bottom surface of the base; where the radar sensor is exposed to an exterior of the waste-receiving system; where the waste-receiving system further comprises a protective cover that encloses the radar sensor such that the radar sensor is hidden from view when the waste receptacle is in the retracted position; where the proximity sensor comprises a transmit antenna and a receive antenna, and wherein the transmit antenna is oriented to emit a signal upward from a top surface of the mount; where the waste-receiving system further comprises a base and sliding rails coupled to the base; where the sliding rails comprise an optical sensor and a marker associated with the optical sensor; where the computer-executable code, when executed, further causes the processor to: determine a current position of the waste receptacle based on a signal provided by the optical sensor, and actuate the motor to move the waste receptacle to the extended position based on the current position; where the computer-executable code, when executed, further causes the processor to: obtain the signal from the optical sensor that indicates that a first receiver of the optical sensor detected a first reflected signal, obtain a second signal from a second optical sensor adjacent to the optical sensor that indicates that a second receiver of the second optical sensor did not detect a second reflected signal, and determine that the current position of the waste receptacle corresponds to a location of the marker; where the computer-executable code, when executed, further causes the processor to: obtain the signal from the optical sensor that indicates that a first receiver of the optical sensor detected a first reflected signal, obtain a second signal from the optical sensor that indicates that a second receiver of the optical sensor that is adjacent to the first receiver and that is associated with a second marker did not detect a second reflected signal, and determine that the current position of the waste receptacle corresponds to a location of the marker; where the computer-executable code, when executed, further causes the processor to: determine a distance between the current position and the extended position, determine a time to reach the extended position from the current position based on the distance and a rotations per minute of the motor, and actuate the motor for the determined time; where the computer-executable code, when executed, further causes the processor to: determine a second optical sensor associated with the extended position, and actuate the motor until the second optical sensor provides a second signal indicating that a second object is detected by the second optical sensor; where the computer-executable code, when executed, further causes the processor to determine that the waste receptacle is in the retracted position prior to actuation of the motor to move the waste receptacle to the extended position; where the computer-executable code, when executed, further causes the processor to start a timer in response to actuation of the motor to move the waste receptacle to the extended position; where the computer-executable code, when executed, further causes the processor to determine that the proximity sensor does not detect a second object in response to the timer expiring; where the proximity sensor comprises a time-of-flight sensor; where the proximity sensor comprises an infrared sensor; and where the object comprises a foot of an individual, and wherein the second object comprises one of a torso, a hand, or an arm of the individual.

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No individual aspects of this disclosure are essential or indispensable.

### BRIEF DESCRIPTION OF THE DRAWINGS

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1 illustrates a rear perspective view of an embodiment of a receptacle assembly.

FIG. 2 illustrates a rear perspective view of an embodiment of a power-operated driver internal to the backside enclosure of the trashcan assembly shown in FIG. 1.

front elevation view of the receptacle assembly shown in FIG. 1.

FIG. 3 illustrates a rear perspective view of an embodiment of the power-operated driver of FIG. 2 with the driver cover removed for illustrative purposes.

FIG. 4 illustrates a top perspective view of an embodiment of the power-operated driver of FIG. 2 with the driver cover removed for illustrative purposes.

FIG. 5 illustrates a top perspective view of an embodiment of the power-operated driver of FIG. 2 with the driver cover removed and the lid lifter removed for illustrative purposes.

FIGS. 6-7 illustrate a side perspective view of an embodiment of the power-operated driver of FIG. 2 with the driver cover removed, the lid lifter removed, and the clutch removed for illustrative purposes.

FIG. 8 illustrates a side perspective view of an embodiment of the power-operated driver of FIG. 2 with the driver cover removed, the lid lifter removed, the clutch removed, and the PCB removed for illustrative purposes.

FIG. 9 illustrates an exploded view of an embodiment of the power-operated driver of FIG. 2.

FIG. 10 illustrates a cross-sectional view of an embodiment of the power-operated driver of FIG. 2 that depicts an orientation of the magnet during a state in which the lid portion is opened or closed.

FIG. 11 illustrates a rear perspective view of an embodiment of a trashcan assembly with a right rear portion of the backside enclosure of the trashcan receptacle removed for illustrative purposes.

FIG. 12 illustrates a top, rear perspective view of an embodiment of a trashcan assembly with a right rear portion of the backside enclosure of the trashcan receptacle removed for illustrative purposes.

FIG. 13 illustrates a top perspective view of an embodiment of a trashcan assembly with a right rear portion of the backside enclosure of the trashcan receptacle removed for illustrative purposes.

FIG. 14 illustrates a top perspective view of an embodiment of a trashcan assembly with a right rear and top portion of the backside enclosure of the trashcan receptacle removed for illustrative purposes.

FIG. 15 illustrates a rear perspective view of an embodiment of a trashcan assembly with a right rear and top portion of the backside enclosure of the trashcan receptacle removed for illustrative purposes.

FIG. 16 illustrates a front perspective view of an embodiment of a trashcan assembly that depicts a distance from the radar sensor to which signals transmitted by the radar sensor may reach with at least a minimum signal strength in a 3D space when the radar sensor is operating in the hyper mode of the sensing state.

FIG. 17 illustrates an example algorithm process of controlling the position of the lid portion.

FIG. 18 illustrates an example algorithm process of controlling the position of the lid portion.

FIG. 19 illustrates an example algorithm process of controlling the position of the lid portion.

FIG. 20 illustrates an example algorithm process of controlling movement of the lid portion once the controller determines to move the lid portion to an open position, a closed position, or a position in between.

FIG. 21A is a front perspective view of an example of a cabinet with an in-cabinet electronically movable waste-receiving system in a closed position and in an open position.

FIG. 21B is a front perspective view of the in-cabinet electronically movable waste-receiving system FIG. 21A, shown separate from the cabinet.

FIG. 21C is a side perspective view of an embodiment of an in-cabinet electronically movable waste-receiving system.

FIG. 22 is an illustration of a portion of an in-cabinet electronically movable waste receptacle of FIG. 21B depicting a lower portion of the system with a cover removed.

FIG. 23 shows another embodiment of the waste-receiving system.

FIG. 24 shows a front view of a portion of the mount, a front view of the base, and the radar sensor.

FIG. 25 shows a top view of the mount.

FIGS. 26A-26B depict one or more optical sensors of the sliding rails.

FIG. 27A illustrates an example algorithm process of controlling the position of the waste-receiving system using voice recognition.

FIG. 27B illustrates another example algorithm process of controlling the position of the waste-receiving system using voice recognition.

FIG. 28 illustrates an example algorithm process of controlling the position of the waste-receiving system using radar.

FIG. 29 illustrates an example algorithm process of controlling the position of the waste-receiving system using an optical sensor.

### DETAILED DESCRIPTION

The various embodiments of a system for opening and closing a lid or door of a receptacle, such as a trashcan, or other device, are disclosed in the context of a trashcan. The present disclosure describes certain embodiments in the context of a trashcan due to particular utility in this context. However, the subject matter of the present disclosure can be used in many other contexts as well, including, for example, commercial trashcans, doors, windows, security gates, and other larger doors or lids, as well as doors or lids for smaller devices such as high precision scales, computer drives, etc. The embodiments and/or components thereof can be implemented in powered or manually operated systems.

It is also noted that the examples may be described as a process, such as by using a flowchart, a flow diagram, a finite state diagram, a structure diagram, or a block diagram. Although these examples may describe the operations as a sequential process, many of the operations can be performed in parallel, or concurrently, and the process can be repeated. In addition, the order of the operations may be different than is shown or described in such descriptions. A process is terminated when its operations are completed. A process may correspond to a method, a function, a procedure, a subroutine, a subprogram, etc. When a process corresponds to a software function, its termination can correspond to a return of the function to the calling function or the main function. Any step of a process can be performed separately or combined with any other step of any other process.

A typical receptacle with a power-operated lid can automatically open or close the lid based on whether an individual is detected in proximity to the receptacle. For example, some typical receptacles use infrared sensors to detect the presence of a nearby individual. Specifically, the typical receptacle may include an infrared transmitter and an infrared receiver. The infrared transmitter may emit infrared light. If an individual is present near the receptacle and in front of the infrared transmitter (e.g., at a location that intersects the transmission path of the emitted infrared light), the emitted infrared light may be reflected off the individual and the reflected infrared light may be detected by the infrared receiver. Detection of the reflected infrared light by the infrared receiver may then cause the receptacle to open the lid (e.g., if the lid is already closed) of keep the lid open (e.g., if the lid is already open). Conversely, if the infrared receiver does not detect reflected infrared light subsequent to the infrared transmitter emitting infrared light, then the receptacle may take no action (e.g., if the lid is already closed) or close the lid (e.g., if the lid is already open).

Infrared transmitters and receivers used in receptacles, however, have limited capabilities. Specifically, infrared transmitters generally emit infrared light over a narrow spatial range (e.g., 5°, 10°, 15°, etc.). If an infrared transmitter and receiver is placed on a front face of the receptacle such that light is emitted perpendicular to the front face of the receptacle, the infrared receiver may be able to detect infrared light reflected off individuals in front of the front face of the receptacle. However, infrared light emitted by the infrared transmitter may not reflect off an individual standing to the side of the receptacle, standing behind the receptacle, or who has placed a hand above a top face of the receptacle, and therefore the infrared receiver may not detect reflected infrared light in such circumstances. It may be desirable to open the lid of the receptacle even when an individual is not standing in front of the front face of the receptacle. To achieve this functionality, a typical receptacle may need to be equipped with multiple infrared transmitters and/or receivers that are pointed in different directions and/or angles (e.g., perpendicular to a front face of the receptacle, at a 45° to a front face and/or top face of the receptacle, perpendicular to a top face of the receptacle, etc.).

In some circumstances, the form factor of a receptacle, an expected placement of a receptacle, an expected usage of a receptacle, or other design considerations may limit the dimensions of the receptacle. If the receptacle relies on infrared light to detect individuals to open or close a lid, the limited dimensions of the receptacle may reduce the amount of space within the receptacle that can be allocated to infrared transmitters and/or receivers. As a result, a receptacle may be equipped with a limited number of infrared transmitters and/or receivers, and therefore the receptacle may only be able to detect individuals that are located in certain locations. Ultimately, users of the receptacle may experience performance issues if such users attempt to cause the receptacle to detect their presence while standing or sitting in a location in which infrared light coverage is limited.

Accordingly, described herein is an improved receptacle that uses a radar sensor in place of or in addition to infrared transmitters and receivers to detect the presence or movement of an individual in close proximity to the receptacle. The radar sensor may include a signal processing unit, a single transmit antenna and one or more receive antennas (e.g., 1, 2, 3, 4, etc.) on a single chip or printed circuit board (PCB). The transmit antenna of the radar sensor may be capable of emitting a signal in some or all directions outward from the PCB, and the receive antenna(s) may be positioned to detect reflected signals originating from different angles and/or directions. Thus, when inserted into a receptacle, the receive antenna(s) of the radar sensor may be capable of detecting the presence or movement of an individual in front of the front face of the receptacle, in front of a side face of the receptacle, in a corner zone in front of and to the side of the receptacle, above a top face of the receptacle, in front of the back face of the receptacle, and/or any position in between. The improved receptacle with the radar sensor described herein may therefore be capable of more accurately and more completely identifying the presence or movement of an individual compared to receptacles that include infrared transmitters and receivers, especially when space inside the receptacle dedicated to presence detection is limited. In fact, because a single radar sensor may be sufficient to detect the presence or movement of an individual in a three-dimensional space that surrounds the receptacle, design considerations that result in a receptacle with constrained dimensions may not hinder the ability of the receptacle to accurately identify the presence or movement of an individual that desires to open a lid of the receptacle.

In some cases, an individual may accidentally or intentionally try to manually close or open the lid of a typical receptacle with a power-operated lid. However, manually closing the lid when the motor has opened or is in the process of opening the lid acts against the operation of the motor and can damage components of the lid driver of a typical receptacle. For example, when the motor is opening the lid, the motor encourages arms in a typical receptacle to abut against and turn flanges in a first direction. Yet, when a user manually attempts to close the lid, the lid and the flanges are encouraged to rotate in a second direction opposite the first direction. In this scenario, the arms are being encouraged to rotate in opposite directions concurrently, which can damage a clutch member, a shaft, and/or a motor that work to open and close the lid.

To avoid such damage, one option implemented in a typical receptacle is to have a clutch member be configured to rotate relative to an end member or other component, such that manual operation of the lid in theory does not damage (e.g., strip or wear down) components of the lid driver. For example, the clutch member can include a first cam surface and a first return surface. The first cam surface can be inclined from a first level to a second level, in relation to a plane extending generally transverse to the longitudinal axis of the clutch member. The first return surface can intersect the first cam surface and can be disposed between the first and second levels.

The end member can include a second cam surface and a second return surface. The second cam surface can be inclined from a first level to a second level, in relation to a plane extending generally transverse to the longitudinal axis of the end member and the shaft. The second return surface can intersect the first cam surface and can be disposed between the first and second levels.

The second cam surface and the second return surface of the end member can be shaped to correspond with the first cam surface and the first return surface of the clutch member, thereby allowing mating engagement of the end member and the clutch member. For example, summits of the first cam surface can be nested in the valleys of the second cam surface, and summits of the second cam surface can be nested in the valleys of the first cam surface.

When the lid is manually operated, the first inclined cam surface can move relative to the second inclined cam surface. As the inclined cam surface slides relative to the second inclined cam surface, the summit of the first cam surface circumferentially approaches the summit of the second cam surface. The relative movement between the first and second inclined cam surfaces (e.g., by the interaction of the inclines) urges the clutch member away from the end member along the longitudinal axis of the shaft (e.g., in a direction generally toward the motor and against the bias of the biasing member). The end member can be generally restrained from moving longitudinally (e.g., by the fastener). Since the clutch member is displaced from the end member, manual operation of the lid can be performed in theory without imposing undue stress on, or damage to, components of the typical receptacle.

When manual operation of the lid ceases, the biasing member can return the clutch member into generally full engagement with the end member. Re-engaging the clutch member and the end member permits transmission of torque from the motor to the clutch member to drive lid movement.

Another option for avoiding such damage implemented in a typical receptacle is to have the driver drive the lid movement with an electronic dynamic position detector like a potentiometer instead of with the clutch member. For example, the driver can include the motor, a torque transfer system such as the shaft, fasteners, an adaptor, and an electronic dynamic position detector such as a potentiometer. The adaptor and the potentiometer can be positioned on or in mechanical communication with the shaft adjacent to the motor such that the adaptor and the potentiometer are generally coaxial.

As the motor is operating to open or close the lid, the driver may monitor for any friction or resistance that could indicate an obstruction or manual operation of the typical receptacle. Such friction or resistance may be detected by the motor, the potentiometer, the controller, and/or any other components of the driver. For example, the potentiometer may output a voltage to the controller. As the motor rotates the shaft, the shaft causes a change in resistance of the potentiometer, thereby resulting in a change in the voltage output by the potentiometer. Generally, as the lid is opened or closed, the voltage output by the potentiometer gradually changes in a constant direction (e.g., the voltage gradually increases or gradually decreases) given that the shaft rotates in a single direction until the lid is opened or closed. If an obstruction is present or a user attempts to manually control the typical receptacle, the gradual change in the voltage output by the potentiometer may be disrupted (e.g., the voltage may begin to increase when the voltage is expected to decrease, or the voltage may begin to decrease when the voltage is expected to increase, or the voltage may stay constant when the voltage is expected to increase or decrease, and/or the voltage may change more slowly than expected, etc.). When the controller detects such a disruption, the power to the motor can be modified, such as by shutting off the power and/or reversing the direction of the motor, or otherwise disabling the motor, thereby reducing the likelihood of damage to the components of the driver. When the motor is disabled, the movement of the lid may work against the internal friction of the motor (e.g., because the lid is rigidly coupled with the motor via the adaptor and the fasteners), thereby providing an inherent damping ability that reduces a speed at which the lid closes.

While using a clutch member or a potentiometer should in theory reduce the likelihood of damage to the motor or other components of the driver in a situation in which the lid is moved manually, the clutch member or potentiometer are sometimes themselves damaged due to their direct or indirect contact with the lid and the force by which an individual holds, closes, or opens the lid. The potentiometer in particular may be in mechanical communication with the shaft, which directly or indirectly engages with the lid to open or close the lid. Rotation of the shaft may cause an internal resistance of the potentiometer to change. Thus, when the shaft is rotated to cause movement of the lid and the lid moves in turn, this also results in an internal resistance of the potentiometer changing and a voltage output by the potentiometer changing. As a result, the voltage values produced by the potentiometer correlate with the position of the lid. Thus, even if an individual manually moves the lid, the controller can use the voltage values produced by the potentiometer to determine when to activate or deactivate the motor when opening or closing the lid. Damage to the clutch member or potentiometer, however, may cause the potentiometer to output incorrect voltage values and/or to no longer output any voltage values, thereby preventing the controller of a typical receptacle from accurately identifying a location of a lid. This can result in the motor being engaged to open or close the lid and continue operation even when the lid is already fully opened or closed. Continuous operation of the motor to close the lid while the lid is already fully closed or to open the lid while the lid is already fully opened can damage the motor, the driver, the lid, and/or other components of the receptacle.

Accordingly, described herein is an improved receptacle that uses a contactless method for identifying the location of the lid. Specifically, the improved receptacle can include a system in which the moving (e.g., rotating) components that open and close the lid do not directly contact the sensing components that determine the position of the moving components, such as by way of a magnet that resides in a lid lifter. A clutch may be internal to the lid lifter and coupled to the motor. The clutch may rotate based on a command received to open or close the lid. Based on a rotation of the clutch, the lid lifter may turn and open or close the lid of the receptacle. Given that the lid lifter turns during the opening or closing of the lid, the magnet that resides internal to the lid lifter may turn or rotate as well. The improved receptacle may further include a magnetic sensor in the controller that detects the magnetic field generated by the magnet. The magnetic sensor and the magnet may not be coupled to each other. In other words, there may be no contact between the magnetic sensor and the magnet. The magnetic sensor may remain stationary when the lid lifter turns and opens or closes the lid. Thus, as the magnet turns, the magnetic sensor may detect changes in the magnetic field given the changing positions of the magnet relative to the magnetic sensor. The value of the magnetic field generated by the magnet and detected by the magnetic sensor may correlate with a position of the lid, and therefore the controller can use measurements captured by the magnetic sensor to determine accurately the position of the lid. The magnet and magnetic sensor themselves may not be in direct contact, and the magnetic sensor may not be coupled in any direct way to the lid. Thus, the component that is used to detect the position of the lid—the magnetic sensor—is not in contact with, or coupled to, and/or does not move at the same time or in the same way as, the lid or any other component that moves in response to a command to open or close the lid. Accordingly, any force applied to the lid by an individual who manually moves the lid would not cause damage to the magnetic sensor given the lack of contact between the two components, and therefore the magnetic sensor can continue to generate magnetic field measurements that provide an accurate indication of the location of the lid no matter how and with what force an individual interacts with the lid.

### Magnet Overview

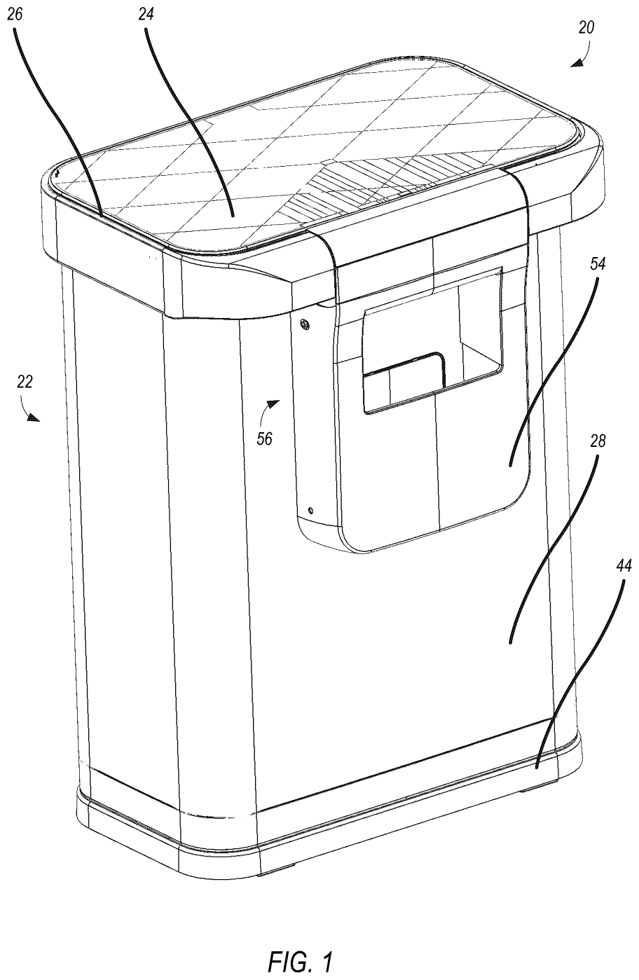

FIG. 1 illustrates a rear perspective view of an embodiment of a receptacle assembly 20. A receptacle can include a trashcan, a bin, a container, a box, and/or the like. For ease of explanation, the receptacle assembly 20 is referred to herein as a trashcan assembly 20.

As illustrated in FIG. 1, the trashcan assembly 20 can include a body portion 22 and a lid portion 24 pivotably attached to the body portion 22. The trashcan assembly 20 can rest on a floor and can be of varying heights and widths depending on, among other things, consumer need, cost, and ease of manufacture.

The trashcan assembly 20 can receive a bag liner (not shown), which can be retained at least partially within the body portion 22. For example, an upper peripheral edge 26 of the body portion 22 can support an upper portion of the bag liner such that the bag liner is suspended and/or restrained within the body portion 22. In some embodiments, the upper edge 26 of the body portion 22 can be rolled, include an annular lip, or otherwise include features that have a generally rounded cross-section and/or extend outwardly from a generally vertical wall of the body portion 22. The outward-extending, upper peripheral edge 26 can support the bag liner and prevent the bag liner from tearing near an upper portion of the bag liner. Although not shown, in some embodiments, the trashcan assembly 20 can include a liner support member supported by the body portion 22, which can support the bag liner.

FIG. 1 illustrates the body portion 22 having a generally rectangular configuration with a rear wall 28. However, other configurations can also be used, for example, a semi-circular configuration. The body portion 22 can be made from plastic, steel, stainless steel, aluminum, or any other material.

The pivotal connection between the body portion 22 and the lid portion 24 can be any type of connection allowing for pivotal movement, such as hinge elements, pins, or rods. For example, the lid portion 24 can pivot about pivot pins extending laterally through a backside enclosure 56. In some embodiments, biasing members, such as one or more torsion springs, can be positioned around the pins. The biasing members can provide a biasing force to assist in opening and/or closing the lid portion 24. This can reduce the amount of power consumed by a motor 78 (not shown in FIG. 1) when moving the lid portion 24 between the open and closed positions and/or can allow for the use a smaller motor (e.g., in dimensional size and/or in power output).

The trashcan assembly 20 can include a base portion 44. The base portion 44 can have a generally annular and curved skirt upper portion and a generally flat lower portion for resting on a surface, such as a kitchen floor. In some implementations, the base portion 44 can include plastic, metal (e.g., steel, stainless steel, aluminum, etc.), or any other material. In some implementations, the base portion 44 and the body portion 22 can be constructed from different materials. For example, the body portion 22 can be constructed from metal (e.g., stainless steel), and the base portion 44 can be constructed from a plastic material.

In some embodiments, the base portion 44 can be separately formed from the body portion 22. The base portion 44 can be connected with or attached to the body portion 22 using adhesive, welding, and/or connection components, such as hooks and/or fasteners (e.g., screws). For example, the base portion 44 can include hooked tabs that can connect with a lower edge (e.g., a rolled edge) of the body portion 22. The hooked tabs can engage the lower edge of the body portion 22 by a snap-fit connection.

The base portion 44 can include projections (not shown) that are open or vented to the ambient environment (e.g., thorough the generally flat lower portion of the base portion 44). Certain embodiments of the base portion 44 include a generally centrally located passage extending through the base portion 44.

In some embodiments, the trashcan assembly 20 can include a liner insert (not shown) positioned within the body portion 22. The liner insert can be secured to the base portion 44. For example, the liner insert can have support members that are joined with the base portion 44 (e.g., with fasteners, welding, etc.). The support members can support and/or elevate the liner insert above away from the base portion 44.

The liner insert can generally support and/or cradle a lower portion of a liner disposed in the trashcan assembly 20 to protect a bag liner from rupture or damage and retain spills. For instance, the liner insert can have a generally smooth surface to reduce the likelihood of the bag liner being torn or punctured by contact with the liner insert. The liner insert can be generally concave or bowl-shaped.

The liner insert can reduce the chance of damage to the bag liner even in trashcan assemblies 20 that do not utilize a generally rigid liner that extends along a majority of or all of the height of the body portion 22. In some embodiments, the height of the liner insert can be substantially less than the height of the body portion 22, positioning the uppermost surface of the liner insert substantially closer to the bottom of the trashcan assembly 20 than to the middle and/or top of the trashcan assembly 20. In some embodiments, the height of the liner insert can be less than or generally equal to about one-fourth of the height of the body portion 22. In certain embodiments, the height of the liner insert can be less than or generally equal to about one-eighth of the height of the body portion 22.

The liner insert can form a seal (e.g., generally liquid resistant) with a lower portion of the body portion 22. In some embodiments, the liner insert can include openings that are configured to correspond to, or mate with, the projections located on the interior bottom surface of the base portion 44, thereby placing the openings and the projections in fluid communication. By aligning the openings of the liner insert and the projections of the base portion 44, the openings can allow ambient air to pass into and out of the interior of the trashcan assembly. The openings can inhibit or prevent the occurrence a negative pressure region (e.g., in comparison to ambient) inside the trashcan assembly 20 when a user removes a bag liner from the trashcan assembly 20. Further, in certain variants, when a user inserts refuse or other materials into the bag liner in the trashcan assembly 20, air within the trashcan assembly 20 can exit via the openings and the projections. The openings can inhibit the occurrence of a positive pressure region (e.g., in comparison to ambient) inside the trashcan assembly 20 and allowing the bag liner to freely expand.

In some embodiments, the trashcan assembly 20 can include a backside enclosure 56 that can house a plurality of bag liners (not shown). A rear cover 54 can encase an open portion of the backside enclosure 56. An interior surface of the backside enclosure 56 can include an opening that provides access to the plurality of bag liners from the interior of the body portion 22. As with all embodiments in this specification, any structure, feature, material, step, and/or process illustrated or described in such application can be used in addition to or instead of any structure, feature, material, step, and/or process illustrated or described in this specification.

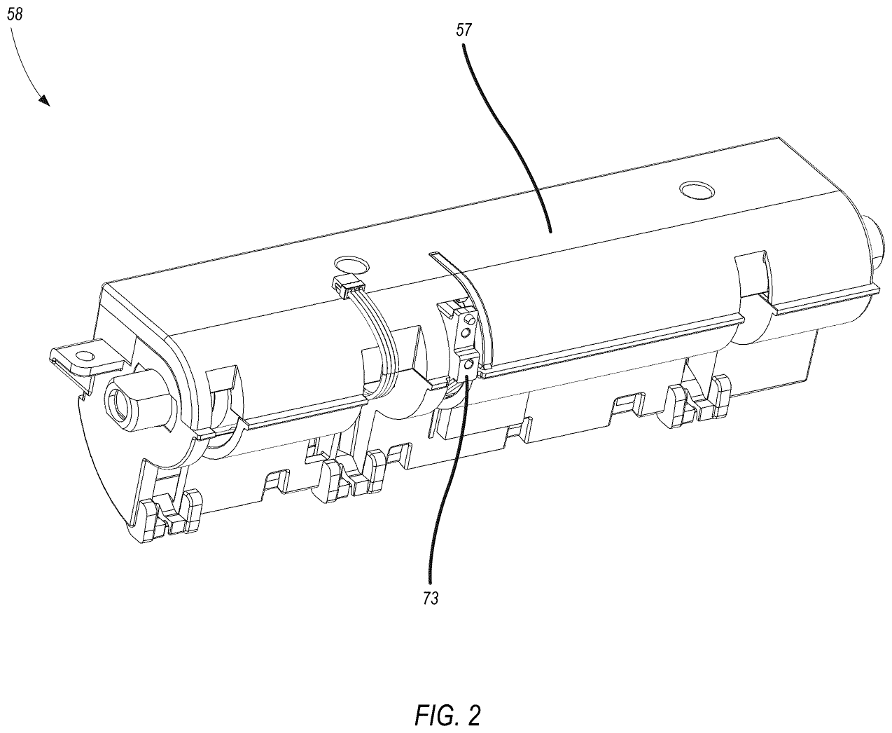

FIG. 2 illustrates a rear perspective view of an embodiment of a power-operated driver 58 internal to the backside enclosure 56 of the trashcan assembly 20 shown in FIG. 1. As illustrated in FIG. 2, the backside enclosure 56 can house a power source (not shown) and the power-operated driver 58 to drive movement of the lid portion 24. Alternatively, the power source may be internal to the power-operated driver 58. In some embodiments, the backside enclosure 56 can include a port 43 (e.g., a USB port, mini-USB port, or otherwise) for recharging the power source. In some embodiments, the backside enclosure 56 can include a power button (not shown) for turning on and off power to one or more features of the trashcan assembly 20. The power-operated driver 58 may include a driver cover 57 that houses components of the power-operated driver 58, such as a lid lifter 73 (described in greater detail below).

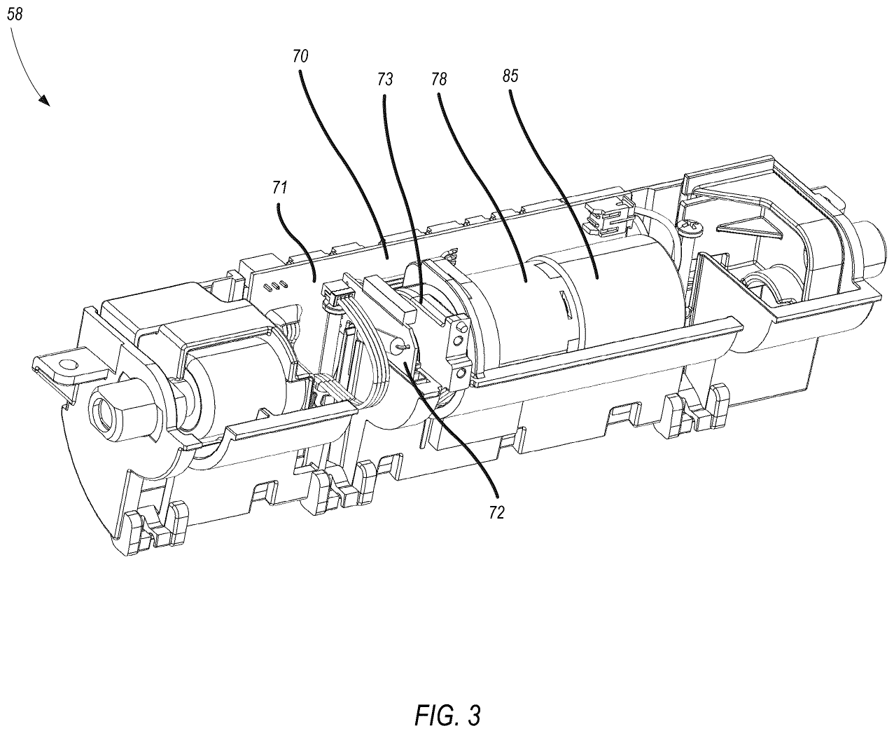

FIG. 3 illustrates a rear perspective view of an embodiment of the power-operated driver 58 of FIG. 2 with the driver cover 57 removed for illustrative purposes. As illustrated in FIG. 3, the power-operated driver 58 includes a controller 70, the lid lifter 73, a motor 78, and a motor sleeve 85. The controller 70 can control one or more features of the trashcan assembly 20, e.g., the motor 78. The controller 70 can include a first PCB 71, a second PCB 72, and/or zero or more other PCBs, which can provide hard-wired feedback control circuits, at least one processor and at least one memory device for storing and performing control routines, or any other type of controller. The first PCB 71 may be coupled to the second PCB 72 via a wired or wireless connection. In some embodiments, the first PCB 71 may include the processor and memory device, whereas the second PCB 72 may include a magnetic sensor (described in greater detail below). In other embodiments, the processor, the memory device, and the magnetic sensor can be included on one of the first PCB 71 or the second PCB 72, the processor and the magnetic sensor can be included on a PCB 71, 72 separate from a PCB 72, 71 that includes the memory device, or the memory device and the magnetic sensor can be included on a PCB 71, 72 separate from a PCB 72, 71 that includes the processor.

In some embodiments, the memory included in controller 70 may be a computer-readable media and may store one or more of any of the modules of software and/or hardware that are described and/or illustrated in this specification. The module(s) may store data values defining executable instructions. The one or more processors of controller 70 may be in electrical communication with the memory, and may be configured by executable instructions included in the memory to perform functions, or a portion thereof, of the trashcan assembly 20. For example, in some aspects, the memory may be configured to store instructions and algorithms that cause the processor to send a command to trigger at least one of the several modes of operation (e.g., ready mode, hyper mode, etc.) of the trashcan assembly 20, as described herein. As another example, in some aspects, the memory may be configured to store instructions and algorithms that cause the processor to send a command to trigger the motor 78 to move the lid portion 24 between the open and closed positions based at least in part on the detection of the presence of an individual, movement of an individual, and/or received voice commands, such as described herein.

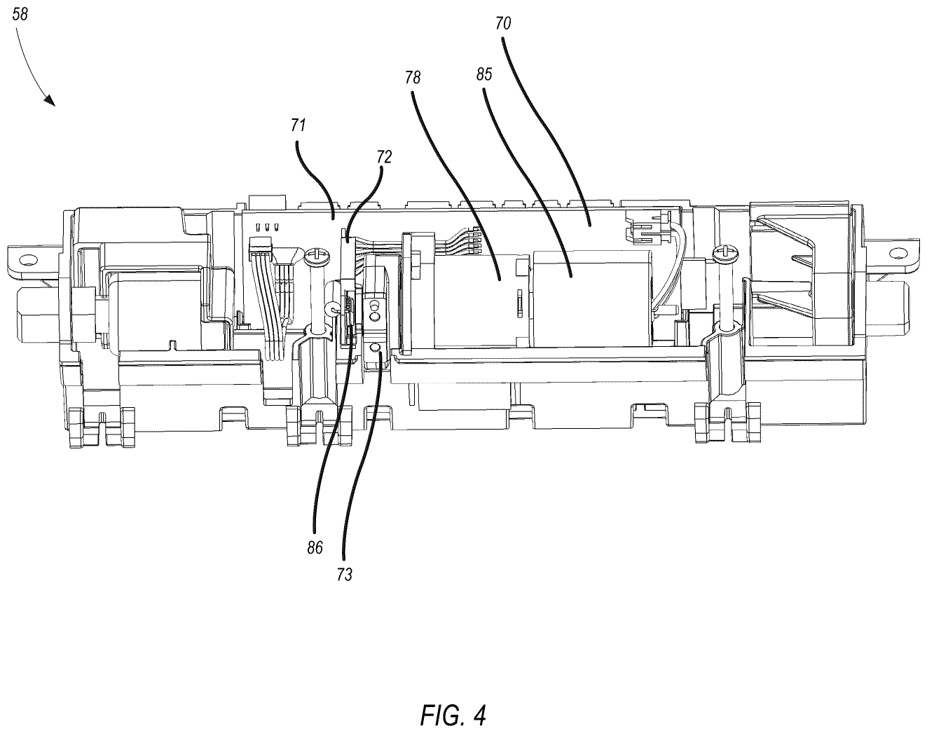

FIG. 4 illustrates a top perspective view of an embodiment of the power-operated driver 58 of FIG. 2 with the driver cover 57 removed for illustrative purposes. As illustrated in FIG. 4, the PCB 72 includes a magnetic sensor 86. The magnetic sensor 86 may be adjacent to, but not coupled with, the lid lifter 73.

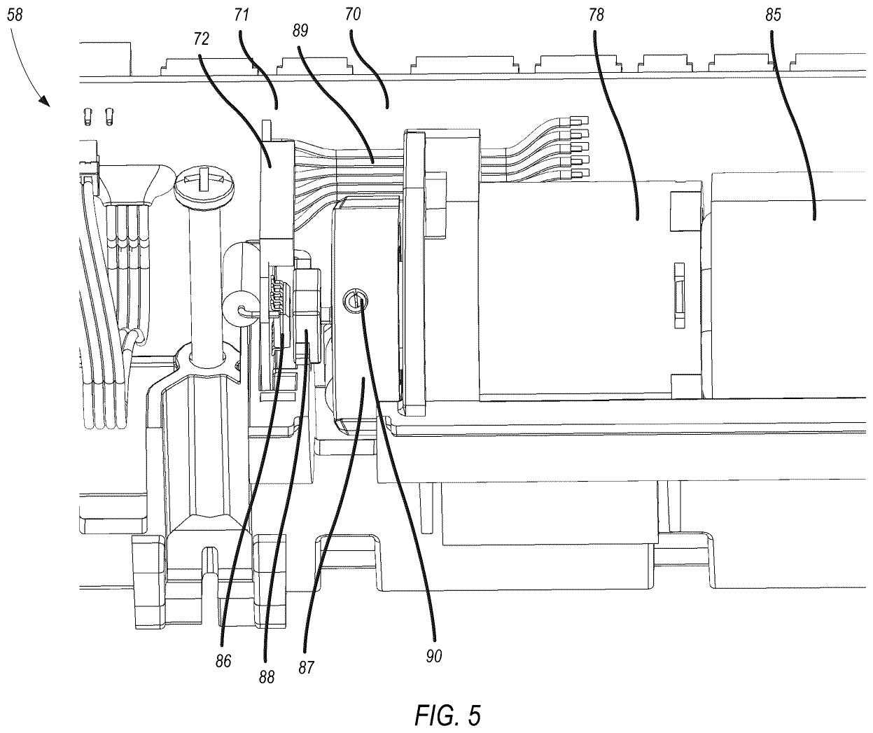

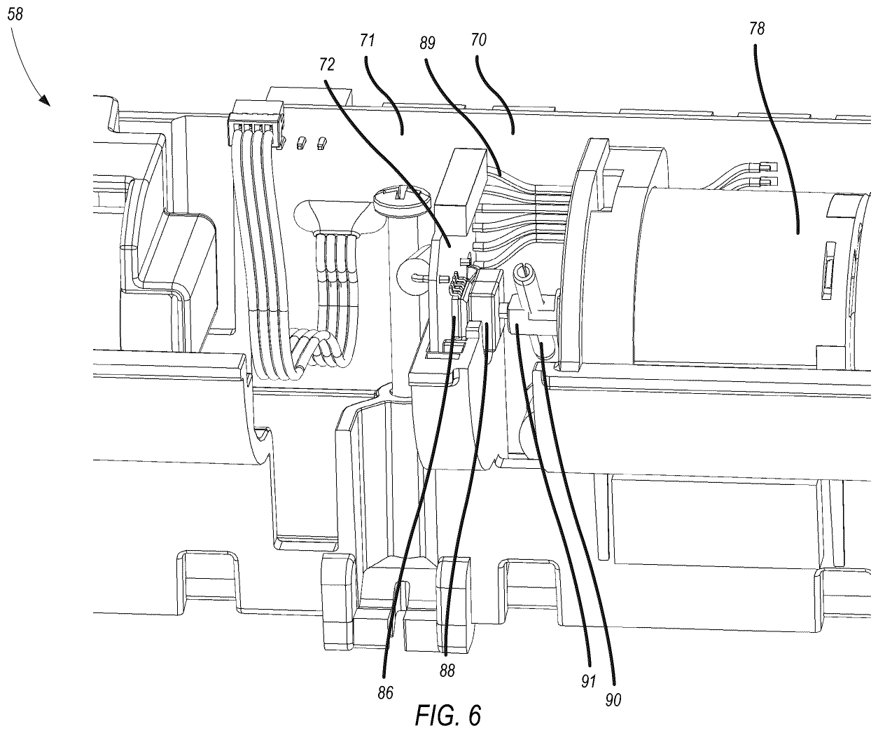

FIG. 5 illustrates a top perspective view of an embodiment of the power-operated driver 58 of FIG. 2 with the driver cover 57 removed and the lid lifter 73 removed for illustrative purposes. As illustrated in FIG. 5, a clutch 87 internal to the lid lifter 73 is coupled to the motor 78. The clutch 87 may be adjacent to, but not coupled with, the magnetic sensor 86. A spring pin 90 may be internal to the clutch 87 and may facilitate a coupling between the clutch 87 (and therefore the lid lifter 73) and the motor 78, which is shown in greater detail with respect to FIG. 6.

The clutch 87 may further be coupled to a magnet 88 internal to the lid lifter 73. Like the clutch 87, the magnet 88 may be adjacent to, but not coupled with, the magnetic sensor 86. As described in greater detail below, the magnet 88 may rotate when the motor 78 causes the clutch 87 (and therefore the lid lifter 73) to rotate. For example, the magnet 88 may rotate at the same speed as the clutch 87.

One or more wires 89 may couple the PCB 72 with the PCB 71. For example, the one or more wires 89 may allow for communication between the magnetic sensor 86 and the processor of the controller 70. Thus, the magnetic sensor 86 can transmit to the processor via the wire(s) 89 an indication of a value of a detected magnetic field.

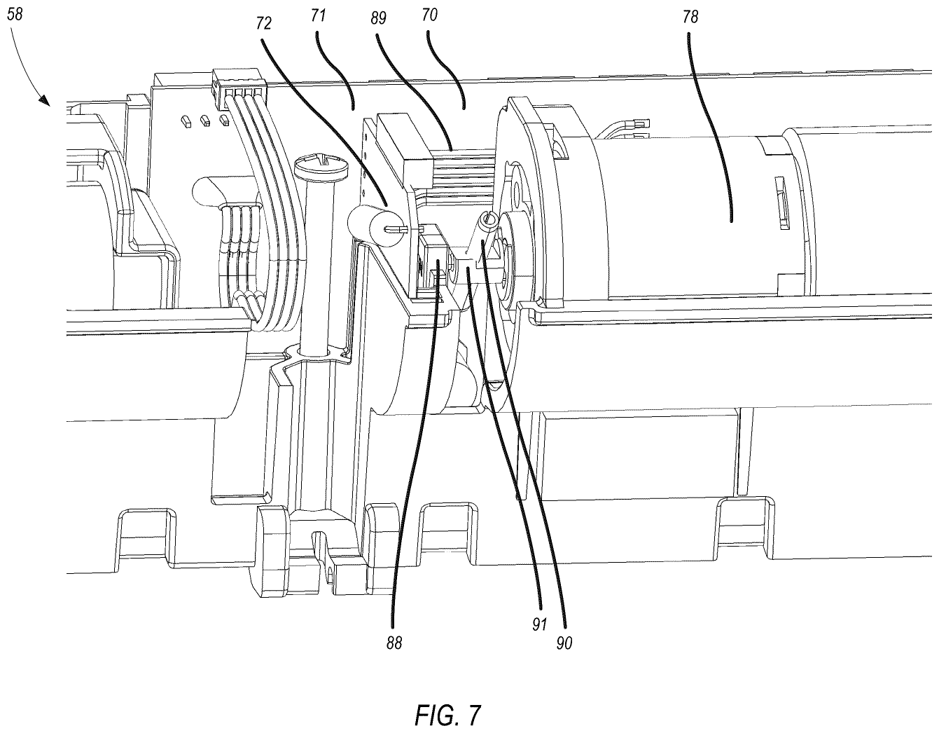

FIGS. 6-7 illustrate a side perspective view of an embodiment of the power-operated driver 58 of FIG. 2 with the driver cover 57 removed, the lid lifter 73 removed, and the clutch 87 removed for illustrative purposes. As illustrated in FIG. 6, the spring pin 90 is coupled to a portion 91 of the motor 78 that rotates when the motor 78 is activated. Thus, the spring pin 90 may rotate when the motor 78 is activated. Because the spring pin 90 is also coupled to the clutch 87 and creates mechanical communication between the clutch 87 (and therefore the lid lifter 73) and the motor 78, the clutch 87 (and therefore the lid lifter 73) may rotate when the motor 78 is activated. In addition, the lid lifter 73 may be aligned with and mate, abut, contact, receive, and/or be received by the lid portion 24. As a result, the lid lifter 73 may cause the lid portion 24 to rotate between an opened and closed position when the motor 78 is activated. The spring pin 90 may therefore allow for the lid lifter 73, the clutch 87, and the portion 91 of the motor 78 that rotates to be generally coaxial.

In addition, the magnet 88 may be coupled to the portion 91 of the motor 78 that rotates when the motor 78 is activated. Thus, the magnet 88 may rotate when the motor 78 is activated. The lid lifter 73, the clutch 87, the portion 91 of the motor 78 that rotates, and the magnet 88 may be generally coaxial.

While the lid lifter 73, the clutch 87, and the magnet 88 may rotate when the motor 78 is activated, the magnetic sensor 86 may remain stationary. If the magnet 88 is not rotating (e.g., because the motor 78 is deactivated and the lid portion 24 is in a closed, open, or partially open state), the magnetic sensor 86 may measure a constant magnetic field generated by the magnet 88. However, as the magnet 88 begins to rotate, the magnetic field measured by the magnetic sensor 86 may begin to change given that the magnetic sensor 86 is not rotating with the magnet 88.

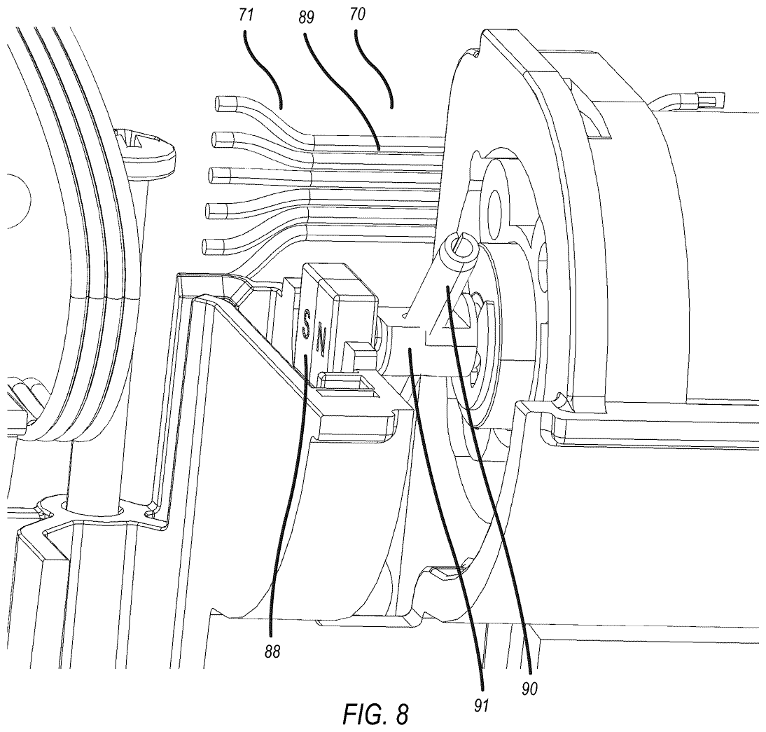

FIG. 8 illustrates a side perspective view of an embodiment of the power-operated driver 58 of FIG. 2 with the driver cover 57 removed, the lid lifter 73 removed, the clutch 87 removed, and the PCB 72 removed for illustrative purposes. As illustrated in FIG. 8, the magnet 88 may be oriented such that a south pole of the magnet 88 may be closer to the PCB 71 than a north pole of the magnet 88 when the lid portion 24 is in an opened or closed state. In some embodiments, each pole of the magnet 88 may be the same distance from a bottom of the power-operated driver 58. Alternatively, a south pole of the magnet 88 may be farther from the PCB 71 than a north pole of the magnet 88 when the lid portion 24 is in an opened or closed state. While FIG. 8 illustrates the magnet 88 as having a specific pole orientation when the lid portion 24 is in an opened or closed state, this is not meant to be limiting and orientation of the magnet 88 may be flipped along a horizontal and/or vertical axis, rotated at an angle between 0-360 degrees, and/or the like.

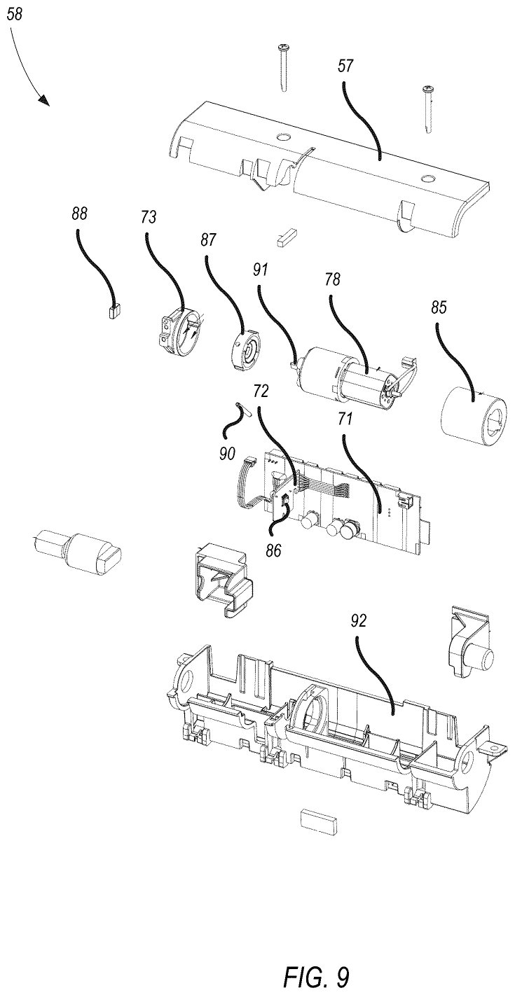

FIG. 9 illustrates an exploded view of an embodiment of the power-operated driver 58 of FIG. 2. As illustrated in FIG. 9, the power-operated driver 58 may include a base structure 92 that mates, abuts, contacts, and/or receives the PCB 71, the PCB 72, and/or the motor 78. The base structure 92 may hold the PCB 72 and the motor 78 in place such that the magnetic sensor 86 included on the PCB 72 and the magnet 88 in mechanical communication with the portion 91 of the motor 78 that rotates may be positioned adjacently and/or generally coaxial without any direct contact between the two components.

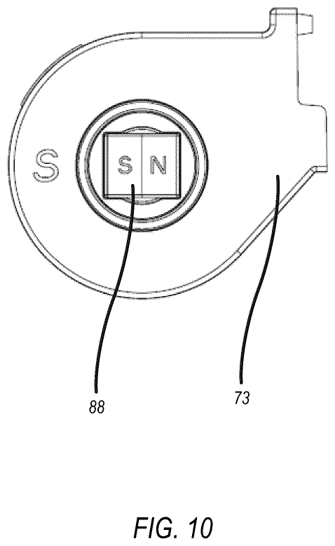

FIG. 10 illustrates a cross-sectional view of an embodiment of the power-operated driver 58 of FIG. 2 that depicts an orientation of the magnet 88 during a state in which the lid portion 24 is opened or closed. As illustrated in FIG. 10, the magnet 88 may be oriented such that the south pole of the magnet is closer to an interior of the trashcan receptacle 20 and the north pole of the magnet is closer to a rear end of the trashcan receptacle 20 when the lid portion 24 is opened or closed. The magnet 88 may rotate when the motor 78 is active, which may result in the orientation of the south pole and the north pole of the magnet 88 with respect to the interior and rear end of the trashcan receptacle 20 changing. However, the orientation of the poles of the magnet 88 with respect to the lid lifter 73 may remain constant given that both components may rotate at the same or similar speed and/or in a same direction when the motor 78 is active.

Prior to the trashcan assembly 20 being manufactured and/or distributed to a user, the controller 70 (e.g., the processor) may be calibrated to correlate magnetic field values received from the magnetic sensor 86 with a position of the lid portion 24. For example, the processor and/or the memory device may be programmed to store a mapping between one or more magnetic field values and one or more lid portion 24 positions. Specifically, the processor and/or memory device may store a first magnetic field value that is mapped to closed state of the lid portion 24, a second magnetic field value that is mapped to an open state of the lid portion 24, and one or more third magnetic field values that are each mapped to a position of the lid portion somewhere between an opened and closed state. Alternatively or in addition, assuming that the processor stores or has access to a magnetic field value mapped to a closed state and a magnetic field value mapped to an open state, the processor may be able to execute one or more instructions to perform an interpolation to estimate the position of the lid portion 24 if the magnetic field value received from the magnetic sensor 86 is between the stored or accessible magnetic field values.

Thus, if the controller 70 determines or receives an instruction to open or close the lid portion 24, the controller 70 can initially obtain an indication of a magnetic field value measured by the magnetic sensor 86. The controller 70 can then use the received magnetic field value to determine the position of the lid portion 24 based on the stored mapping and/or an interpolation operation. If the controller 70 determines that the position of the lid portion 24 matches a position to which the controller 70 determined or received an instruction to move the lid portion 24, then the controller 70 may take no action (e.g., the controller 70 may not cause the motor 78 to activate). However, if the controller 70 determines that the position of the lid portion 24 does not match a position to which the controller 70 determined or received an instruction to move the lid portion 24, then the controller 70 can activate the motor 78 and cause the motor 78 to generate rotational force in a direction that would cause the lid portion 24 to move to the desired position. The controller 70 can periodically or continuously monitor the position of the lid portion 24 via magnetic field values measured by the magnetic sensor 86 while the motor 78 is active. Once the controller 70 determines, via the received magnetic field values, that the lid portion 24 is now located at the desired position, the controller 70 can instruct the motor 78 to deactivate and no longer generate rotational force to move the lid portion 24.

As described above, the techniques described herein guard against damage resulting from accidental or intentional movement of the lid portion 24 by an individual. Specifically, because the controller 70 uses the measurements taken by the magnetic sensor 86 before determining whether, in which direction, and/or for how long to activate the motor 78, the controller 70 obtains an accurate reading of the position of the lid portion 24 even if the lid portion 24 ends up in a certain position due to the accidental or intentional movement of the lid portion 24 by an individual.

### Radar Overview

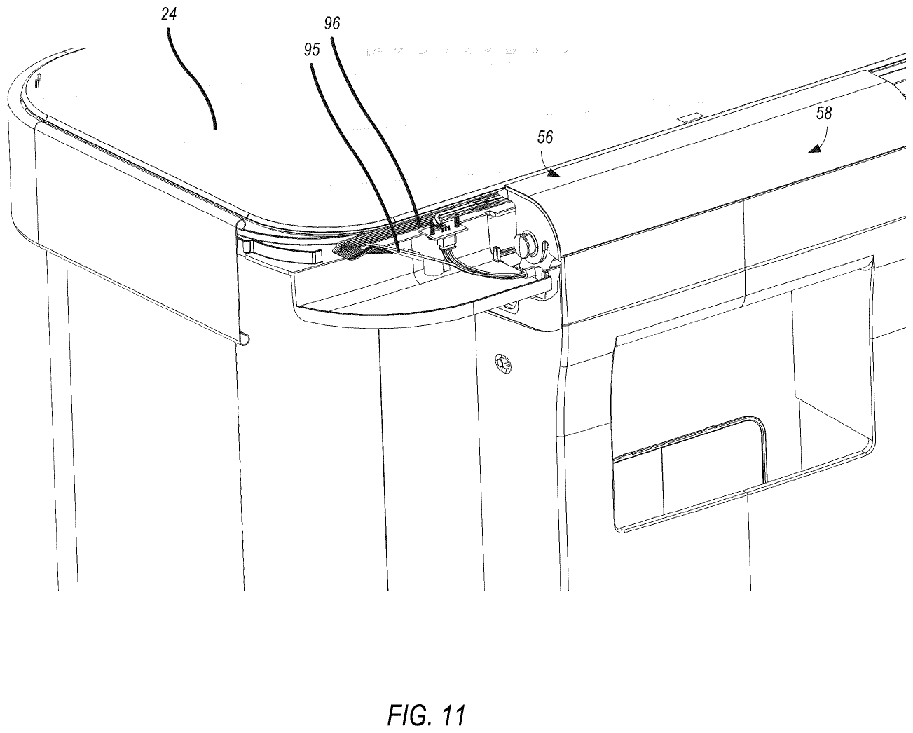

FIG. 11 illustrates a rear perspective view of an embodiment of a trashcan assembly 20 with a right rear portion of the backside enclosure 56 of the trashcan receptacle 20 removed for illustrative purposes. A receptacle can include a trashcan, a bin, a container, a box, and/or the like. As illustrated in FIG. 11, a radar sensor 95 may be included interior to the right rear portion of the backside enclosure 56 and adjacent to the power-operated driver 58 (which may be interior to a top portion of the backside enclosure 56). The radar sensor 95 may be coupled to the controller 70 (e.g., the PCB 71) via one or more wires 96 and/or a wireless connection (not shown).

The radar sensor 95 may include one or more transmit antennas and one or more receive antennas. For example, the radar sensor 95 may include one transmit antenna and 2, 3, 4, 5, etc. receive antennas, where each receive antenna is oriented in a different direction to detect a reflected signal originating from a different direction. Thus, the radar sensor 95 may be configured to detect the presence or movement of objects (e.g., individuals) in a three-dimensional (3D) space. The radar sensor 95 may transmit a continuous wave (CW) signal, such as an unmodulated continuous wave signal, a frequency modulated continuous wave (FMCW) signal, and/or the like. In some embodiments, the radar sensor 95 may transmit signals at a frequency between about 50-70 GHZ, such as between about 57.1 GHz to about 63.9 GHZ.

The radar sensor 95 may further include one or more signal processors and/or one or more memory devices, where the signal processor(s) may be configured to process a transmitted signal (e.g., transmitted by a transmit antenna), a received reflected signal (e.g., received by a receive antenna), and/or other data to detect the presence and location (e.g., distance and angle) of an object that is in proximity to the radar sensor 95 (e.g., within 2, 3, 4, 5, 10, etc. feet of the radar sensor 95). In some embodiments, the radar sensor 95 may output (e.g., to the controller 70) a high signal (e.g., a “1” bit, a voltage above a threshold level, etc.) if an object is detected and a low signal (e.g., a “0” bit, a voltage below a threshold level, etc.) if no object is detected. In other embodiments, the radar sensor 95 may output (e.g., to the controller 70) an indication of the location of a detected object or an indication that no object is detected.

The radar sensor 95 can operate in one of several states. For example, the radar sensor 95 can enter a shutdown state, a deep sleep state, a light sleep state, and/or a sensing state. In the shutdown state, the controller 70 or other power source in the backside enclosure 56 may not supply power to the radar sensor 95 and/or the radar sensor 95 may not transmit signals to identify the presence of objects until power is supplied and/or the controller 70 activates the radar sensor 95 and/or instructs the radar sensor 95 to enter a different state (e.g., the sensing state). In the deep sleep state, the radar sensor 95 may receive at least some power from the controller 70 or other power source, but may not transmit signals to detect the presence of objects until the controller 70 provides an instruction to awaken and transition to a different state (e.g., the sensing state) and/or additional power is supplied. In the light sleep state, the radar sensor 95 may receive at least some power from the controller 70 or other power source, but may not transmit signals to detect the presence of objects until the controller 70 provides an instruction to awaken and transition to a different state (e.g., the sensing state) and/or additional power is supplied. While the radar sensor 95 may not actively transmit signals in either the deep sleep state or light sleep state, the radar sensor 95 may consume more power in the light sleep state. However, the radar sensor 95 may be able to more quickly enter the sensing state when in the light sleep state versus the deep sleep state.

In the sensing state, the radar sensor 95 can operate in a ready mode and in a hyper mode. Prior to an object (e.g., an individual) being detected and/or if the lid portion 24 is closed and an object has not been detected within a threshold period of time (e.g., 30 seconds, 1 minute, 5 minutes, 10 minutes, etc.), the radar sensor 95 may operate in the ready mode. In the ready mode, power may be supplied to the radar sensor 95 at a first level (e.g., 14.2 mW, 14.4 mW, 14.6 mW, 14.8 mW, etc.) and the total 3D area over which signals transmitted by the radar sensor 95 can reach may be a 3D area with a first volume. If the radar sensor 95 detects the presence of an individual within the 3D area with the first volume, the controller 70 may either cause the lid portion 24 to open and the power supplied to the radar sensor 95 to increase or cause the power supplied to the radar sensor 95 to increase without yet causing the lid portion 24 to open. With the increased power supplied to the radar sensor 95, the radar sensor 95 may begin operating in a hyper mode. In the hyper mode, power supplied to the radar sensor 95 may be at a second level higher than the first level (e.g., 15.0 mW, 15.1 mW, 15.2 mW, 15.3 mW, etc.) and the total 3D area over which signals transmitted by the radar sensor 95 can reach may be a 3D area with a second volume that is greater than the first volume (e.g., because the increased power may allow signals transmitted by the transmit antenna of the radar sensor 95 to travel farther and/or may allow reflected signals that are detected by the receive antenna(s) of the radar sensor 95 to have a higher signal strength). Alternatively, in the hyper mode, power supplied to the radar sensor 95 may remain constant (e.g., at the first level or at a level similar to the first level, such as within a threshold milliwatt of the first level), but the sensitivity threshold of the receive antenna(s) may be lowered (e.g., in response to an instruction provided by the controller 70). For example, the radar sensor 95 may process a reflected signal to determine whether movement (or presence) of an object is detected if the reflected signal has a signal strength that is equal to or greater than a minimum signal strength. The controller 70 can instruct the radar sensor 95 to lower the minimum signal strength when transitioning from the ready m mode to the hyper mode such that the radar sensor 95 may process a reflected signal to determine whether movement (or presence) of an object is detected if the reflected signal has a signal strength that is equal to or greater than the new lower minimum signal strength. As an alternative, the minimum signal strength threshold may be at a baseline value in the hyper mode, and the controller 70 can instruct the radar sensor 95 to raise the minimum signal strength when transitioning to the ready mode such that the radar sensor 95 may process a reflected signal to determine whether movement (or presence) of an object is detected if the reflected signal has a signal strength that is equal to or greater than the new higher minimum signal strength when in the ready mode. Thus, the radar sensor 95 may detect and/or process reflected signals that satisfy a first minimum signal strength when in the ready mode, and may detect and/or process reflected signals that satisfy a second minimum signal strength that is lower than the first minimum signal strength when in the hyper mode. As another alternative, in the hyper mode, the power supplied to the radar sensor 95 may be at the second level and the sensitivity threshold of the receive antenna(s) may be lowered.

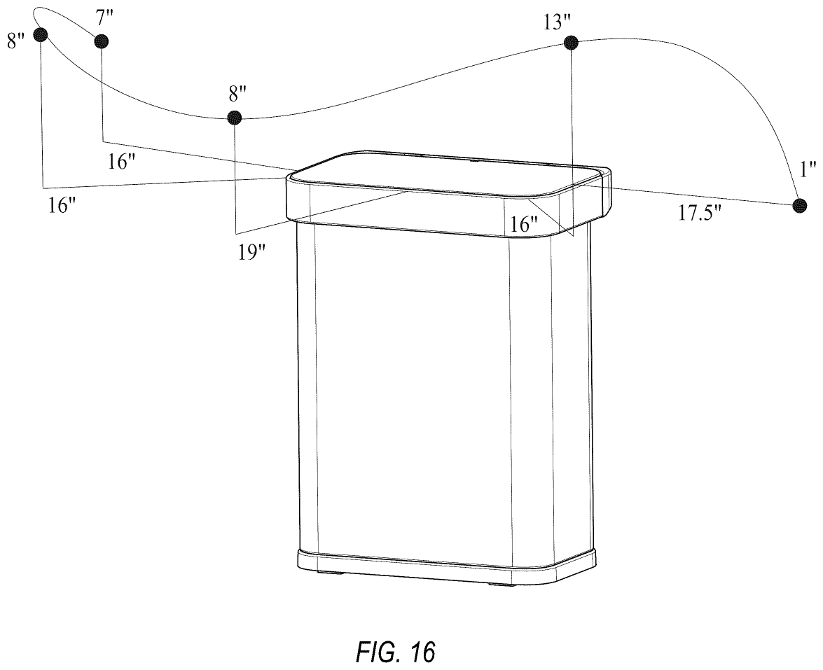

While in the hyper mode, the radar sensor 95 may continue to detect whether an individual is present within the 3D area with the second volume. If the radar sensor 95 detects the presence of an individual within the 3D area with the second volume (e.g., receive antenna(s) detect a reflected signal that has a signal strength that meets or exceeds a minimum signal strength and the processed reflected signal results in a determination that movement or presence of an individual is detected), the controller 70 may cause the lid portion 24 to open (e.g., if the lid portion 24 is not already open) or may allow the lid portion 24 to remain open (e.g., if the lid portion 24 is already open). The radar sensor 95 may continue to operate in the hyper mode for a threshold period of time, where the threshold period of time may or may not reset each time an individual is detected within the 3D area with the second volume. If the radar sensor 95 does not detect or no longer detects an individual within the 3D area with the second volume, then the controller 70 may cause the lid portion 24 to close (e.g., if the lid portion 24 is already open) or to remain closed (e.g., if the lid portion 24 is already closed). An example of a 3D area with the second volume is depicted in FIG. 16.

Alternatively, the radar sensor 95 may operate in the ready mode when in the deep sleep or light sleep state, and may operate in the hyper mode when in the sensing state. In this embodiment, the controller 70 may instruct the radar sensor 95 to transition from the deep sleep or light sleep state to the sensing state when the controller 70 determines that the hyper mode should be activated.

In an alternative embodiment, the radar sensor 95 may first operate in a hyper mode, then transition to operating in a ready mode. For example, prior to an object (e.g., an individual) being detected and/or if the lid portion 24 is closed and an object has not been detected within a threshold period of time (e.g., 30 seconds, 1 minute, 5 minutes, 10 minutes, etc.), the radar sensor 95 may operate in the hyper mode. If the radar sensor 95 detects the presence of an individual in the hyper mode, the controller 70 may either cause the lid portion 24 to open and the power supplied to the radar sensor 95 to decrease and/or the minimum signal strength of the receive antenna(s) to increase or cause the power supplied to the radar sensor 95 to decrease and/or the minimum signal strength of the receive antenna(s) to increase without yet causing the lid portion 24 to open. With the decreased power supplied to the radar sensor 95 and/or the increased minimum signal strength for detecting reflected signals, the radar sensor 95 may begin operating in a ready mode. If the radar sensor 95 detects the presence of an individual in the ready mode (e.g., receive antenna(s) detect a reflected signal that has a signal strength that meets or exceeds a minimum signal strength and the processed reflected signal results in a determination that movement or presence of an individual is detected), the controller 70 may cause the lid portion 24 to open (e.g., if the lid portion 24 is not already open) or may allow the lid portion 24 to remain open (e.g., if the lid portion 24 is already open). The radar sensor 95 may continue to operate in the ready mode for a threshold period of time, where the threshold period of time may or may not reset each time an individual is detected within the 3D area in which radar signals are emitted. If the radar sensor 95 does not detect or no longer detects an individual within the 3D area in which radar signals are emitted, then the controller 70 may cause the lid portion 24 to close (e.g., if the lid portion 24 is already open) or to remain closed (e.g., if the lid portion 24 is already closed).

As used herein, radar signals emitted at a second power level being described as traveling farther than radar signals emitted at the first power level less than the second power level means that, at a specific location in the vicinity of the trashcan receptacle 20, a signal strength of a radar signal emitted at the second power level may be greater than a signal strength of a radar signal emitted at the first power level (and a signal strength of a reflected signal resulting from emission of a radar signal at the second power level may be greater than a signal strength of a reflected signal resulting from emission of a radar signal at the first power level) assuming that environmental conditions remain constant. Thus, a difference between the 3D area with the second volume and the 3D area with the first volume less than the second volume may be that at any given location within or outside the two 3D areas, the signal strength of an emitted or reflected signal may be higher in the 3D area with the second volume than in the 3D area with the first volume assuming that environmental conditions remain constant and the radar signals are emitted at different power levels.

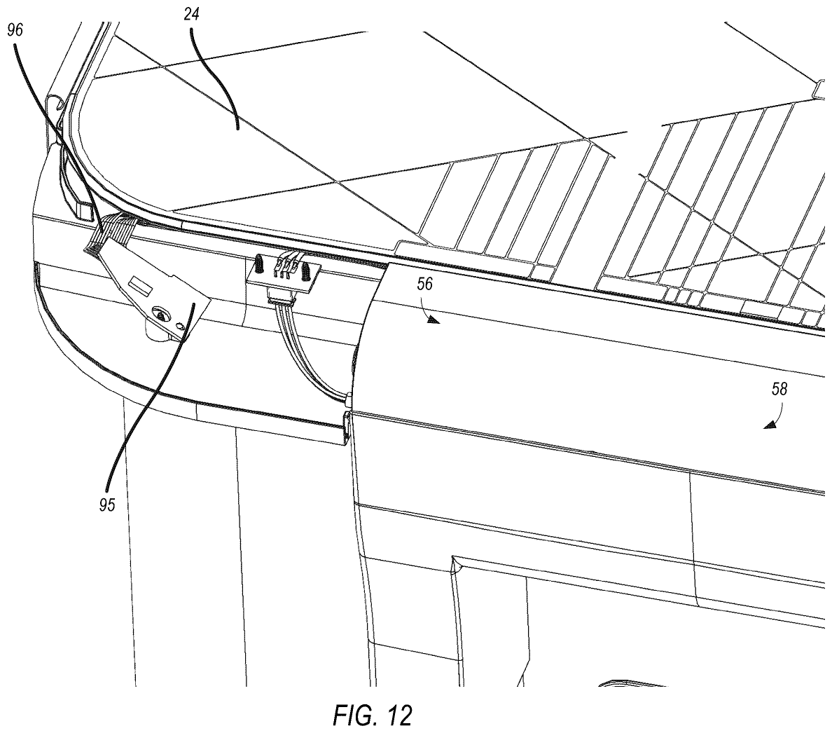

FIG. 12 illustrates a top, rear perspective view of an embodiment of a trashcan assembly 20 with a right rear portion of the backside enclosure 56 of the trashcan receptacle 20 removed for illustrative purposes. As illustrated in FIGS. 11-12, the radar sensor 95 may be angled such that a bottom surface of the radar sensor 95 may be between 0-90 degrees of an axis that is perpendicular to the ground. For example, the bottom surface of the radar sensor 95 and an axis that is perpendicular to the ground may form an angle that is at least about 40 degrees, 45 degrees, 50 degrees, or any other value between 0 degrees and 90 degrees when the radar sensor 95 is positioned in the backside enclosure 56. Similarly, the bottom surface of the radar sensor and an axis that is parallel with the ground may form an angle that is at least about 40 degrees, 45 degrees, 50 degrees, or any other value between 0 degrees and 90 degrees when the radar sensor 95 is positioned in the backside enclosure 56. The radar sensor 95 may be positioned at such an angle to fit within the constrained dimensions of the right rear portion of the backside enclosure 56 and/or to provide a large area in front of, to either or both sides of, in either or both corner regions to the front and side(s) of, and/or on top of the trashcan receptacle 20 in which signals emitted by a transmitter of the radar sensor 95 can reach (and therefore to provide a large area in which an individual can be detected).

The positioning of the radar sensor 95 may also result in reduced interference. For example, metal materials may interfere with signals transmitted by the radar sensor 95. In some embodiments, the lid portion 24 may include metal materials. To reduce the likelihood of interference caused by the lid portion 24 (or any other portion of the trashcan assembly 20 that includes metal materials), the radar sensor 95 may be positioned such that when the lid portion 24 is closed, the radar sensor 95 can transmit signals that propagate toward the front face, side faces, and top face of the trashcan assembly 20 below and/or above the closed lid portion 24. When the lid portion 24 is fully open or in the process of being opened, the signals transmitted by the radar sensor 95 may still propagate below the lid portion 24 toward the front, top, and side faces of the trashcan assembly 20. Specifically, the angle at which the lid portion 24 opens (e.g., from 0 degrees to 90 degrees with respect to an axis that is parallel to the ground) may also allow the signals to propagate toward a front face and a front, top face of the trashcan assembly 20. However, when the lid portion 24 is fully open, the lid portion 24 may be positioned generally vertically (e.g., generally perpendicular with the ground) and above and behind the position of the radar sensor 95 from the perspective of the front of the trashcan assembly 20. In some embodiments, all of the lid portion 24 may be positioned further rear of the trashcan assembly 20 than the radar sensor 95 when the lid portion 24 is fully open. Thus, signals transmitted by the radar sensor 95 and that propagate toward the front, top, or side of the trashcan assembly 20 may be clear of any obstructions or interference that could be caused by the lid portion 24. Thus, the positioning of the radar sensor 95 may allow for continued, accurate object detection regardless of the position of the lid portion 24.

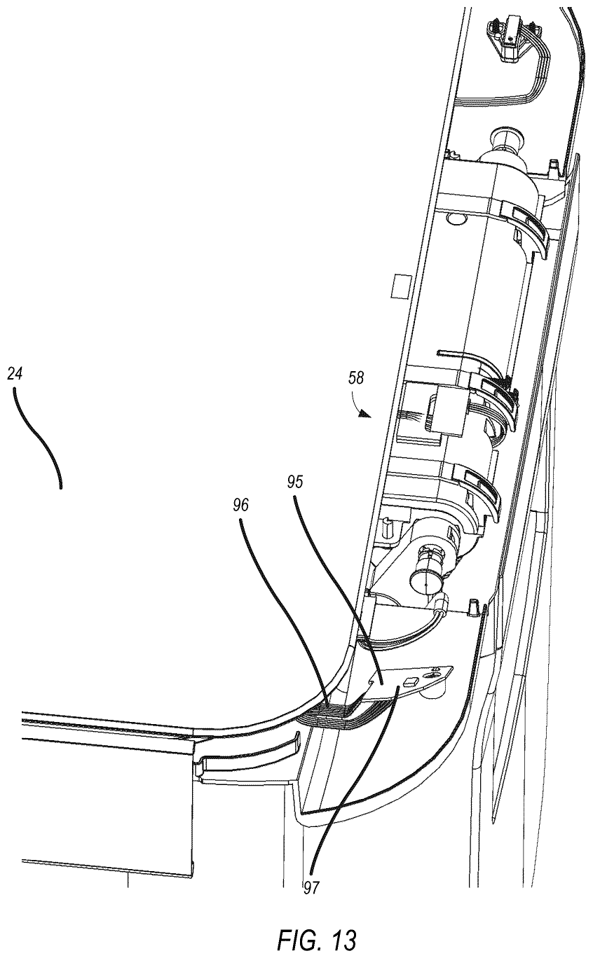

FIG. 13 illustrates a top perspective view of an embodiment of a trashcan assembly 20 with a right rear portion of the backside enclosure 56 of the trashcan receptacle 20 removed for illustrative purposes. As illustrated in FIG. 13, a bottom surface 97 of the radar sensor 95 may be angled toward the power-operated driver 58 and/or a top side of the trashcan receptacle 20. The transmit antenna(s) and the receive antenna(s) may be located on the bottom surface 97. Alternatively, some or all of the transmit antenna(s) and/or some or all of the receive antenna(s) can be located on a top surface of the radar sensor 95 (not shown). Thus, some or all of the transmit antenna(s) and/or some or all of the receive antenna(s) of the radar sensor 95 can be located on the same surface or on different surfaces.

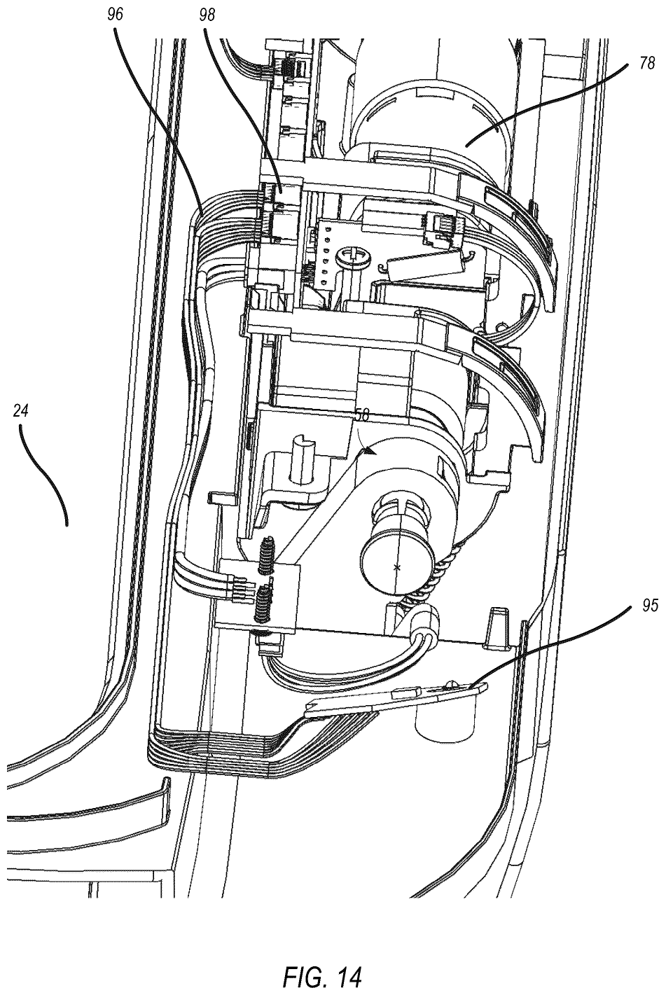

FIG. 14 illustrates a top perspective view of an embodiment of a trashcan assembly 20 with a right rear and top portion of the backside enclosure 56 of the trashcan receptacle 20 removed for illustrative purposes. As illustrated in FIG. 14, the one or more wires 96 may couple to a port 98 of the PCB 91, thereby providing a wired connection between the radar sensor 95 and the processor of the controller 70. The radar sensor 95 may transmit to the processor of the controller 70 via the one or more wires 96 an indication of whether an object (e.g., an individual) is detected. The one or more wires 96 or other wires depicted therein may supply power to the radar sensor 95.

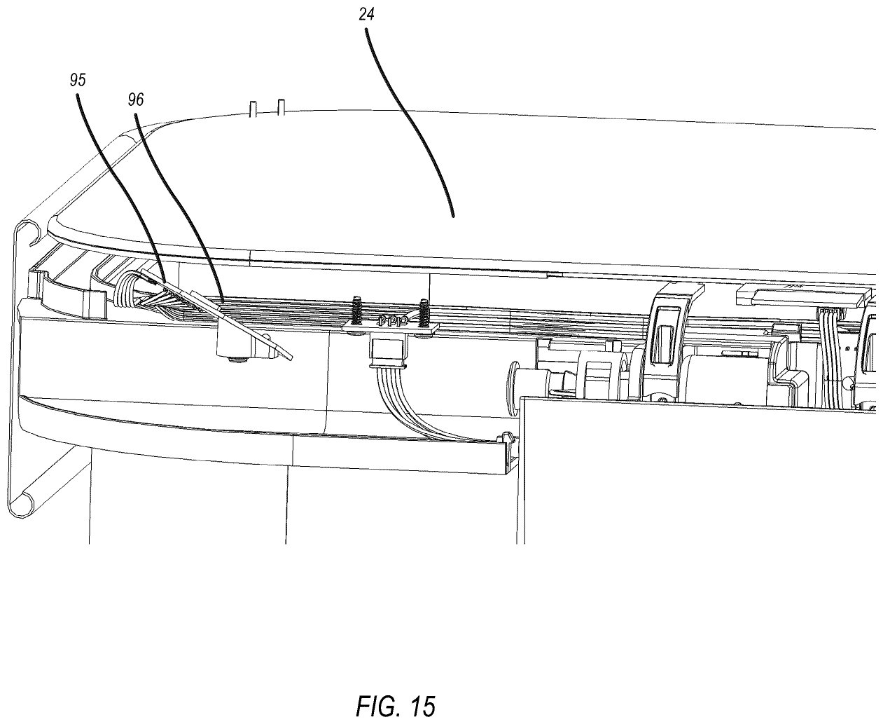

FIG. 15 illustrates a rear perspective view of an embodiment of a trashcan assembly 20 with a right rear and top portion of the backside enclosure 56 of the trashcan receptacle 20 removed for illustrative purposes. As illustrated in FIG. 15, and as described above, the top surface and bottom surface 97 of the radar sensor 95 may be positioned at an angle between 0-90 degrees with respect to an axis that is perpendicular or parallel to the ground.

FIG. 16 illustrates a front perspective view of an embodiment of a trashcan assembly 20 that depicts a distance from the radar sensor 95 to which signals transmitted by the radar sensor 95 may reach with at least a minimum signal strength in a 3D space when the radar sensor 95 is operating in the hyper mode of the sensing state. As illustrated in FIG. 16, when the radar sensor 95 is operating in the hyper mode, signals transmitted by the transmit antenna may reach 19″ from a front face of the trashcan assembly 20, 16″ from a front left side or front right side of the trashcan assembly 20, 16″ from a left side of the trashcan assembly 20, 17.5″ from a right side of the trashcan assembly 20, a height of 7″ from 16″ from a left side of the trashcan assembly 20, a height of 8″ from 16″ from a front left side of the trashcan assembly 20, a height of 8″ from 19″ from a front face of the trashcan assembly 20, a height of 13″ from 16″ from a front right side of the trashcan assembly 20, and a height of 1″ from 17.5″ from a right side of the trashcan assembly 20.

While FIG. 16 depicts specific distances, this is merely exemplary and is not meant to be limiting. The exact distances over which signals transmitted by the transmit antenna can travel while having at least a minimum signal strength may be dictated by any interference present in a location of the trashcan assembly 20, the amount of power supplied to the radar sensor 95, and/or other environment factors. In addition, FIG. 16 depicts the distances as being longer on the right side of the trashcan assembly 20 because the radar sensor 95 can be located at the rear right side of the trashcan assembly 20. However, the radar sensor 95 can be located at the rear left side of the trashcan assembly 20 instead. In such an embodiment, the distances may be flipped such that the distances may be longer on the left side of the trashcan assembly 20.

### Controlling Lid Position

As discussed herein, the trashcan assembly 20 can implement an algorithm that directs various actions, such as opening and closing of the lid portion 24, triggering the ready mode and hyper mode, or other actions. In general, the algorithm can include evaluating one or a plurality of received signals and, in response, determining whether to provide an action. In some embodiments, the algorithm determines whether to provide an action in response to receipt of a signal from the radar sensor 95, such as opening or closing the lid portion 24. In certain variants, the algorithm determines whether to open the lid portion 24 in response to an object being detected in a certain location or combination of locations, such as an object being detected in a 3D space with the first volume (e.g., referred to herein as a first sensing region) and/or in a 3D space with the second volume (e.g., referred to herein as a second sensing region). Some embodiments are configured to open the lid portion 24 in response to an object being detected in a certain sequence of locations, such as an object being detected in the first sensing region and an object being subsequently or concurrently detected in the second sensing region. Certain implementations are configured to determine whether a detected object is fleeting or transitory, which may indicate that the detected object is not intended to trigger operation of the trashcan assembly 20 (e.g., a person walking by the trashcan assembly 20). For example, some embodiments can evaluate whether a detected object is detected for less than a certain period and/or is moving through at least one of the sensing regions at greater than or equal to a maximum speed. If the detected object is fleeting or transitory, the algorithm can determine that the lid portion 24 should not be opened in response to such detection.

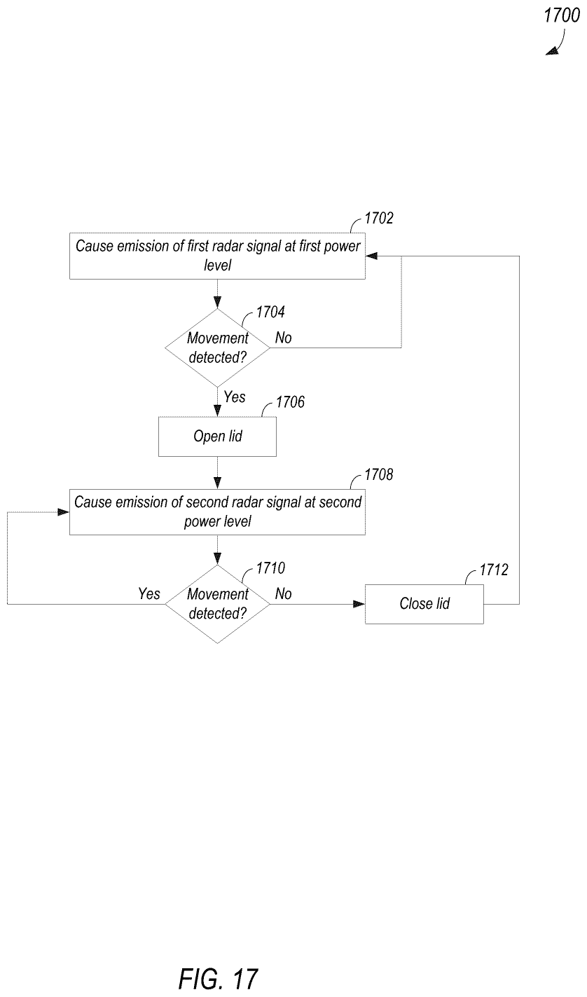

FIG. 17 illustrates an example algorithm process 1700 of controlling the position of the lid portion 24. The process 1700 may be performed by controller 70 of trashcan assembly 20. The process 1700 can be implemented, in part or entirely, by a component of the controller 70 or implemented elsewhere in the trashcan assembly 20, for example by one or more processors executing logic or computer-executable instructions in controller 70. In some embodiments, controller 70 includes one or more processors in electronic communication with at least one computer-readable memory storing instructions to be executed by the at least one processor of controller 70, where the instructions cause the trashcan assembly 20 to implement the process 1700.

In some embodiments, the process 1700 starts at block 1702 where a first radar signal is caused to be emitted at a first power level using a transmit antenna. In some embodiments, in block 1702, the trashcan assembly 20 is in the ready mode, as discussed above. In some embodiments, the controller 70 causes the radar sensor 95 to emit the first radar signal in a 3D direction (e.g., toward a front face, a top face, and/or a side face of the trashcan receptacle 20).

As shown, the process 1700 can include block 1704 where a determination is made as to whether movement (or presence) of an object is detected, such as in the first sensing region or a second sensing region. For example, a receive antenna of the radar sensor 95 can detect a reflected signal that originates as a result of the transmit antenna of the radar sensor 95 emitting the first radar signal, and a signal processor of the radar sensor 95 can process at least the reflected signal to determine whether movement (or presence) of an object is detected. The radar sensor 95 can then transmit a message to the controller 70 that indicates whether movement (or presence) of an object is detected. For example, the message can be in the form of a high signal (e.g., movement or presence of an object is detected), a low signal (e.g., movement or presence of an object is not detected), an indication of a location of an object (if present), and/or the like. If no movement (or presence) of an object is detected, the process 1700 reverts to block 1702. However, if movement (or presence) of an object is detected, the process 1700 continues to block 1706, in which the lid portion 24 is opened. For example, in response to movement (or presence) of an object being detected in the first sensing region or the second sensing region, the controller 70 can send a signal to the motor 78 to open the lid portion 24.

In some embodiments, the process 1700 moves to block 1708, which can include causing emission of a second radar signal at a second power level using a transmit antenna. In some embodiments, the second power level is greater than the first power level. For example, the trashcan assembly 20 may be in the hyper mode, and the sensing extent of the first sensing region can be increased. In some embodiments, the controller 70 causes the radar sensor 95 to emit the second radar signal in a 3D direction (e.g., toward a front face, a top face, and/or a side face of the trashcan receptacle 20).

Alternatively, at block 1708, the controller 70 can cause emission of a second radar signal that is at the first power level or a power level similar to the first power level (e.g., within a threshold wattage of the first power level, such as within 0.05, 0.08, 0.1, etc. mW of the first power level), but may instruct the radar sensor 95 to lower a sensitivity threshold of the receive antenna(s). For example, the radar sensor 95 may detect a reflected signal and eventually determine that movement (or presence) of an object is detected if the reflected signal has a signal strength that exceeds a minimum signal strength. The controller 70 may instruct the radar sensor 95 to lower the minimum signal strength such that the radar sensor 95 may process reflected signals and possibly detect movement (or presence) of an object based on such signals as long as the reflected signals have a signal strength that is equal to or greater than the new lower minimum signal strength. As another alternative, at block 1708, the controller 70 can cause emission of the second radar signal at the second power level and can instruct the radar sensor 95 to lower the sensitivity threshold of the receive antenna(s).

As illustrated, the process 1700 can include block 1710 where a determination is made as to whether a further movement (or presence) of an object is detected. For example, the trashcan assembly 20 (e.g., the radar sensor 95) can determine whether further movement (or presence) of an object has been detected in at least one of the first or second sensing regions. The radar sensor 95 can then transmit a message to the controller 70 that indicates whether movement (or presence) of an object is detected. For example, the message can be in the form of a high signal (e.g., movement or presence of an object is detected), a low signal (e.g., movement or presence of an object is not detected), an indication of a location of an object (if present), and/or the like. If a further movement (or presence) of an object is detected, the process 1700 can revert to block 1708, in which the controller 70 causes the radar sensor 95 to continue to emit a second radar signal at a second power level.

If no further movement (or presence) of an object is detected, the process 1700 can continue to block 1712. In some embodiments, the process 1700 includes a timer or delay before moving to block 1712. For example, the process 1700 can include determining that no further movement (or presence) of an object is detected for at least a predetermined amount of time, such as at least about: 1, 2, 3, or 4 seconds. This can enable a user to briefly leave the first and/or second sensing regions without the process 1700 continuing to block 1712.

In some embodiments, block 1712 includes closing the lid portion 24 and/or reverting to the ready mode. For example, the controller 70 can send a signal to the motor 78 to close the lid portion 24. In certain implementations, block 1712 includes reducing or ceasing operation of the radar sensor 95 (e.g., causing the radar sensor 95 to transition to a shutdown, deep sleep, or light sleep state). As illustrated, the process 1700 can revert to block 1702.

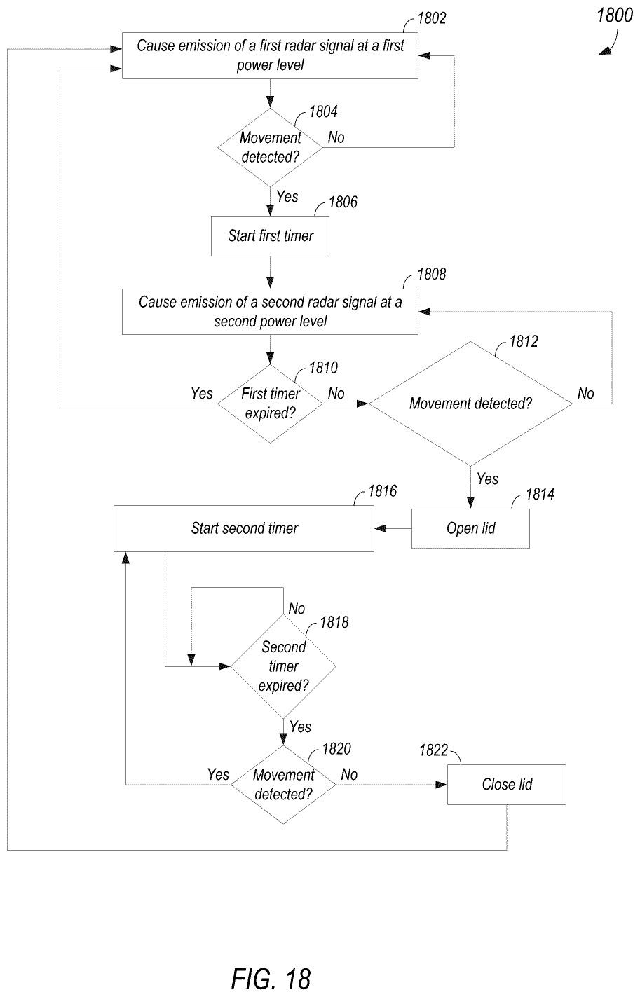

FIG. 18 illustrates an example algorithm process 1800 of controlling the position of the lid portion 24. The process 1800 may be performed by the controller 70 of trashcan assembly 20. The process 1800 can be implemented, in part or entirely, by a component of the controller 70 or implemented elsewhere in the trashcan assembly 20, for example by one or more processors executing logic or computer-executable instructions in controller 70. In some embodiments, controller 70 includes one or more processors in electronic communication with at least one computer-readable memory storing instructions to be executed by the at least one processor of controller 70, where the instructions cause the trashcan assembly 20 to implement the process 1800.

In some embodiments, process 1800 starts at block 1802 where a first radar signal is caused to be emitted at a first power level using a transmit antenna. In some embodiments, in block 1702, the trashcan assembly 20 is in the ready mode, as discussed above. In some embodiments, the controller 70 causes the radar sensor 95 to emit the first radar signal in a 3D direction (e.g., toward a front face, a top face, and/or a side face of the trashcan receptacle 20).

As shown, the process 1800 can include block 1804 where a determination is made as to whether movement (or presence) of an object is detected, such as in the first sensing region or a second sensing region. For example, a receive antenna of the radar sensor 95 can detect a reflected signal that originates as a result of the transmit antenna of the radar sensor 95 emitting the first radar signal, and a signal processor of the radar sensor 95 can process at least the reflected signal to determine whether movement (or presence) of an object is detected. The radar sensor 95 can then transmit a message to the controller 70 that indicates whether movement (or presence) of an object is detected. For example, the message can be in the form of a high signal (e.g., movement or presence of an object is detected), a low signal (e.g., movement or presence of an object is not detected), an indication of a location of an object (if present), and/or the like. If no movement (or presence) of an object is detected, the process 1800 reverts to block 1802. However, if movement (or presence) of an object is detected, the process 1800 continues to block 1806.

In certain embodiments, block 1806 includes the controller 70 activating the hyper mode by causing additional power to be supplied to the radar sensor 95 and/or by instructing the radar sensor 95 to lower a minimum signal strength threshold of the receive antenna(s), which can increase the extent of the sensing range of the radar sensor 95. In some embodiments, block 1806 includes starting a first timer. For example, the first timer may be a timer or counter implemented by the controller 70 or a mechanical timer and the first timer expires or fires after a first predetermined period of time (e.g., approximately 1 second, approximately 5 seconds, etc. or a time based on a time it takes the transmit antenna to emit a predetermined number of radar signals). Detection of movement (or presence) of the object at block 1804 causes the controller 70 to transition the radar sensor 95 into the hyper mode. The first timer represents a time that the radar sensor 95 waits in the hyper mode for the detection of an object before transitioning back into the ready mode.

The process 1800 can include block 1808, which can include causing emission of a second radar signal at a second power level using a transmit antenna, causing emission of a second radar signal at a first power level using a transmit antenna and a change to (e.g., a lowering of) the minimum signal strength threshold, and/or causing emission of a second radar signal at a second power level using a transmit antenna and a change to (e.g., a lowering of) the minimum signal strength threshold. In some embodiments, the second power level is greater than the first power level. For example, the trashcan assembly 20 may be in the hyper mode, and the sensing extent of the first sensing region can be increased. In some embodiments, the controller 70 causes the radar sensor 95 to emit the second radar signal in a 3D direction (e.g., toward a front face, a top face, a corner zone in front of and to the side of the trashcan receptacle 20, a side face of the trashcan receptacle 20, and/or any position in between).

As illustrated, in block 1810 a determination is made as to whether the first timer has expired. If the first timer has expired, the process 1800 reverts to block 1802 and the first timer is reset (e.g., to its value before being started). For example, if the first timer expires, this may indicate that no movement (or presence) of an object was detected (because, for example, a user inadvertently moved into the first sensing region and/or because the user did not intend to open the lid portion 24). In various embodiments, when the process 1800 reverts to block 1802, the controller 70 can transition the radar sensor 95 back into the ready mode.

If the first timer has not expired, the process 1800 continues to block 1812 where a determination is made as to whether movement (or presence) of an object is detected, such as in the first sensing region or a second sensing region. For example, a receive antenna of the radar sensor 95 can detect a reflected signal that originates as a result of the transmit antenna of the radar sensor 95 emitting the second radar signal, and a signal processor of the radar sensor 95 can process at least the reflected signal to determine whether movement (or presence) of an object is detected. The radar sensor 95 can then transmit a message to the controller 70 that indicates whether movement (or presence) of an object is detected. For example, the message can be in the form of a high signal (e.g., movement or presence of an object is detected), a low signal (e.g., movement or presence of an object is not detected), an indication of a location of an object (if present), and/or the like. If no movement (or presence) of an object is detected, the process 1800 reverts to block 1808. For example, if no movement (or presence) of an object is detected, then the transmit antenna of the radar sensor 95 may continue to emit signals in an attempt to detect movement (or presence) of an object before the first timer expires.

If movement (or presence) of an object is detected in block 1812, the process 1800 continues to block 1814 in which the lid portion 24 is opened. For example, in response to movement (or presence) of an object being detected in the first sensing region or the second sensing region, the controller 70 can send a signal to the motor 78 to open the lid portion 24.

Alternatively, the controller 70 may wait a period of time before causing the lid portion 24 to open. For example, the controller 70 may cause the radar sensor 95 to remain in the hyper mode and start a timer and, at expiry of the time, determine based on an input received from the radar sensor 95, whether an object is still in the first or second sensing region. If the radar sensor 95 detects movement (or presence) of the object after expiry of the timer, then the controller 70 may cause the lid portion 24 to open. Otherwise, if the radar sensor 95 does not detect movement (or presence) of the object after expiry of the timer, then the controller 70 may cause the lid portion 24 to remain closed and the process 1800 may revert to block 1802. This can aid in determining whether the detected object is fleeting or intends for the lid portion 24 to open, thereby reducing the chance that the lid portion 24 will open prematurely and/or unintentionally, such as could otherwise occur when a person merely walks by the trashcan assembly 20.

At block 1816, a second timer is started. For example, the second timer may be a timer or counter implemented by the controller 70 or a mechanical timer and the second timer expires or fires after a second predetermined period of time (e.g., approximately 0.5 seconds, approximately 1 second, etc. or a time based on a time it takes the transmit antenna to emit a predetermined number of radar signals). Once movement (or presence) of an object is initially detected in the first or second sensing region, the controller 70 determines whether the object remains in the first or second sensing region for a period of time to determine whether to leave the lid portion 24 open or whether to close the lid portion 24.

Alternatively, the controller 70 can start the second timer after the lid portion 24 is opened and the radar sensor 95 indicates that no further movement (or presence) of an object is detected. Thus, the trashcan receptacle 20 may wait a certain amount of time after no further movement (or presence) of an object is detected before closing the lid portion 24. This may be beneficial in situations in which an individual leaves a vicinity of the trashcan assembly 20, but intends to return and continue using the trashcan assembly 20.

As illustrated, the process 1800 continues to block 1818 where a determination is made as to whether the second timer has expired. If the second timer has expired, the process 1800 continues to block 1820. Otherwise, if the second timer has not expired, the process 1800 reverts to block 1818.

At block 1820, a determination is made as to whether movement (or presence) of an object is detected, such as in the first sensing region or a second sensing region. For example, a receive antenna of the radar sensor 95 can detect a reflected signal that originates as a result of the transmit antenna of the radar sensor 95 emitting the second radar signal, and a signal processor of the radar sensor 95 can process at least the reflected signal to determine whether movement (or presence) of an object is detected. The radar sensor 95 can then transmit a message to the controller 70 that indicates whether movement (or presence) of an object is detected. For example, the message can be in the form of a high signal (e.g., movement or presence of an object is detected), a low signal (e.g., movement or presence of an object is not detected), an indication of a location of an object (if present), and/or the like. If no movement (or presence) of an object is detected, the process 1800 continues to block 1822 and the controller 70 causes the motor 78 to close the lid portion 24. For example, if no movement (or presence) of an object is detected after expiry of the second timer, this may indicate that an individual is no longer using the trashcan receptacle 20 and the lid portion 24 can be closed. Once the lid portion 24 is closed, the process 1800 reverts to block 1802. If movement (or presence) of an object is detected, the process 1800 reverts to block 1816 and the second time is reset. For example, if movement (or presence) of an object is detected after expiry of the second timer, this may indicate that an individual is continuing to use the trashcan receptacle 20 and the lid portion 24 should remain open.

### Voice Activation

In some embodiments, the trashcan assembly 20 can actuate one or more features of the trashcan assembly 20, such as opening and/or closing the lid portion 24 or moving the trashcan or a holder or support of one or more trashcans from one location to another, using an audio sensor, such as an audio sensor configured to sense one or more voice commands or other sounds (e.g., clapping, snapping, or otherwise) received from a user. In some embodiments, the audio sensor can be the only sensor utilized to actuate the trashcan assembly 20, or the audio sensor can be used with one or more other sensors, such as one or more movement or proximity detectors like a radar sensor 95 (e.g., described anywhere in this specification). Regarding the audio sensor, the memory in the controller 70 and/or memory in a remote system can store data representing one or more keywords or sounds. A keyword or sound (also referred to herein as a wake word or a code word) may be a word that is associated with a particular action or state of the trashcan assembly 20. When the trashcan assembly 20 detects a particular keyword or sound, the trashcan assembly 20 can take a corresponding action (e.g., open the lid portion 24, close the lid portion 24, maintain the lid in an open position, etc.) and/or transition to a corresponding state (e.g., transition to a stay-open mode or transition to a stay-closed mode, which are described in greater detail below).

The backside enclosure 56 and/or any other portion of the trashcan assembly 20 can include a microphone. For example, the microphone can be disposed on a generally outer portion of the trashcan assembly 20. In some embodiments, at least a portion of the microphone is exposed to the trashcan exterior. In other embodiments, the microphone is not exposed to the trashcan exterior and a hard or soft grill can be coupled with the microphone to protect the microphone while still allowing sound to pass from the trashcan exterior to the microphone. The microphone may capture sound, such as an utterance spoken by or a sound made by a user. Once captured, the microphone can transform the sound into an electrical audio signal that represents the captured sound and transmit the electrical audio signal to the controller 70.

The trashcan assembly 20 may include a network interface (e.g., a wireless network adapter, a wired network adapter, etc.) in electrical communication with the controller 70, and the controller 70 may transmit the electrical audio signal to a remote system via the network interface. The remote system can perform speech recognition on the electrical audio signal to generate a transcript of a word or words spoken by a user, or to identify a type of sound made by a user. The remote system can then transmit the results of the speech recognition (e.g., the transcript, the identified type of sound, etc.) to the controller 70 via the network interface.

Alternatively, using instructions and/or algorithms stored in the memory, one or more of the processors of the controller 70 can perform speech recognition on the received electrical audio signal to identify any words that may have been spoken or sounds that may have been uttered.

Once the results of the speech recognition are generated or received, the processor can compare the identified words (or sounds) with one or more keywords (e.g., using the data representing one or more keywords stored in the memory) or one or more sounds (e.g., using data representing one or more sounds stored in the memory) to determine if there are any matches. Thus, the processor can perform a comparison of the speech recognition processed version of the captured audio with known keywords or sounds to determine whether a user said any of the known keywords or made any of the known sounds.

Alternatively, the remote system, after performing the speech recognition, can perform the comparison in place of the processor of the controller 70. Thus, the remote system can provide to the controller 70 via the network interface an indication of whether a known keyword or sound was uttered and which one, and/or can instruct the controller 70 via the network interface to take a specific action (e.g., open the lid portion 24, close the lid portion 24, etc.) that corresponds with a detected keyword or sound match.

If an identified word does not match a keyword, the controller 70 takes no action. If an identified word matches a keyword, the controller 70 can then perform an action and/or transition to a state associated with the keyword. For example, if the processor determines or receives a determination that the user said a keyword or made a sound associated with the opening of the lid portion 24 (e.g., “OPEN LID” or “OPEN TRASHCAN,” etc.), the controller 70 can cause the motor 78 to move the lid portion 24 to the open position. Likewise, if the processor determines or receives a determination that the user said a keyword or made a sound associated with the closing of the lid portion 24 (e.g., “CLOSE LID” or “CLOSE TRASHCAN,” etc.), the controller 70 can cause the motor 78 to move the lid portion 24 to the closed position. As another example, if the processor determines or receives a determination that the user said a keyword or made a sound associated with a desire to keep the lid portion 24 open for an extended period (e.g., “STAY OPEN” or “TASK MODE,” etc.), the controller 70 can cause the motor 78 to move the lid portion 24 to the open position (if the lid portion 24 is closed) or not cause the motor 78 to move the lid portion 24 to the closed position even if no movement (or presence) of an object is detected by the radar sensor 95 for an extended period or indefinitely. In some embodiments, the extended period can be at least about 20 seconds or at least about 30 seconds or at least about one minute, etc.). Likewise, if the processor determines or receives a determination that the user said a keyword or made a sound associated with a desire to keep the lid portion 24 closed for an extended period (e.g., “STAY CLOSED” or “CLOSED MODE,” etc.), such as to avoid unintentionally triggering the opening of the trashcan assembly 20 when someone is working around or otherwise near the trashcan assembly 20 for some other reason besides depositing trash, the controller 70 can cause the motor 78 to move the lid portion 24 to the closed position (if the lid portion 24 is open) or not cause the motor 78 to move the lid portion 24 to the open position even if movement (or presence) of an object is detected by the radar sensor 95 for an extended period. In some embodiments, the lid portion 24 may remain open or closed until a repeated or different keyword is uttered or sound is made (e.g., a keyword associated with the closing or opening of the lid portion 24), until a predetermined period of time has passed (e.g., at least about 1 minute, at least about 5 minutes, etc.), and/or the like. It is contemplated that any type of location detection or motion detection or sound detection, including any of those that are disclosed in this specification, or any combination of such modes of detection, can be used by the electronic controller of the trashcan assembly 20 to actuate any function described in this specification.

In some embodiments, the keywords recognized by the trashcan assembly 20 are preset. For example, the data representing the keywords can be stored in the memory during assembly and/or manufacture of the trashcan assembly 20.

In some embodiments, the keywords recognized by the trashcan assembly 20 are user-defined. For example, the trashcan assembly 20 can include a button, switch, or other such user input component that, when enabled, causes the trashcan assembly 20 to enter a training mode. In the training mode, a display or screen of the trashcan assembly 20 (or a separate mobile application running on a user device like a mobile phone, tablet, laptop, watch, etc. that communicates with the trashcan assembly 20 via the network interface) can identify an action or state of the trashcan assembly 20 and prompt a user to say a keyword or make a sound that will then be associated with the action or state. The microphone can capture the keyword uttered by the user or sound made by the user and transmit the representative electrical audio signal to the controller 70. The controller 70 or a remote system can perform speech recognition on the electrical audio signal to generate data representing the uttered keyword or made sound and the generated data can be stored in memory of the controller 70 and/or memory of the remote system for later use. The trashcan assembly 20 can repeat this process for any number of actions or states that can be associated with a keyword. In addition, the trashcan assembly 20 can repeat this process for multiple users. Different users may say the same word in different ways (e.g., with different accents, intonations, inflections, pitch, rate, rhythm, etc.) and so it may be useful to store varied pronunciations of a single keyword to improve the accuracy of the speech recognition and thus the actions performed by the trashcan assembly 20. The memory of the controller 70 and/or remote system can store one or more pronunciations for a single keyword and any number of these pronunciations can be compared with the identified words during the speech recognition process.

In some embodiments, the trashcan assembly 20 can include wireless communication components as part of the network interface that allow the trashcan assembly 20 to receive keyword and/or sound information wirelessly from a user device. The wireless communication components can include an antenna, a transceiver coupled with the antenna, and related circuitry. The antenna can be disposed on a generally outer portion of the trashcan assembly 20. In some embodiments, at least a portion of the antenna is exposed to the trashcan exterior. The antenna may be positioned in a manner that avoids signal interference when the lid portion 24 changes positions. The antenna can transmit signals received from the transceiver and receive signals transmitted by the user device. The antenna forwards signals received from the user device to the transceiver.

The transceiver can be located anywhere within the interior of the trashcan assembly. For example, the transceiver can be a chip included within the controller 70 (e.g. on PCB 71, PCB 72, etc.). The transceiver can package data for transmission over the antenna and unpackage data received by the antenna. The transceiver may be able to communicate over a variety of networks, such as a cellular network, a network using the IEEE 802.11 protocol (e.g., Wi-Fi), a network using the Bluetooth® protocol, and/or the like. The transceiver can forward unpackaged data to the controller 70 for processing and/or storage.

A user device can be any electronic device. For example, a user device can include a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear,” virtual reality devices, augmented reality devices, etc.), wireless devices, home automation devices (e.g., “smart thermostats” or “smart meters”), set-top boxes, gaming consoles, entertainment systems, televisions with network access and program execution capabilities (e.g., “smart TVs”), and various other electronic devices and appliances. The user device can be equipped with software or a mobile application (e.g., an “app”) that is configured to enable the user device and/or the trashcan assembly 20 to perform any of the functions, tasks and/or steps described and/or illustrated herein.

For example, using the app, a user can establish a connection between the user device and the trashcan assembly 20 (e.g., via communications that pass through the wireless communication components of the network interface). The app can then be used to train the trashcan assembly 20, control the trashcan assembly 20, and/or the like. For example, the app can generate a user interface for display on the screen of the user device that identifies an action or state of the trashcan assembly 20 and that prompts a user to say a keyword that will then be associated with the action or state. In some embodiments, a microphone of the user device captures the keyword or sound uttered by the user and the user device performs speech recognition to generate data representing the uttered keyword or sound. The generated data is then transmitted to the controller 70 and/or remote system, via the antenna, the transceiver, and/or the related circuitry, for storage in the memory of the controller 70 and/or the remote system. The generated data can also be stored locally on the user device (e.g., by storing the generated data locally, the user device can be used to program multiple trashcan assemblies 20 without having the user repeat the training process). In some embodiments, a microphone of the user device captures the keyword uttered by the user and the representative electrical audio signal is transmitted to the controller 70 and/or remote system via the antenna, the transceiver, and/or the related circuitry. The representative electrical audio signal can also be stored locally on the user device to, for example, allow the user to program multiple trashcan assemblies 20 without having to repeat the training process. The controller 70 and/or remote system then performs speech recognition to generate data representing the uttered keyword or sound and stores the generated data in the memory. The app can repeat this process for any number of actions or states that can be associated with a keyword or sound. In addition, the app can repeat this process for multiple users. As described above, different users may say the same word in different ways (e.g., with different accents, intonations, inflections, pitch, rate, rhythm, etc.) and so it may be useful to store varied pronunciations of a single keyword to improve the accuracy of the speech recognition and thus the actions performed by the trashcan assembly 20. The memory of the controller 70 and/or remote system can store one or more pronunciations for a single keyword and any number of these pronunciations can be compared with the identified words during the speech recognition process.

As another example, the app can receive an utterance made by a user, perform speech recognition on the utterance, and either provide the results of the speech recognition to the controller 70 or compare the results of the speech recognition to known keywords and/or sounds and provide the results of the comparison to the controller 70 (or provide to the controller 70 an instruction to perform a specific action based on the results of the comparison). As another example, the app can perform speech recognition and/or perform the comparison based on an utterance captured by the trashcan assembly 20. In other words, the app can perform speech recognition instead of the remote system in some embodiments. Generally, any combination of the trashcan assembly 20, the remote system, and the app can perform any of the operations described herein with respect to the voice recognition and trashcan assembly 20 voice activation capabilities.

In some embodiments, the wireless communication components of the network interface can also be used to obtain keyword data from an informational source (e.g., the Internet, a home system, etc.). The keyword data can be stored in the memory of the controller 70 and/or the remote system for later use.

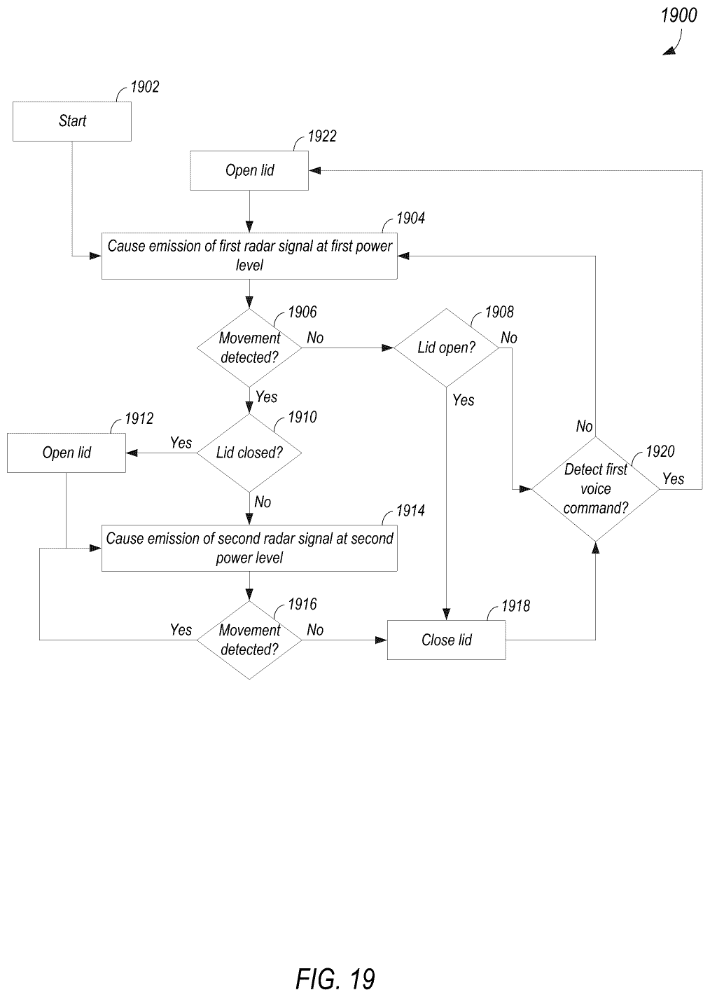

In certain embodiments, the voice recognition capability and the object movement (or presence) detection capability of the trashcan assembly 20 can work in conjunction to determine when to actuate one or more functions of the trashcan assembly 20, such as when to close and/or open the lid portion 24. For example, FIG. 19 illustrates an example algorithm process 1900 of controlling the position of the lid portion 24. The process 1900 may be performed by controller 70 of trashcan assembly 20, as described above. The process 1900 can be implemented, in part or entirely, by a component of the controller 70 or implemented elsewhere in the trashcan assembly 20, for example by one or more processors executing logic or computer-executable instructions in controller 70. In some embodiments, controller 70 includes one or more processors in electronic communication with at least one computer-readable memory storing instructions to be executed by the at least one processor of controller 70, where the instructions cause the trashcan assembly 20 to implement the process 1900. The process 1900 starts at block 1902.

As illustrated, the process 1900 moves to block 1904 where a first radar signal is caused to be emitted at a first power level using a transmit antenna. In some embodiments, in block 1702, the trashcan assembly 20 is in the ready mode, as discussed above. In some embodiments, the controller 70 causes the radar sensor 95 to emit the first radar signal in a 3D direction (e.g., toward a front face, a top face, a corner zone in front of and to the side of the trashcan receptacle 20, a side face of the trashcan receptacle 20, and/or any position in between).

As shown, the process 1900 can include block 1906 where a determination is made as to whether movement (or presence) of an object is detected, such as in the first sensing region or a second sensing region. For example, a receive antenna of the radar sensor 95 can detect a reflected signal that originates as a result of the transmit antenna of the radar sensor 95 emitting the first radar signal, and a signal processor of the radar sensor 95 can process at least the reflected signal to determine whether movement (or presence) of an object is detected. The radar sensor 95 can then transmit a message to the controller 70 that indicates whether movement (or presence) of an object is detected. For example, the message can be in the form of a high signal (e.g., movement or presence of an object is detected), a low signal (e.g., movement or presence of an object is not detected), an indication of a location of an object (if present), and/or the like. If no movement (or presence) of an object is detected, the process 1900 continues to block 1908. However, if movement (or presence) of an object is detected, the process 1900 continues to block 1910.

At block 1908, a determination is made as to whether the lid portion 24 is open. For example, even though no movement (or presence) of an object is detected, the lid portion 24 may still be open if the user uttered a keyword or made a sound associated with the opening of the lid portion 24. If the lid portion 24 is closed, the process 1900 moves to block 1920. Otherwise, the process 1900 moves to block 1918 to close the lid portion 24 and then proceeds to block 1920.

As illustrated, a determination is made as to whether the lid portion 24 is closed at block 1910. For example, as described above, the lid portion 24 may be open even before movement (or presence) of an object is detected if the user uttered a keyword that caused the lid portion 24 to open. If the lid portion 24 is closed, the process 1900 moves to block 1912 to open the lid portion 24 and then proceeds to block 1914. However, if the lid portion 24 is already open, the process 1900 proceeds directly to block 1914.

In some embodiments, the process 1900 moves to block 1914, which can include causing emission of a second radar signal at a second power level using a transmit antenna, causing emission of a second radar signal at a second power level using a transmit antenna and a change to (e.g., a lowering of) the minimum signal strength threshold, and/or causing emission of a second radar signal at a first power level using a transmit antenna and a change to (e.g., a lowering of) the minimum signal strength threshold. In some embodiments, the second power level is greater than the first power level. For example, the trashcan assembly 20 may be in the hyper mode, and the sensing extent of the first sensing region can be increased. In some embodiments, the controller 70 causes the radar sensor 95 to emit the second radar signal in a 3D direction (e.g., toward a front face, a top face, a corner zone in front of and to the side of the trashcan receptacle 20, a side face of the trashcan receptacle 20, and/or any position in between).

As illustrated, the process 1900 can include block 1916 where a determination is made as to whether movement (or presence) of an object is detected, such as in the first sensing region or a second sensing region. For example, a receive antenna of the radar sensor 95 can detect a reflected signal that originates as a result of the transmit antenna of the radar sensor 95 emitting the second radar signal, and a signal processor of the radar sensor 95 can process at least the reflected signal to determine whether movement (or presence) of an object is detected. The radar sensor 95 can then transmit a message to the controller 70 that indicates whether movement (or presence) of an object is detected. For example, the message can be in the form of a high signal (e.g., movement or presence of an object is detected), a low signal (e.g., movement or presence of an object is not detected), an indication of a location of an object (if present), and/or the like. If no movement (or presence) of an object is detected, the process 1900 proceeds to block 1918 and the lid portion 24 is closed. If movement (or presence) of an object is detected, then the process 1900 reverts to block 1914.

In some embodiments, the process 1900 includes a timer or delay before moving to block 1918. For example, the process 1900 can include determining that no further movement (or presence) detection has occurred for at least a predetermined amount of time, such as at least about: 1, 2, 3, or 4 seconds. This can enable a user to briefly leave the first or second sensing regions without the process 1900 continuing to block 1918.

As described above, block 1918 includes closing the lid portion 24 and/or reverting to the ready mode. For example, the controller 70 can send a signal to the motor 78 to close the lid portion 24. In certain implementations, block 1918 includes reducing the amount of power supplied to the radar sensor 95, reducing the extent of the first sensing region, and/or reducing or eliminating the range of the second sensing region. In some embodiments, block 1918 includes reducing or ceasing operation of the transmit antenna of the radar sensor 95.

In some embodiments, the process 1900 moves to block 1920 where a determination is made as to whether a first voice command is detected. For example, the first voice command can be a keyword or wake word (or sound) that is associated with the opening of the lid portion 24. The controller 70, remote system, and/or app can perform speech recognition on an utterance made by a user to determine whether the utterance corresponds to the first voice command. If the first voice command is detected, the process 1900 moves to block 1922 to open the lid portion 24 as verbally instructed by the user. However, if the first voice command is not detected, the process 1900 reverts to block 1904. Thus, voice recognition can be used to open the lid portion 24 even when no movement (or presence) of an object is detected within the first or second sensing regions.

While the process 1900 is described herein with respect to a keyword associated with the opening of the lid portion 24, this is not meant to be limiting. Any keyword associated with any action or state can be used in conjunction with the movement (or presence) detection capabilities of the radar sensor 95 in a similar manner to open and/or close the lid portion 24.

### Controlling Lid Movement

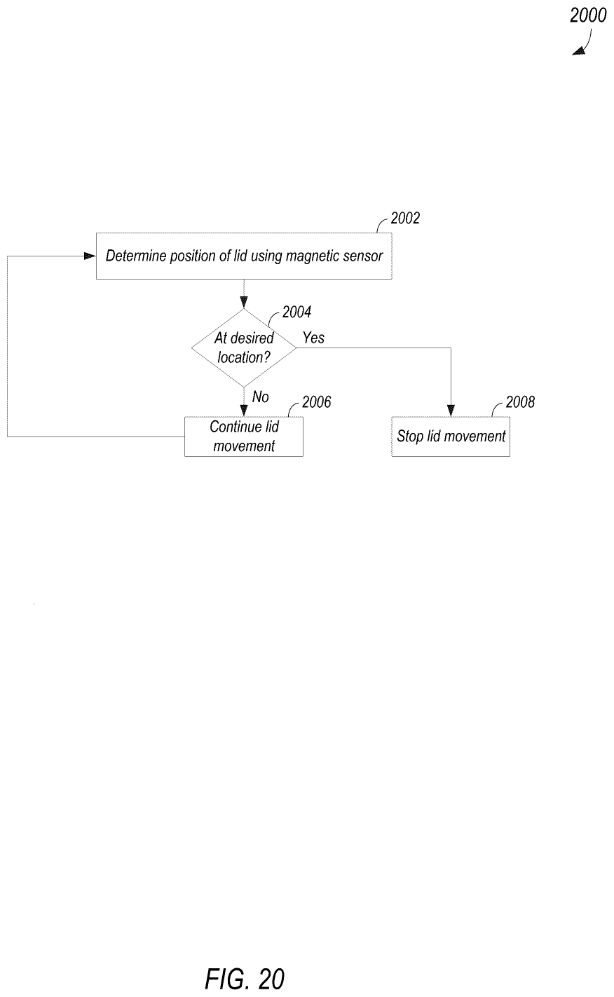

FIG. 20 illustrates an example algorithm process 2000 of controlling movement of the lid portion 24 once the controller 70 determines to move the lid portion 24 to an open position, a closed position, or a position in between. The process 2000 may be performed by controller 70 of trashcan assembly 20. The process 2000 can be implemented, in part or entirely, by a component of the controller 70 or implemented elsewhere in the trashcan assembly 20, for example by one or more processors executing logic or computer-executable instructions in controller 70. In some embodiments, controller 70 includes one or more processors in electronic communication with at least one computer-readable memory storing instructions to be executed by the at least one processor of controller 70, where the instructions cause the trashcan assembly 20 to implement the process 2000.

At block 2002, a position of the lid portion 24 is determined using the magnetic sensor 88. For example, a processor of the controller 70 can receive an indication of a magnetic field value measured by the magnetic sensor 88. The processor of the controller 70 can retrieve a magnetic field value-to-lid position mapping stored in memory of the controller 70, and can use the mapping to determine a position of the lid portion 24 given the received magnetic field value. In some embodiments, the processor may perform an interpolation operation to determine the position of the lid portion 24 if the mapping does not identify a specific lid position for the received magnetic field value (but does identify a specific lid position for a magnetic field value less than the received value and for a magnetic field value greater than the received value). When the controller 70 initially determines to move the lid portion 24 to a new position, the controller 70 may perform block 2002 before causing the motor 78 to activate and begin moving the lid portion 24. This may prevent damage to the motor 78 or other components of the trashcan assembly 20 if, for example, an individual manually moved the lid portion 24 to a fully open position and the controller 70 otherwise determined to open the lid portion 24 or an individual manually moved the lid portion 24 to a fully closed position and the controller 70 otherwise determined to close the lid portion 24.

At block 2004, a determination is made as to whether the lid portion 24 is already at a desired location (e.g., a closed position, an open position, or a position in between). If the received magnetic field value maps to a position that matches the desired location of the lid portion 24, then the process 2000 continues to block 2008 and the controller 70 causes the motor 78 to stop moving the lid portion 24 (e.g., if the motor 78 was already active) or does not send a command to the motor 78 to activate (e.g., if the motor 78 had not yet been activated).

If the received magnetic field value maps to a position that does not match the desired location of the lid portion 24, then the process 1900 continues to block 2006 and the controller 70 causes the motor 78 to continue moving the lid portion 24 (e.g., if the motor 78 was already active) or sends a command to the motor 78 to activate (e.g., if the motor 78 had not yet been activated). The process 2000 then reverts to block 2002.

The process 2000 can be repeated periodically, such as at a frequency that matches or closely matches a frequency at which the motor 78 steps the lid portion 24 between different positions. Thus, the controller 70 can continuously monitor the position of the lid portion 24 and cause the motor 78 to stop movement of the lid portion 24 when the lid portion 24 arrives at the desired location and before the lid portion 24 arrives at a position that could cause friction or other force to be applied to the lid portion 24, motor 78, or other components of the trashcan assembly 20 that could result in damage.

While the disclosure provided herein is directed to trashcan assemblies, this is not meant to be limiting. For example, the features, structures, methods, techniques, and other aspects described herein can be implemented in a hamper, crate, box, basket, drum, can, bottle, jar, barrel, or any other container or receptacle that may include a movable lid.

In-Cabinet Waste-Receiving System with Radar Sensor

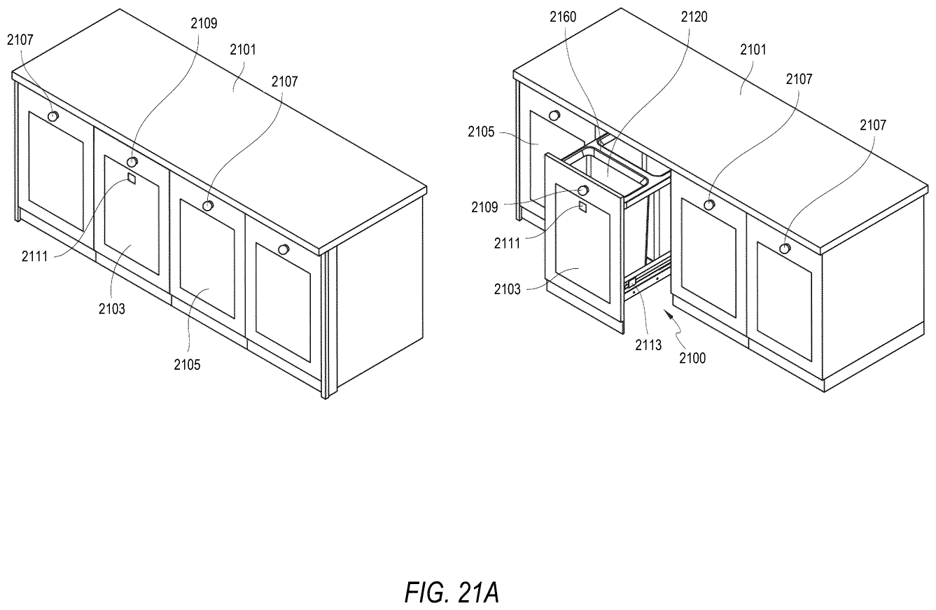

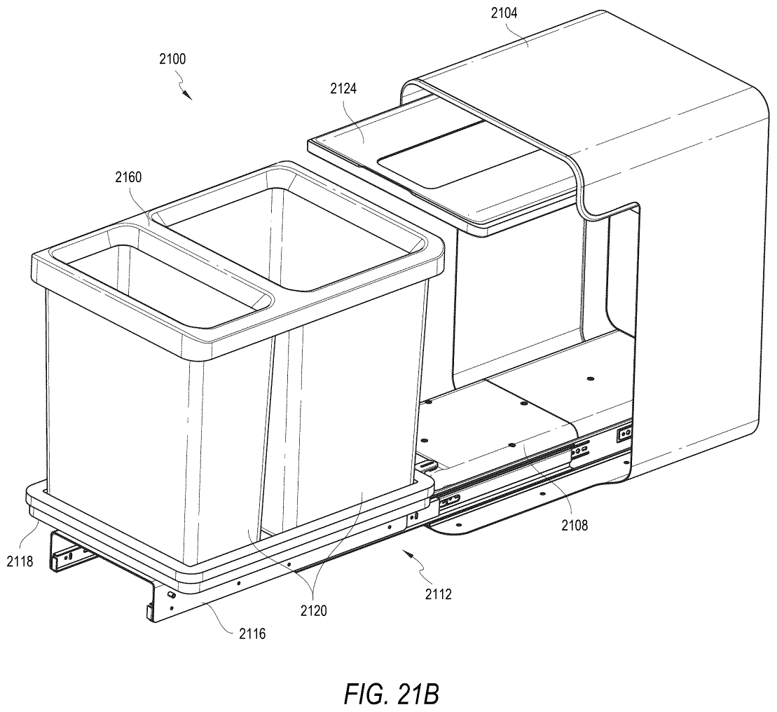

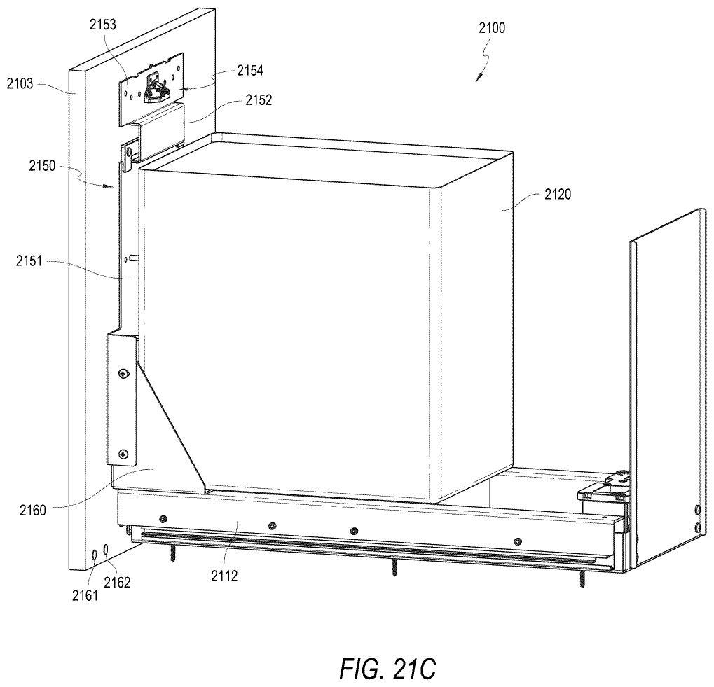

As illustrated in FIG. 21A, a waste-receiving system 2100 can be configured to be placed securely within a permanent or semi-permanent fixture within a building, such as within a dwelling (e.g., a house or apartment), or within a commercial or industrial building, within a school, or within any other type of building. The permanent or semi-permanent fixture can be a cabinet 2101, as shown. In some embodiments, the waste-receiving system 2100 can comprise a movable outer cover or door 2103 that can be similar or identical in appearance to one or more other outer doors 2105 of the cabinet 2101 that are adjacent or close to the movable outer cover or door 2103. The movable outer cover or door 2103 can have approximately the same dimensions of one or more of the other outer doors 2105. The movable outer cover or door 2103 can be generally about the same height, width, and/or length as one or more other outer doors 2105. The movable outer cover or door 2103 can include one or more appearance features that are generally or substantially the same as or similar to those of the other outer doors 2105, such as one or more contours, shapes, bevels, colors, stains, grains, wood types, handles, knobs, insets, etc., that are generally or substantially the same or similar. The waste-receiving system 2100 can include a bracket or region of attachment configured to receive and securely hold the cover or door 2103.

The other outer doors 2105 of the cabinet 2101 can include one or more conventional grasping devices 2107 such as one or more protrusions (e.g., handles, knobs, etc.) or recesses as shown. The movable outer cover or door 2103 or outer interface of the waste-receiving system 2100 can include one or more user-communicators such as user-communication devices 2109, which can comprise a grasping device, such as a handle or knob, that can be similar or identical in appearance to the grasping devices 2107 of the other outer doors 2105, or another device configured to contact, sense, and/or communicate with a user, such as a button, pedal, or other actuator or sensor. The one or more user-communication devices 2109 can be actuated in any useful way, such as by enabling a user to manually open the movable outer cover 2103, to pull the movable outer cover 2103 into the room such that the waste-receiving system 2100 can be transitioned from the closed or retracted position to the open or extended position under the force of the user's action, and/or to sense the presence of a user (e.g., by sensing a user's foot positioned near, underneath, and/or behind a front cabinet door 2103 via a radar sensor, by detecting the utterance of a keyword that matches a keyword associated with opening the waste-receiving system 2100, etc.). In some embodiments, there is no electronic actuator or sensor visible from outside of the waste-receiving system 2100 when in the closed position in normal use, which can help to preserve a normal or traditional look or ambiance for a room. Alternatively or additionally, the one or more user-communication devices 2109 can comprise an electronic actuator, such as a button, switch, touch sensor, radar sensor, LIDAR sensor, proximity sensor, time-of-flight sensor, transducer, and/or microphone, etc., that is configured to communicate with a user, such as by touch or sound, and to generate an electronic signal that is communicated to an electronic processor or controller in the waste-receiving system 2100 which can cause the waste-receiving system 2100 to automatically move under the influence of the electric motor 2264 from the closed to the open position and/or from the open position to the closed position.

The waste-receiving system 2100 can be configured to enable one or more of the user-communication devices 2109 to allow the user to indicate to a processor of the waste-receiving system 2100 that the waste-receiving system 2100 should remain in an open state for an extended period and/or until the user indicates that the waste-receiving system 2100 can return to a closed state. For example, when the user touches or actuates one or more of the user-communications devices 2109, and/or the user hyper extends or pulls or pushes the waste-receiving system 2100 into an open or extended state, the waste-receiving system 2100 can stay in the open or extended state until the user closes the waste-receiving system 2100, until a time-of-flight sensor or proximity sensor indicates that a user is no longer within a threshold distance of the waste-receiving system 2100, or an automated timer can be triggered causing the waste-receiving system 2100 to automatically close after a predetermined time (for example, after at least about three, four, or five minutes). When locking the waste-receiving system 2100 in an open state, the user can remove trash, clean the receptacle(s) 2120, or conduct any other necessary activity with the waste-receiving system 2100 open.

In some embodiments, the waste-receiving system 2100 has one or more opening-actuation sensors 2111 positioned on an exterior, room-facing, and/or forward-facing surface of the waste-receiving system 2100, such as on an outer surface of the movable outer cover or door 2103, as shown. The exterior, room-facing, and/or forward-facing surface can be oriented to face in the direction of motion of the waste-receiving system 2100 as it transitions between the closed or retracted position and the open or extended position. Any sensor, transducer, processor, controller, step, and/or algorithm that is disclosed and/or illustrated anywhere in U.S. Pat. No. 9,856,080, which is incorporated by reference in this specification in its entirety, can be used with or instead of any sensor, transducer, processor, controller, step, and/or algorithm in this specification. In some embodiments, information or data that is generated by the one or more sensors 2111 and communicated to a processor or controller of the waste-receiving system 2100 can be used to determine when the motor 2264 should be used to convey the waste receptacles 2120 into an open position, when the motor 2264 should be used to convey the waste receptacles 2120 into a closed position, and/or when the motor 2264 should stop and start. Computer-executable code stored in electronic memory of the waste-receiving system 2100 can, when executed by a processor or controller of the waste-receiving system 2100, cause the waste-receiving system 2100 to determine how the motor 2264 is controlled based on data received from sensors. For example, in some embodiments, the waste-receiving system 2100 can be configured to advance one or more waste receptacles 2120 from the closed or retracted position to the open or extended position when the one or more sensors 2111 detect that a user is present, near, and/or moving toward or in the direction of the waste-receiving system 2100 and/or when the one or more sensors 2111 detect that a user has made an utterance that matches a keyword or voice command associated with a particular action (e.g., close, open, extend, retract, etc.). The waste-receiving system 2100 can be configured to maintain the one or more waste receptacles 2120 in the open or extended position for a predetermined amount of time (e.g., at least about 30 seconds), until the one or more sensors 2111 no longer detect that a user is present or near the waste-receiving system 2100, until the user touches a sensor, until the user moves the waste-receiving system 2100 by a small amount, and/or until the user utters a particular voice command, at which point the waste-receiving system 2100 can be configured to move the one or more waste receptacles 2120 back into the closed or retracted position. For example, a motor (e.g., motor 2264 discussed herein) can provide the power or force to close the waste-receiving system 2100 by advancing it back into the cabinet. Human force is not necessary or required to close the waste-receiving system 2100. In some embodiments, the one or more sensors 2111 can be configured to detect the user's presence and actuate the waste-receiving system 2100 without requiring the user to perform any additional movement besides simply moving toward or being present in front of the waste-receiving system 2100. For example, the one or more sensors 2111 need not (but can if desired) be configured to require the user to wave, swipe, push a button, or otherwise move in any additional or other way to actuate the waste-receiving system 2100 to move from the closed to the open position and/or to move from the open position to the closed position.

As illustrated, the waste-receiving system 2100 can comprise a movement-monitoring system comprising one or more optional movement-monitoring sensors 2113 and the processor or controller of the waste-receiving system 2100. In some embodiments, as shown, the one or more movement-monitoring sensors 2113 can be positioned on one or more lateral sides of the waste-receiving system 2100, or on or in any other suitable surface or component of the waste-receiving system 2100. The one or more opening-actuation sensors 2111 can be positioned on a surface that is generally perpendicular or orthogonal to the surface on which the movement-monitoring sensors 2113 are positioned, as illustrated. The one or more opening-actuating sensors 2111 can be configured to detect movement or the presence of obstacles in a different dimension or direction than the opening-actuation sensors 2111. In some embodiments, the one or more opening-actuation sensors 2111 can be or can form part of the movement-monitoring system.

In some embodiments, the sensors 2111 can be an accelerometer. The accelerometer can be positioned on the front of the door 2103, within the door 2103, on the inside surface of the door 2103, or in any other location on or within the waste-receiving system 2100. The accelerometer can be used to detect when the advancing door 2103 encounters one or more obstructions, for example, a person or object in front of the door 2103, and/or when a user has manually moved the door 2103, such as by grasping a handle or knob on the door 2103 and pushing or pulling it. The accelerometer can be configured to generate a signal that can be used to stop the motor (e.g., motor 2264) if an obstruction and/or movement of the door 2103 by a user is detected. In some embodiments, the accelerometer can obviate the need for a clutch. The accelerometer 111 can assist in manual opening of the waste-receiving system 2100 by generating a signal to cause the motor 2264 to stop and/or to reverse direction.

In FIG. 21A, one movement-monitoring sensor 2113 is positioned on the right side of the waste-receiving system 2100 and another movement-monitoring sensor 2113 is positioned on the left side of the waste-receiving system 2100 (not shown in the view provided). As the waste-receiving system 2100 moves from the retracted or closed position to the extended or open position, the movement-monitoring system can continuously or intermittently receive information from one or more of the movement-monitoring sensors 2113 about whether the extending or opening of the waste-receiving system into the room can begin or continue to proceed safely, such as without contacting or hitting or moving into a path of movement of something or someone in the room. The movement-monitoring system (e.g., a processor or controller of the movement-monitoring system) can process the received information to determine whether the waste-receiving system 2100 is likely to hit or be hit by an obstacle in the room. If the movement-monitoring system determines from information or data received by one or more of the movement-monitoring sensors 2113 that the waste-receiving system 2100 is likely to hit or be hit by an obstacle in the room, the movement-monitoring system can cause the waste-receiving system 2100 to stop moving and/or to retract or close at the same speed or at an increased speed as compared to the speed at which the waste-receiving system 2100 was extending out or opening.

When the waste-receiving system 2100 encounters or senses resistance to any movement (e.g., opening, moving outward into the extended position, closing, moving inward to the retracted position), computer-executable code stored in an electronic memory and/or in the processor or controller of the waste-receiving system 2100 can, when executed by the processor or controller, cause the processor or controller to determine whether to continue moving, to stop, to move in the same direction at a slower speed, and/or to move in an opposite direction at the same speed, a slower speed, or an increased speed. In some embodiments, the resistance to movement can be sensed by an increase in the electrical power drawn into or required to actuate the electric motor 2264 and/or by a decrease in the speed or rotational velocity (e.g., rotations per minute or RPM) of the electric motor 2264 or any other moving part of the waste-receiving system 2100. The determination made by the processor or controller can be influenced by the magnitude and/or pattern of the sensed resistance. The processor or controller can communicate with or send a signal or a series of signals to the electric motor 2264 to stop or to perform the one or more other movements determined appropriate by the processor or controller. The detection of and response to resistance detected by the waste-receiving system 2100 can help to avoid damage or excessive wear to the waste-receiving system 2100 or other objects, pets, or people.

The waste-receiving system 2100 can be configured to communicate with a separate electronic device, such as through a wired or wireless connection (e.g., Wi-Fi, Bluetooth, etc.). The separate electronic device can be a generally stationary device, such as a desktop computer, a server, a router, etc., and/or a mobile electronic device such as a mobile phone, laptop computer, tablet computer, etc. Computer-executable code stored on the separate electronic device (e.g., code of an application running on the separate electronic device) can, when executed by a processor of the separate electronic device, cause the separate electronic device to communicate with, receive information from, and/or control movement of or settings in the processor or controller of the waste-receiving system 2100. For example, the separate electronic device can communicate with the waste-receiving system 2100 to determine the speed of any movement of the waste-receiving system 2100, the amount of time that it stays open, the sensitivity of the sensors (e.g., whether to trigger an opening action when a user is within a first distance, such as a foot, or within a second distance that is larger than the first distance, such two feet, etc.). In some embodiments, the waste-receiving system 2100 can communicate to the separate electronic device how often the waste-receiving system 2100 is being opened and closed over a certain period of time, whether the contents (e.g., trash) inside of the receptacle have accumulated to the point of substantially filling the receptacle and needing to be removed, whether an onboard supply of one or more reusable supplies (e.g., trash bags) has been substantially used up and needs to be replenished, etc.

In some embodiments, as shown in FIG. 21B, the waste-receiving system 2100 includes a casing 2104. The casing 2104 can be configured to fit snuggly, securely, and/or tightly within a range of standard sized kitchen cabinets, such as at least about 13 inches wide and/or less than or equal to about 16 inches wide, at least about 19 inches in height and/or less than or equal to about 27 inches in height, and/or at least about 20 inches deep and/or less than or equal to about 30 inches deep. In some embodiments, the waste-receiving system 2100 is configured to replace an existing cabinet structure (e.g., internal shelving) such that the existing structure can be removed and the casing 2104 can be inserted. In some embodiments, a series of casing 2104 sizes can be provided for cabinets with different dimensions. Shims or one or more adjustable side, top, bottom, or rear brackets can be used in appropriate situations to allow a casing that is slightly or somewhat smaller than an existing internal cabinet cavity to fit and be attached securely, tightly, and/or snuggly within the cavity. In some embodiments, the casing 2104 can be specially sized for the dimensions of a particular cabinet. In some embodiments, the casing 2104 can comprise at least two, three, or four sides that can be configured to attach to at least two, three, or four sides within the cabinet space.

In some embodiments, the casing 2104 can have a generally annular shape or at least a portion of the casing 2104 can form a generally closed loop. The casing 2104 can comprise a top portion, a bottom portion, a first side portion, and a second side portion. As shown, the bottom portion of the casing 104 may extend further towards a front end of a cabinet as compared to the top portion, first side portion, and second side portion. In some embodiments, the casing 2104 can comprise an outer periphery of the waste-receiving system 2100 that is wider and taller than all other portions of the waste-receiving system 2100 before installation, such that when retracted, all other components of the waste-receiving system 2100 can fit inside, or within the profile of the width and/or height the casing 2104 as illustrated. In some embodiments, the casing 2104 may not be wider or taller than other portions of the waste-receiving system 2100, but may be any structure, such as a bracket, for enabling the waste-receiving system 2100 to attach to an interior space or structure of a cabinet. The casing 2104 may, but is not required to, surround all or a portion of the waste-receiving system 2100. In some embodiments, the casing 2104 can quickly and easily be detachable from the other components of the waste-receiving system 2100, such as even without the use of tools, to help facilitate installation and/or cleaning. The casing 2104 can include brackets, apertures, and/or other features to facilitate tight, snug, secure, and/or close attachment or affixing of the casing 104 inside of a cabinet space. For example, in some embodiments as shown, the casing can be shaped or structured to be attachable to at least two different surfaces inside of a cabinet space, such as at least two opposing surfaces (e.g., left and right walls, top and bottom walls, etc.) or at least two perpendicular surfaces (e.g., a bottom wall and a side wall, a top wall and a side wall, etc.) When the casing 2104 is detached from one or more or all other components of the waste-receiving system 2100, an installation worker can easily reach inside of the casing 2104 to secure or affix the casing 2104 to the interior of the cabinet space on at least one, two, three, and/or four sides and then attach or reattach the other components of the waste-receiving system 100 to and/or within the casing 2104.

As illustrated in FIG. 21B, two or more or all of the casing 2104, the base 2108, the movable portion 2116, the one or more receptacles 2120, the waste receptacle lid 2124, and/or the electric motor 2264, can be combined into an integral or unitary structure that is joined together such that it can be conveniently shipped, transported, and/or installed as a unit. One or more parts of the integral or unitary structure of the waste-receiving system 2100, including any of the parts mentioned here, can be temporarily removed from each other for convenience in installation, service, repair, and/or cleaning.

A base 2108 can be removably fastened to the casing 2104. The bottom surface of the base 2108 can be attached to an inner bottom surface of the casing 2104. In some embodiments, a translating mechanism is affixed to the base 2108. In some embodiments, as shown, the translating mechanism can be a rail system. The rail system can be sliding rails 2112. The translating mechanism can be affixed to a first side and second side of the base 2108. The translating mechanism 2112 can be connected to a movable portion 2116. The movable portion 2116 can be configured to carry one or more waste receptacles 2120. The various waste receptacles 2120 can vary in size and shape.

The waste-receiving system 2100 can further include a waste receptacle lid 2124. The waste receptacle lid 2124 can be configured to close the one or more waste receptacles 2120. The lid 2124 can help to contain or diminish unwanted smells or vapors within the one or more waste receptacles 2120 when the waste-receiving system 2100 is in the retracted or closed position. The waste receptacle lid 2124 can be configured to move relative to the one or more waste receptacles 2120 automatically as the waste-receiving system 2100 moves from the closed or retracted position to the open or extended position and/or from the open or extended position to the closed or retracted position. In some embodiments, the opening and closing of the lid 2124 can occur mechanically without any electrical assistance. In some embodiments, the opening and closing of the lid 2124 can be performed with the use of one or more electrical motors, electrical solenoids, and/or electrical linear actuators.

FIG. 21C shows an embodiment of a waste-receiving system 2100. In some embodiments, the outer cover or door 2103 can be connected to the waste-receiving system 2100 via a mount 2150. The mount 2150 can include a first mount portion 2151 that is coupled to the door 2103. The first mount portion 2151 can be coupled to a second mount portion 2160 that is connected to or above the sliding rails 2112.

The waste-receiving system 2100 can include a sensor mount 2154. The sensor mount 2154 can be positioned on the inside side of the cover or door 2103. The sensor mount 2154 can be connected to a mounting plate 2153 that is connected to the inside of the door 2103. The mounting plate 2153 can be connected to the mount 2150 via a connecting plate 2152.

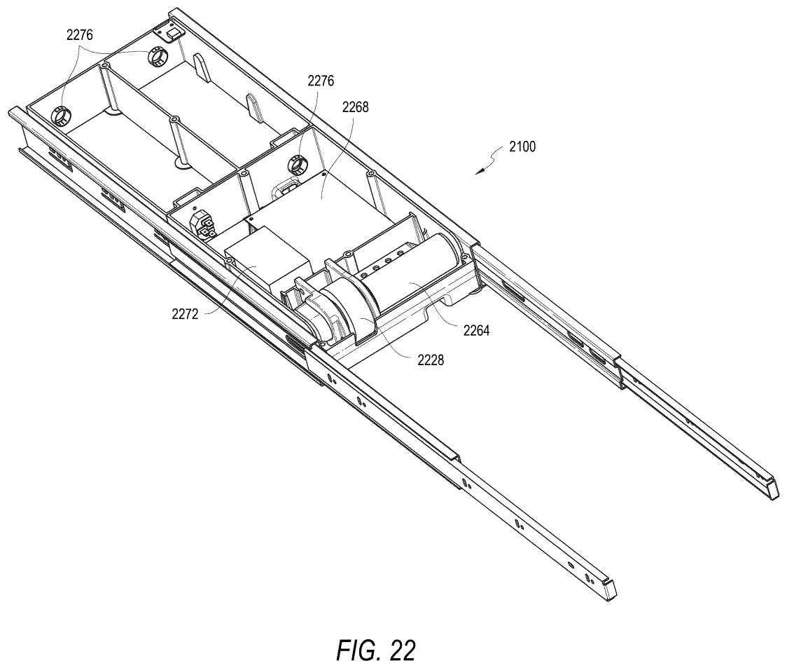

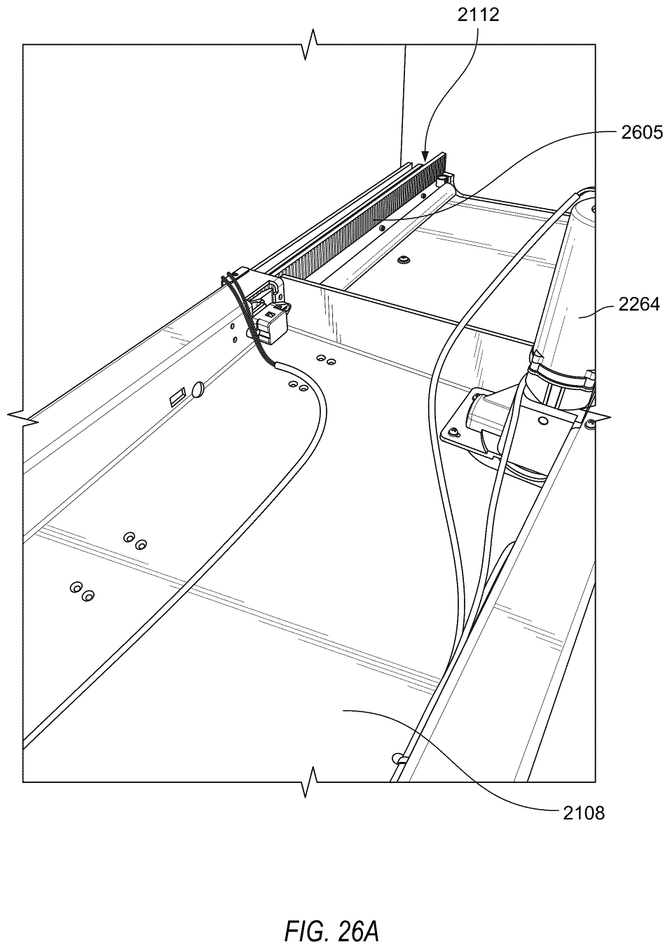

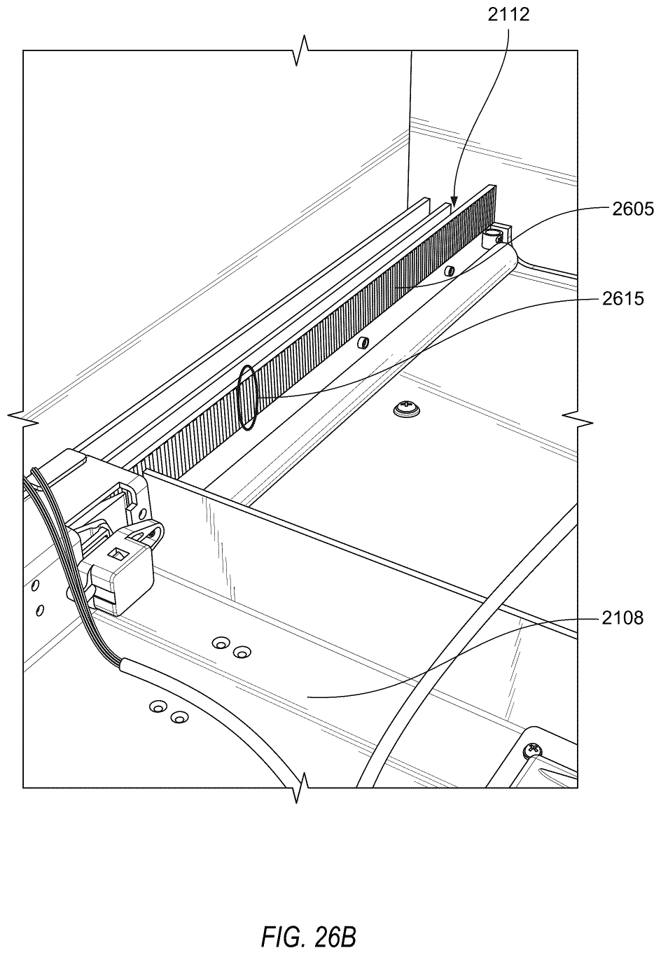

Turning to FIG. 22. FIG. 22 depicts an embodiment of the waste-receiving system 2100. The drive wheel 2228 is shown connected to a motor 2264. The motor 2264 can be an electric motor. In some embodiments, the motor 2264 can be controlled by a controller 2268. In some embodiments, the motor 2264 can receive power from a power supply 2272. As illustrated, in some embodiments the motor 2264 is positioned on a lower side or region of the waste-receiving system 2100, such that in the closed or retracted position, the motor 2264 is generally enclosed within and/or positioned below the top surface of the base 2108 and/or is positioned directly below one or more of the receptacles 2120. In other embodiments, not shown, the motor 2264 is positioned on a lower side or region of the waste-receiving system 2100, such that in the closed or retracted position, the motor 2264 is positioned above the top surface of the base 2108 and/or is positioned directly behind one or more of the receptacles 2120 (see FIG. 26A). The motor 2264 can be configured to provide power or force to open the waste-receiving system 2100. The motor 2264 can be configured to provide power or force to close the waste-receiving system 2100. Outside human force is not necessary to open and/or close the waste-receiving system 2100. However, the waste-receiving system 2100 may be configured to properly open and/or close the waste-receiving system 2100 subsequent to the use of human force to open and/or close the waste-receiving system 2100, as described in greater detail below.

In some embodiments the motor 2264 can be positioned in the back of the waste-receiving system 100. For example, the motor 2264 can be positioned between the waste receptacle(s) 2120 and a rear wall of a cabinet, or the motor 2264 can be positioned in contact with the rear wall of the cabinet, or the motor 2264 can be positioned between the sliding rails 2112. By providing the motor 2264 in one or more of these positions, the waste receptacle(s) 2120 can have a large volume. For example, the bottom of the one or more waste receptacle(s) 2120 can be positioned below the top of one or more of the rails 2112, and/or the waste receptacle(s) 2120 can be positioned to sit directly on a bottom surface (e.g., a surface that is configured to be adjacent to, proximate to, and/or essentially coplanar with the bottom of the cabinet in which the waste-receiving system is mounted), allowing for an increase in waste receptacle(s) 2120 volume between the sliding rails 2112. The volume of the waste receptacle(s) 2120 can increase by about 10% to about 15%. The motor 2264 being positioned in the rear or back of the waste-receiving system 2100 can allow for the motor 2264 to be hidden from view of the user.

The controller 2268 can receive signals from one or more of a variety of different types of sensors. In some embodiments, the sensors can include one or more light sensors (e.g., one or more infrared sensors, time-of-flight sensors, etc.), heat sensors, stress/strain sensors, touch sensors, sound sensors (e.g., one or more microphones), radar sensors, LiDAR sensors, and/or any other type of sensors. In some embodiments, the controller 2268 can receive signals from the motor 2264. In some embodiments, the controller 2268 can receive/send signals from/to the power supply 2272. The base 2108 can include one or more fenestrations 2276. The fenestrations 2276 can be useful to route power to the power supply 2272.

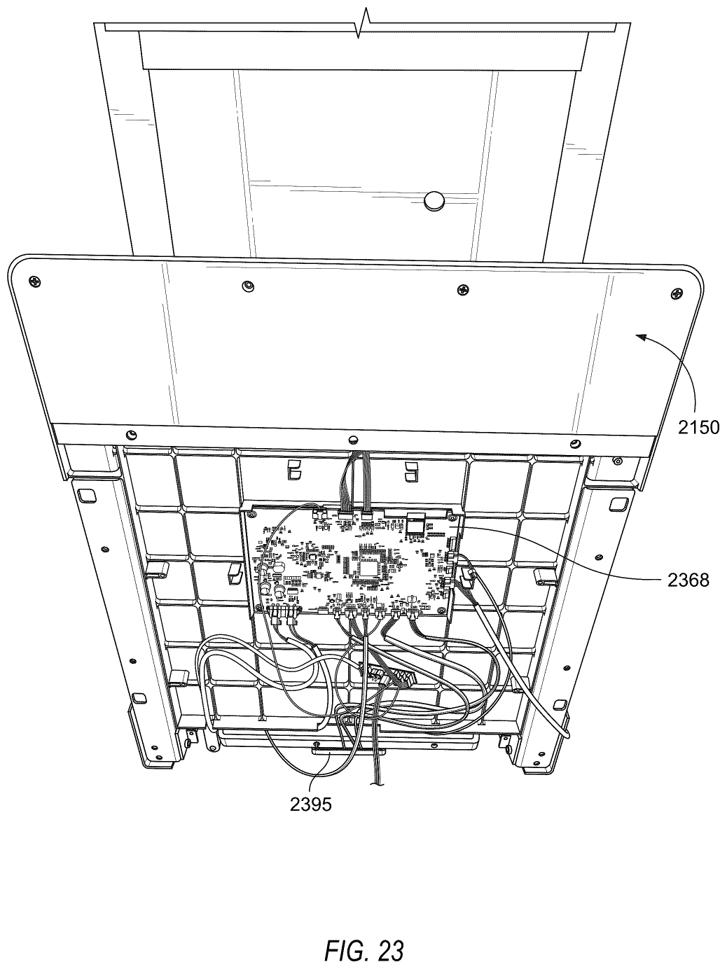

FIG. 23 shows another embodiment of the waste-receiving system 2100. In some embodiments, a controller 2368 can be coupled to a side of the mount 2150 that connects the outer cover or door 2103 to the waste-receiving system 2100. The controller 2368 may be positioned between the outer cover or door 2103 and the mount 2150 when the outer cover or door 2103 is connected to the waste-receiving system 2100. The controller 2368 may perform any or all of the same functionality as the controller 2268. Thus, the controller 2368 may be installed in place of the controller 2268 and no controller 2268 or 2368 may be positioned below the base 2108. Alternatively, the waste-receiving system 2100 may include both the controller 2268 and the controller 2368.

The controller 2368 may be coupled to a radar sensor 2395, a proximity sensor (e.g., a time-of-flight sensor, an infrared sensor, etc.), not shown, and/or a transducer (e.g., a microphone), not shown, via one or more wired and/or wireless connections (e.g., one or more cables, one or more wireless transceivers, etc.). The controller 2368 may supply power to the radar sensor 2395 and/or the proximity sensor. Alternatively, the radar sensor 2395 and/or proximity sensor may receive power directly from the power supply 2272.

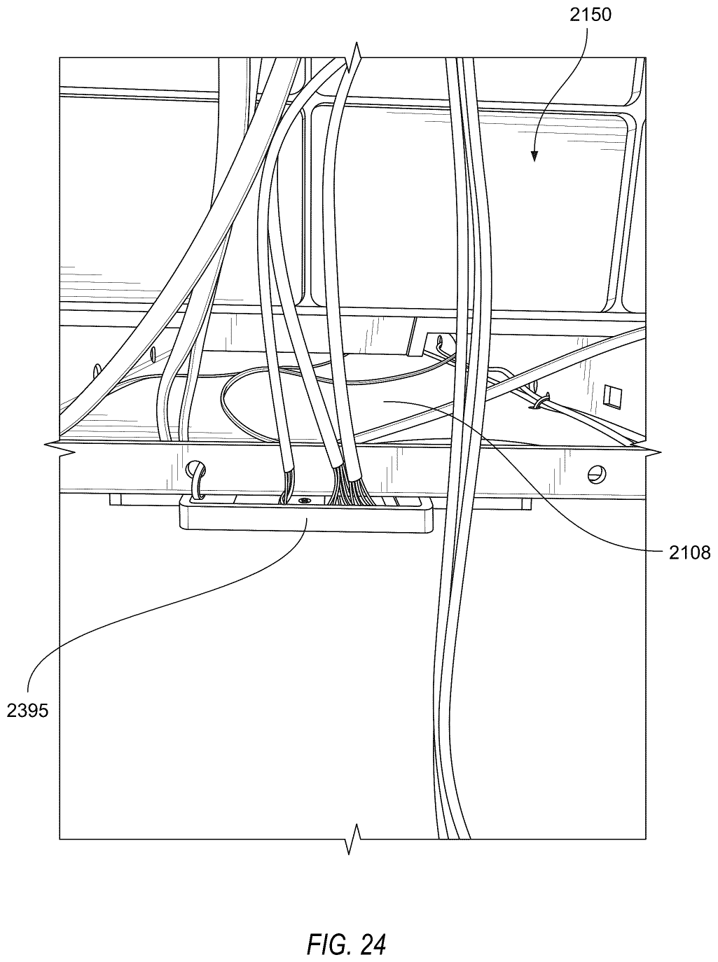

The radar sensor 2395 may be coupled to a front and outer bottom portion of the base 2108 (e.g., a front bottom surface of the base 2108) (see FIG. 24) and/or to an outer bottom surface of the casing 2104. The radar sensor 2395 may include a signal processing unit, a single transmit antenna and one or more receive antennas (e.g., 1, 2, 3, 4, etc.) on a single chip or printed circuit board (PCB). The transmit antenna of the radar sensor 2395 may be capable of emitting a signal in some or all directions outward from the PCB, and the receive antenna(s) may be positioned to detect reflected signals originating from different angles and/or directions. For example, the transmit antenna of the radar sensor 2395 may be positioned to emit a signal outward from the PCB towards the ground (e.g., locations below the waste-receiving system 2100). In particular, the bottom of the cabinet 2101 may be positioned on the ground. The bottom of the outer cover or door 2103, the bottom of the outer doors 2105, and/or the base 2108, however, may be positioned a certain height above the ground (e.g., at least about: 2 inches, 2.5 inches, 3 inches, 3.5 inches, 4 inches, 4.5 inches, etc. above the ground). The outer cover or door 2103, the outer doors 2105, and/or a front portion of the base 2108 (e.g., a side of the base 2108 that is closer to the outer cover or door 2103) may also extend outward a certain distance (e.g., at least about: 1 inch, 1.5 inches, 2 inches, 2.5 inches, etc.) from the cabinet 2101 when the waste-receiving system 2100 is in a closed position, thereby creating open space between a bottom of the front of the outer cover or door 2103 and/or of the outer doors 2105, a bottom of the front portion of the base 2108, and a bottom portion of the front of the cabinet 2101 (e.g., a baseboard of the cabinet 2101, which may be positioned underneath the waste-receiving system 2100 and be coupled to the ground). The open space may be large enough for a portion of an individual's foot to be placed therein. The transmit antenna of the radar sensor 2395 may be positioned to point toward the open space when the waste-receiving system 2100 is in a closed position in an attempt to detect objects that enter the open space (e.g., an individual's foot). In some embodiments, the radar sensor 2395 may be exposed to the open space (e.g., exposed to an exterior of the waste-receiving system 2100). In some embodiments, a protective cover or another component of the waste-receiving system 2100 may enclose the radar sensor 2395 within the waste-receiving system 2100 such that the radar sensor 2395 is not visible to a user when viewing any portion of the open space (e.g., such that the radar sensor 2395 is hidden from view when the waste-receiving system 2100 is in a closed or retracted position).

Thus, when coupled to the front and bottom portion of the base 2108, the receive antenna(s) of the radar sensor 2395 may be capable of detecting the presence or movement of an individual's foot (or hand or other object being controlled by the individual) that is placed below the outer cover or door 2103, the outer doors 2105, and/or a front portion of the base 2108. Placement of an individual's foot (or hand or other object being controlled by the individual) into the open space may indicate that the individual is standing in front of the outer cover or door 2103 and plans to use the receptacle 2120. Thus, if the presence or movement of an individual or object is detected by the receive antenna(s), the radar sensor 2395 may transmit a signal to the controller 2368 indicating that an object is detected. If the waste-receiving system 2100 is currently in a closed position, the controller 2368 may transmit a signal to the motor 2264 that causes the motor 2264 to move the waste-receiving system 2100 into an open or extended position (e.g., that actuates the motor 2264 to move the waste-receiving system 2100 (e.g., the receptacle 2120) into an open or extended position). If the waste-receiving system 2100 is currently in an extended position, the controller 2368 may transmit a signal to the motor 2264 that causes the motor 2264 to move the waste-receiving system 2100 into an open or further extended position or take no action (e.g., the controller 2368 may allow the waste-receiving system 2100 to remain in the extended position). If the waste-receiving system 2100 is currently in an open position, the controller 2368 may not take any action, including not transmitting a signal to the motor 2264 that causes the motor 2264 to move the waste-receiving system 2100 into a closed or retracted position (e.g., the controller 2368 may allow the waste-receiving system 2100 to remain open).

The radar sensor 2395 may be configured to periodically emit signals, regardless of the position of the waste-receiving system 2100. Thus, the receive antenna(s) may detect reflected signals regardless of the position of the waste-receiving system 2100. Using a radar sensor 2395 to detect an object in the open space (or in any space below the waste-receiving system 2100 when the waste-receiving system 2100 is in an open, extended, or retracted position) may produce more accurate object detection results than by using other types of sensors. The distance between the bottom of the base 2108 and the ground in which it is desired to detect objects may be small (e.g., no more than about: 2 inches, 2.5 inches, 3 inches, 3.5 inches, 4 inches, 4.5 inches, etc.). A proximity sensor like an infrared sensor may produce noisy or unclear results when used to detect objects over such a short distance because the short distance may result in too much light emitted by the sensor being reflected between the ground and the bottom of the base 2108. This excessive reflectance can be exacerbated by the type of material of the ground or floor. For example, tile, certain types of wood, laminate, and/or other common floor types found in kitchens, laundry rooms, or other rooms where receptacles 2120 may be placed may cause excessive reflectance. The radar sensor 2395, however, does not rely on light to detect objects, and therefore the results produced by the radar sensor 2395 are not affected by excessive reflectance.

While the present disclosure describes the use of a radar sensor 2395 to detect the presence of an object below the waste-receiving system 2100 (e.g., in the open space when the waste-receiving system 2100 is in a closed position or in in any space below the waste-receiving system 2100 when the waste-receiving system 2100 is in an open, extended, or retracted position), this is not meant to be limiting. For example, a LIDAR sensor, a contact sensor, an ultrasonic sensor, a microwave sensor, a tomographic sensor, a vibration motion sensor, a camera, and/or the like may replace the radar sensor 2395 and be used to detect the presence of an object below the waste-receiving system 2100.

FIG. 24 shows a front view of a portion of the mount 2150, a front view of the base 2108, and the radar sensor 2395. As illustrated in FIG. 24, the radar sensor 2395 may be coupled to an outer bottom surface of the base 2108 and/or an outer bottom surface of the casing 2104. In some embodiments, the radar sensor 2395 is enclosed in a casing that is coupled to the outer bottom surface of the base 2108 and/or the outer bottom surface of the casing 2104 and that supports the radar sensor 2395 at a height above ground height. If the radar sensor 2395 is enclosed in a casing, the casing may be formed from a material that allows the transmit antenna of the radar sensor 2395 to emit signals external to the casing and that allows the receive antennas to detect reflected signals originating from external to the casing.

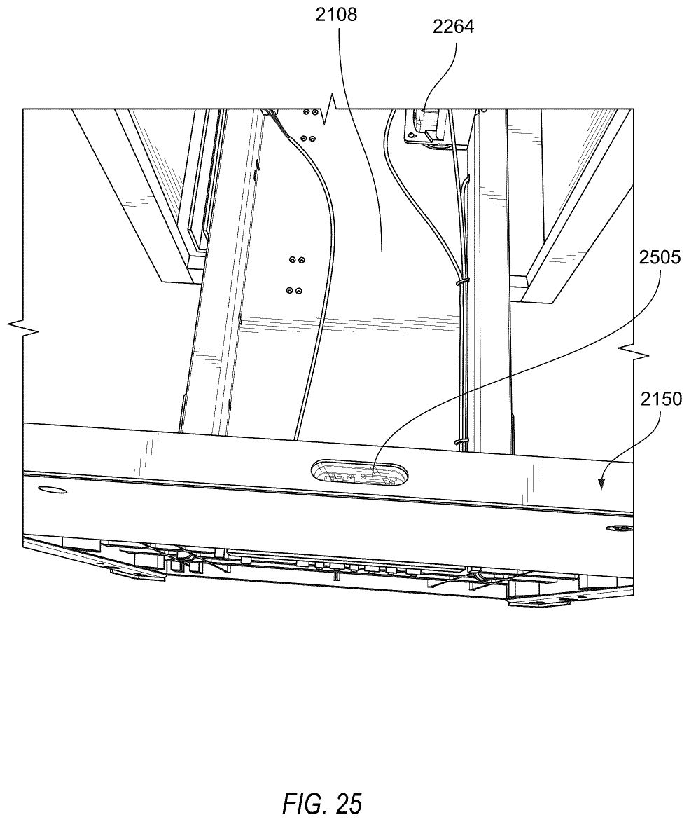

FIG. 25 shows a top view of the mount 2150. The top surface of the mount 2150 may include a recessed enclosure in which a proximity sensor 2505 is positioned. For example, the proximity sensor 2505 may be a time-of-flight sensor or an infrared sensor that includes one or more transmitters that emit light and/or one or more receivers that detect reflected light. As described herein, the proximity sensor 2505 may be coupled to the controller 2368 via a wired or wireless connection (e.g., one or more cables, a wireless transceiver, etc.). When the waste-receiving system 2100 is in a closed position, the proximity sensor 2505 may be hidden from view and be positioned underneath an inner top surface of the cabinet 2101. The proximity sensor 2505 may enter an off or sleep state when the waste-receiving system 2100 is in the closed position to reduce energy consumption.

When the waste-receiving system 2100 is in an open, extended, or retracted position, the proximity sensor 2505 may periodically emit light outward from the top surface of the mount 2150. If the proximity sensor 2505 detects reflected light subsequent to emission of the light outward from the top surface of the mount 2150, the proximity sensor 2505 may determine that an object (e.g., an individual's hand, arm, torso, head, etc.) is detected and can transmit a signal to the controller 2368 indicating the same. As described in greater detail below, the controller 2368 may the instruct the motor 2264 (e.g., actuate the motor 2264) to move the waste-receiving system 2100 from an open or extended position to a closed or retracted position if no object is detected by the proximity sensor 2505 after a set amount of time (and the controller 2368 has not otherwise received an instruction to stay in an open or extended position) and/or may take no action if the waste-receiving system 2100 is in an open or extended position and the proximity sensor 2505 detects an object (and the controller 2368 has not otherwise received an instruction to move to a closed or retracted position).

The region in which the proximity sensor 2505 emits light may extend upward from the top surface of the mount 2150 in a cone shape that extends from a middle portion of the top surface of the mount 2150 outward towards each lateral end of the top surface of the mount 2150. The region in which the proximity sensor 2505 emits light may be perpendicular to the top surface of the mount 2150 and/or approximately perpendicular to the top surface of the mount 2150 (e.g., within 5° of an axis that is perpendicular to the top surface of the mount 2150, within 10° of an axis that is perpendicular to the top surface of the mount 2150, within 15° of an axis that is perpendicular to the top surface of the mount 2150, within 20° of an axis that is perpendicular to the top surface of the mount 2150, etc.).

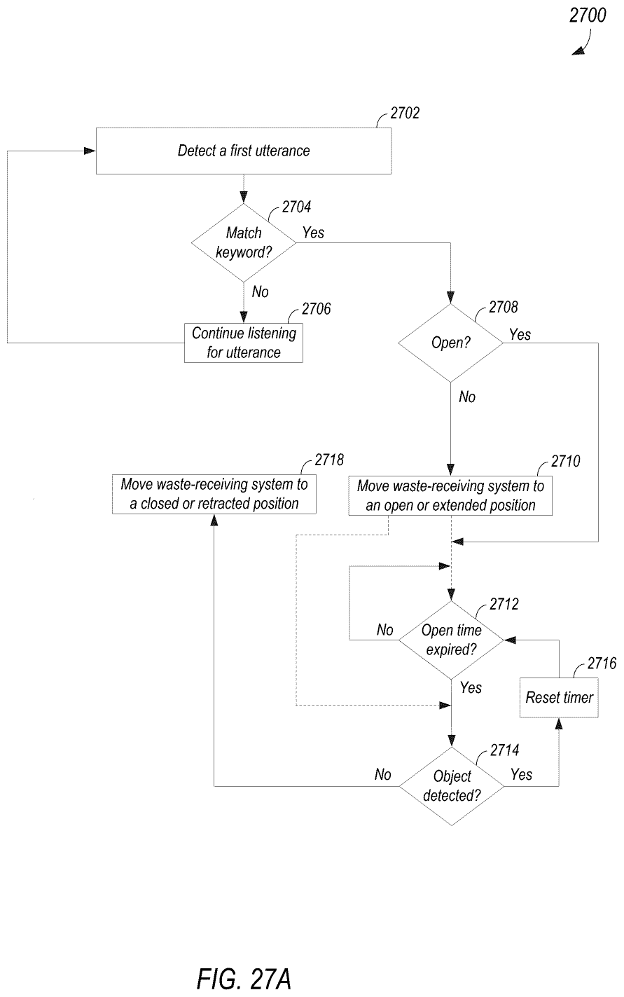

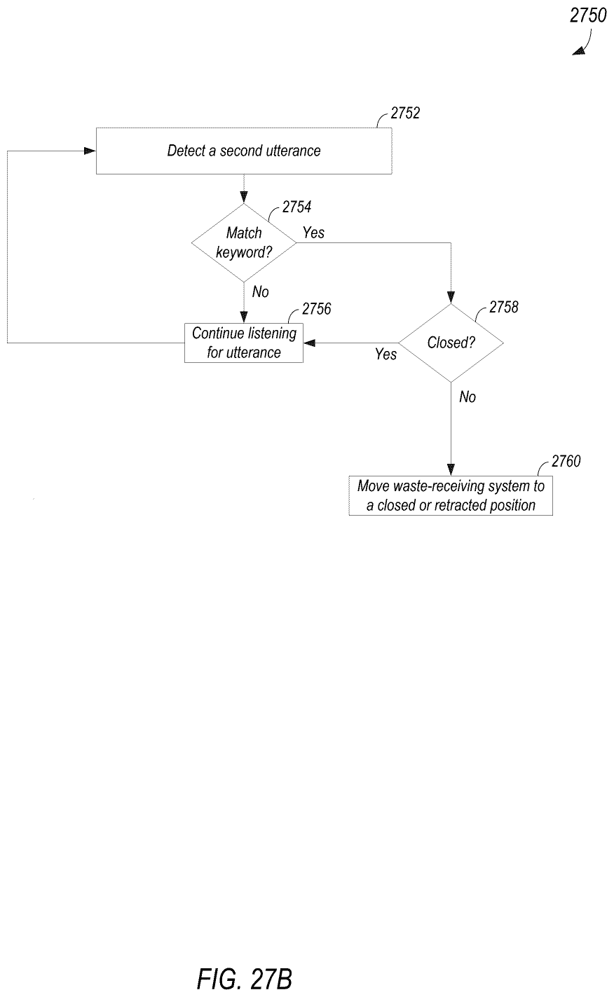

The waste-receiving system 2100 may include both the sensor(s) 2111 and the proximity sensor 2505 or just one of the sensor(s) 2111 or the proximity sensor 2505. In an embodiment in which the sensor(s) 2111 are not present, the controller 2368 may rely on the proximity sensor 2505, the radar sensor 2395, and/or one or more optical sensors 2605 (see FIGS. 26A-26B) to determine where to position the waste-receiving system 2100. Different scenarios in which the controller 2368 uses the proximity sensor 2505, the radar sensor 2395, and/or the optical sensor(s) 2605 to determine where to position the waste-receiving system 2100 are described in greater detail below with respect to FIGS. 27A, 27B, 28, and 29.

FIGS. 26A-26B depict one or more optical sensors 2605 of the sliding rails 2112. As described herein, the sliding rails 2112 may include a left sliding rail 2112 that is coupled to a first side of the base 2108 (where the first side of the base 2108 may not be the front or rear sides of the base 2108) and a right sliding rail 2112 that is coupled to a second side of the base 2108 (where the second side of the base 2108 may not be the front or rear sides of the base 2108). As illustrated in FIGS. 26A-26B, a portion of the sliding rails 2112 may include one or more vertical (or horizontal or lateral) slits or openings through which one or more optical sensors 2605 may emit light and/or one or more vertical (or horizontal or lateral) markers that can be applied using adhesive or paint that can be perceived by the optical sensor(s) 2605. FIG. 26B illustrates an example vertical opening or marker 2615. The openings or markers 2615 may be equally or nearly equally spaced apart along the sliding rails 2112 and traverse the sliding rails 2112 in a direction that ranges from a front of the cabinet 2101 to a rear of the cabinet 2101. For example, the portion of the sliding rails 2112 that include the openings or markers 2615 through which one or more optical sensors 2605 may emit light and/or that can be perceived by the optical sensor(s) 2605 may be a portion that extends passed the waste-receiving system 2100 when the waste-receiving system 2100 is in at least one of an open, extended, or retracted position. In other words, the portion of the sliding rails 2112 that include the openings or markers 2615 through which one or more optical sensors 2605 emit light and/or that can be perceived by the optical sensor(s) 2605 may be the portion of the sliding rails 2112 that ranges from the position of the sliding rails 2112 that is closest to the rear of the cabinet 2101 to the position of the sliding rails 2112 that is perpendicular to a rear portion of the base 2108 when the waste-receiving system 2100 is in an open position (or any other position in which the waste-receiving system 2100 cannot be further extended outside of the cabinet 2101).

Alternatively, one of the left or right sliding rails 2112, but not both, may include one or more openings or markers 2615 through which one or more optical sensors 2605 may emit light and/or that can be perceived by the optical sensor(s) 2605. In still another alternative, not shown, the openings or markers 2615 may be positioned laterally or flat on a top surface of the base 2108 (or on a top surface of the bottom of the casing 2104), with the openings or markers 2615 positioned on the top surface of the base 2108 (or on a top surface of the bottom of the casing 2104) in place of or in addition to the openings or markers 2615 being positioned on the sliding rails 2112. For example, the openings or markers 2615 can each be positioned such that a long edge of the openings or markers 2615 extend partially or fully from the left sliding rail 2112 toward the right sliding rail 2112, or vice-versa, and a short edge of the openings or markers 2615 extend in a direction that parallels the sliding rails 2112. Alternatively, the openings or markers 2615 can each be positioned such that a short edge of the openings or markers 2615 extend partially or fully from the left sliding rail 2112 toward the right sliding rail 2112, or vice-versa, and a long edge of the openings or markers 2615 extend in a direction that parallels the sliding rails 2112. In still another alternative, the openings or markers 2615 can be square, circular, or another shape. As described herein, no matter the shape, size, or direction in which the openings or markers 2615 are oriented, the openings or markers 2615 may be spaced and positioned at different points along a direction between a front of the cabinet 2101 and a rear of the cabinet 2101. In an embodiment in which the openings or markers 2615 are positioned on the sliding rails 2112, the optical sensor(s) 2605 may be oriented to detect reflected light or the openings or markers 2615 in a lateral direction (e.g., in a direction that is parallel with a top surface of the base 2108). For example, the optical sensor(s) 2605 may be positioned inside the openings or mark ers 2615 or opposite to the openings or markers 2615 (e.g., on an opposing sliding rail 2112). In an embodiment in which the openings or markers 2615 are positioned on the top surface of the base 2108, the optical sensor(s) 2605 may be oriented downward to detect reflected light or the openings or markers 2615. For example, the optical sensor(s) 2605 may be positioned above the top surface of the base 2108 (e.g., above the top surface of the base 2108 and below the bottom surface of the receptacle 2120 such that the optical sensor(s) 2605 may move with the waste-receiving system 2100, above the top surface of the base 2108 and above the receptacle 2120 such that the optical sensor(s) 2605 do not move with the waste-receiving system 2100, etc.) and/or above the receptacle 2120 (such as on a bottom surface of the top of the casing 2104).

The sliding rails 2112 or the casing 2104 may include one or more sensors for detecting the position of the trashcan or holder of the trashcan as it progresses between the closed and opened positions, such as a single optical sensor 2605 or multiple optical sensors 2605. For example, the sliding rails 2112 or the casing 2104 may include a single optical sensor 2605 for each opening or marker. A marker can comprise a (vertical or horizontal or lateral) stripe that can be applied using adhesive or paint, a (vertical or horizontal or lateral) opening, or any other marker that can be perceived by the optical sensor(s) 2605. In some embodiments, a position-sensing system can comprise one optical sensor 2605 for each opening or marker 2615, a single optical sensor 2605 for a group of, but not all of, the openings or markers 2615, and/or a single optical sensor 2605 for all of the openings or markers 2615. In an embodiment in which the sliding rails 2112 or the casing 2104 includes a single optical sensor 2605 for a group of or all of the openings or markers 2615, each optical sensor 2605 may include a transmitter (or multiple transmitters) that is capable of emitting light through or toward multiple openings or markers 2615 and/or may include a receiver (or multiple receivers) for each opening or marker 2615 associated with the respective optical sensor 2605 such that the respective optical sensor 2605 can determine through which opening or marker 2615 reflected light passed and/or can determine which opening or marker 2615 was detected. In an embodiment in which the sliding rails 2112 or the casing 2104 includes a single optical sensor 2605 for each opening or marker 2615, each optical sensor 2605 may include a transmitter (or multiple transmitters) that is capable of emitting light through or toward a single opening or marker 2615 (e.g., the opening or marker 2615 associated with the respective optical sensor 2605) and/or may include a receiver (or multiple receivers) that is capable of detecting light reflected through the associated opening or marker 2615 such that the respective optical sensor 2605 can determine whether light passed through the associated opening or marker 2615 and/or that is capable of determining whether the associated opening or marker 2615 is detected. Alternatively, the optical sensor(s) 2605 may include one or more image sensors in place of or in addition to transmitter(s) and/or receiver(s) in order to detect the presence of one or more openings or markers 2615, where each image sensor may be associated with one or more openings or markers 2615.

The optical sensor(s) 2605 may each emit light outward toward the marker, such as through openings 2615, in a direction that is perpendicular to the left and right sliding rails 2112 via one or more transmitters. If the waste-receiving system 2100 is in a position in which the waste-receiving system 2100 intersects with the light emitted by a particular optical sensor 2605, light may be reflected off the waste-receiving system 2100 and detected by one or more receivers of the particular optical sensor 2605. Each optical sensor 2605 may be in communication with the controller 2368 via a wired or wireless connection (e.g., one or more cables, a wireless transceiver, etc.). In response to an optical sensor 2605 detecting reflected light, the optical sensor 2605 may determine that an object is present in front of the optical sensor 2605 and transmit a signal to the controller 2368 indicating the same (where the signal may indicate the optical sensor 2605 that detected an object, the optical sensor 2605 receiver that detected an object, and/or an indication of the associated opening or marker). Alternatively or in addition, in response to an optical sensor 2605 not detecting reflected light (and therefore emitted light reaches a marker or the marker is otherwise detected), the optical sensor 2605 may determine that an object is not present in front of the optical sensor 2605 and transmit a signal to the controller 2368 indicating the same.

The controller 2368 can collectively use the signals provided by the optical sensor(s) 2605 to determine a position of the waste-receiving system 2100. In some embodiments, the controller 2368 can count the number of markers detected by the optical sensor(s) 2605 as the trashcan or trashcan support moves out or in between the closed and the opened positions, and thereby determine the location of the trashcan or trashcan support. Determining the location can be useful in deciding when to stop moving in either direction. In some embodiments, the controller 2368 may determine that the waste-receiving system 2100 is in a closed position if the optical sensor 2605 that emits light through or toward the opening or marker 2615 that is closest to the rear of the cabinet 2101 detects an object. Likewise, the controller 2368 may determine that the waste-receiving system 2100 is in an open position (or any other position in which the waste-receiving system 2100 cannot be further extended outside of the cabinet 2101) if the optical sensor 2605 that emits light through or toward the opening or marker 2615 that is closest to the front of the cabinet 2101 detects an object. The controller 2368 can similarly determine that the waste-receiving system 2100 is in a position between the open position and the closed position and the specific position of the waste-receiving system 2100 based on signals provided by two adjacent optical sensors 2605 associated with adjacent openings or markers 2615 that provide different indications of whether an object is detected (e.g., one optical sensor 2605 detects an object and the other does not) and/or based on a signal provided by a single optical sensor 2605 that includes two adjacent receivers corresponding to adjacent openings or markers 2615 in which one receiver detects reflected light and the other does not.

The number of openings or markers 2615 may determine the resolution at which the controller 2368 can determine the position of the waste-receiving system 2100. Thus, the number of openings or markers 2615 is variable and can be set to meet the desired resolution at which to measure the position of the waste-receiving system 2100.

By using the optical sensor(s) 2605 to determine the position of the waste-receiving system 2100, the controller 2368 can determine how long the motor 2264 should run to open, extend, retract, or close the waste-receiving system 2100 and can instruct the motor 2264 accordingly. For example, the controller 2368 may have access to data stored in memory of the controller 2368 that indicates the relative location of each optical sensor 2605 and/or each receiver of each optical sensor 2605, such as a mapping between each optical sensor 2605 and/or each receiver of each optical sensor 2605 and the corresponding opening or marker 2615. The data may further indicate the opening or marker 2615 that is closest to a rear of the cabinet 2101, the opening or marker 2615 that is closest to a front of the cabinet 2101, the optical sensor 2605 that is closest to a rear of the cabinet 2101, the optical sensor 2605 that is closest to a front of the cabinet 2101, an optical sensor 2605 receiver that is closest to a rear of the cabinet 2101, and/or an optical sensor 2605 receiver that is closest to a front of the cabinet 2101. The data may further indicate an opening or marker 2615, an optical sensor 2605, and/or an optical sensor 2605 receiver that is associated with an open position, an extended position, a closed position, a retracted position, and/or any other position of the waste-receiving system 2100. In general, the data may indicate the opening or marker 2615, an optical sensor 2605, and/or an optical sensor 2605 receiver that is associated with or mapped to some or all possible positions of the waste-receiving system 2100. The data may further indicate a spacing or distance between each opening or marker 2615, each optical sensor 2605, and/or each optical sensor 2605 receiver.

In response to a determination by the controller 2368 that the waste-receiving system 2100 should be moved to a first position, the controller 2368 can use the signal(s) received from the optical sensor(s) 2605 to determine a current position of the waste-receiving system 2100. For example, the controller 2368 can determine a position of the waste-receiving system 2100 based on the optical sensor 2605 and/or optical sensor 2605 receiver that is closest to a rear of the cabinet 2101 that detects an object (where the position of the waste-receiving system 2100 may be defined based on the location of the rear surface of the base 2108 (e.g., the rear surface of the waste-receiving system 2100). The controller 2368 can further use the data stored in memory to determine how to instruct the motor 2264. For example, the controller 2368 can determine a distance between the current position and the first position using the data, where the distance may be represented as a physical measurement (e.g., in inches or centimeters), a number of openings or markers 2615 (where it may be known to the controller 2368 the distance between each opening or markers 2615 via the stored data), a number of optical sensors 2605 (where it may be known to the controller 2368 the distance between each optical sensor 2605 via the stored data), and/or a number of optical sensor 2605 receivers (where it may be known to the controller 2368 the distance between each optical sensor 2605 receiver via the stored data). The controller 2368 may further determine a direction in which the waste-receiving system 2100 would need to move to reach the first position from the current position using the stored data. The motor 2264 may operate at a set RPM or the controller 2368 can set the RPM of the motor 2264. The controller 2368 can use the motor 2264 RPM to calculate a time it would take the motor 2264 to move the waste-receiving system 2100 from the current position to the first position given the distance between the two positions. The controller 2368 can then instruct the motor 2264 to run for the calculated time and move the waste-receiving system 2100 in the determined direction.

As another example, the controller 2368 can use the stored data to determine a marker such as an opening 2615, an optical sensor 2605, and/or an optical sensor 2605 receiver associated with or mapped to the first position (e.g., given that the stored data may indicate which opening or marker 2615, optical sensor 2605, and/or optical sensor 2605 receiver is associated with or mapped to each possible position of the waste-receiving system 2100). The controller 2368 can then determine a direction in which the waste-receiving system 2100 would need to travel to reach the first position from the current position (e.g., based on the stored data), and instruct the motor 2264 to move the waste-receiving system 2100 in the determined direction. The controller 2368 can monitor signals received from the optical sensor 2605 associated with the opening or marker 2615 and/or the optical sensor 2605 receiver at the first position. In response to the controller 2368 receiving a signal from the monitored optical sensor 2605 indicating that an object is detected, the controller 2368 can instruct the motor 2264 to stop moving the waste-receiving system 2100.

By using optical sensor(s) 2605 in this manner to determine a position of the waste-receiving system 2100 and/or to move the waste-receiving system 2100, the waste-receiving system 2100 can accurately move into a desired position even if an individual manually actuates the user-communication devices 2109 and moves the waste-receiving system 2100 without the controller 2368 causing the movement to occur. No matter to which position the individual moves the waste-receiving system 2100 (including if the individual moves the waste-receiving system 2100 to a position other than an open, extended, closed, or retracted position), the waste-receiving system 2100 will be able to determine a current position using the optical sensor(s) 2605. The controller 2368 can then use stored data and/or signal(s) from the optical sensor(s) 2605 to determine how to instruct the motor 2264 to move the waste-receiving system 2100 to the desired position.

FIG. 26A further illustrates an example configuration of the motor 2264 in which the motor 2264 is oriented vertically and coupled to a rear portion of the top surface of the base 2108 such that the motor 2264 is positioned behind the receptacle 2120. This configuration is an alternative to the configuration depicted in FIG. 22 in which the motor 2264 is oriented horizontally and coupled to a rear portion of the top surface of the base 2108.

In certain embodiments, the waste-receiving system 2100 can use voice recognition in conjunction with the object detection capability described above with respect to FIGS. 23, 24, 25, 26A, and 26B to determine when to move into an open, extended, closed, or retracted position. For example, the waste-receiving system 2100 may include a transducer coupled to the controller 2368. The transducer may be a microphone, such as the user-communication device 2109 or another microphone located on or near an exterior surface of the outer cover or door 2103, location on or near a surface of the mount 2150, and/or the like.

FIG. 27A illustrates an example algorithm process 2700 of controlling the position of the waste-receiving system 2100 using voice recognition. The process 2700 may be performed by the controller 2368 of the waste-receiving system 2100, as described above. The process 2700 can be implemented, in part or entirely, by a component of the controller 2368 or implemented elsewhere in the waste-receiving system 2100, for example by one or more processors executing logic or computer-executable instructions in controller 2368. In some embodiments, controller 2368 includes one or more processors in electronic communication with at least one computer-readable memory storing instructions to be executed by the at least one processor of controller 2368, where the instructions cause the waste-receiving system 2100 to implement the process 2700. The process 2700 starts at block 2702.

At block 2702, a first utterance is detected. For example, the first utterance may be detected by the microphone. The microphone may convert the detected utterance into an audio signal and transmit the audio signal to the controller 2368. The controller 2368 may perform speech recognition on the audio signal to determine one or more keywords uttered by an individual. Alternatively, the controller 2368 can transmit the audio signal to a remote system via a wired or wireless connection (e.g., via one or more cables, via a wireless transceiver that uses a Wi-Fi protocol, a Bluetooth protocol, etc.), and the remote system can perform speech recognition on the audio signal to determine one or more keywords uttered by the individual. The controller 2368 can compare an uttered keyword to a stored keyword associated with moving the waste-receiving system 2100 to an open position to determine whether the uttered keyword matches the stored keyword (e.g., if the controller 2368 performs the speech recognition or if the remote system provides the results of the speech recognition to the controller 2368 via the wired or wireless connection). Alternatively, the controller 2368 can transmit an indication of the uttered keyword(s) to the remote system, the remote system can perform the comparison, and the remote system can provide the results of the comparison to the controller 2368 (e.g., if the controller 2368 performs the speech recognition), or the remote system can perform the comparison and provide the results of the comparison to the controller 2368 (e.g., if the remote system perform the speech recognition).

At block 2704, the controller 2368 determines whether an uttered keyword matches the stored keyword associated with moving the waste-receiving system 2100 to an open position or receives results from the remote system indicating whether an uttered keyword matches the stored keyword. In response to an uttered keyword matching the stored keyword, the process 2700 moves to block 2708. In response to an uttered keyword not matching the stored keyword, the process 2700 moves to block 2706.

At block 2706, the waste-receiving system 2100 continues listening for an utterance given that the uttered keywords did not match the stored keyword associated with moving the waste-receiving system 2100 to an open position. The process 2700 then reverts back to block 2702 once a new utterance is detected. If, however, an uttered keyword matches another stored keyword associated with moving the waste-receiving system 2100 to another position, the process 2700 may execute operations that cause the movement to occur.

At block 2708, it is determined whether the waste-receiving system 2100 is currently in an open position. If the waste-receiving system 2100 is currently in an open position, the process 2700 moves to block 2712 (or block 2714). Otherwise, if the waste-receiving system 2100 is not currently in an open position, the process 2700 moves to block 2710.

At block 2710, the waste-receiving system 2100 (e.g., the receptacle 2120) is moved to an open (or extended) position. The waste-receiving system 2100 may be moved to the open (or extended) position in a manner as described herein with respect to FIGS. 23, 24, 25, 26A, and 26B. The process 2700 then moves to either block 2712 or block 2714.

Once the waste-receiving system 2100 is in the open (or extended) position, the waste-receiving system 2100 may use a timer in conjunction with signals from the proximity sensor 2505 to determine when to move the waste-receiving system 2100 to a closed or retracted position. For example, the waste-receiving system 2100 may start a timer when the waste-receiving system 2100 is moved to the open (or extended) position. At block 2712, a determination is made as to whether the timer that started when the waste-receiving system 2100 was moved to the open (or extended) position has expired. If the timer has expired, the process 2700 moves to block 2714. Otherwise, if the timer has not expired, the process 2700 reverts back to block 2712.

At block 2714, a determination is made as to whether an object is detected by the proximity sensor 2505. If an object (e.g., an individual's hand, arm, torso, head, etc.) is detected by the proximity sensor 2505, this may indicate that an individual is standing near the waste-receiving system 2100 and using the waste-receiving system 2100. Thus, the process 2700 may move to block 2716 and the timer may be reset. Once the timer is reset, the process 2700 may revert back to block 2712. Otherwise, if no object is detected by the proximity sensor 2505, this may indicate that the individual is not standing near the waste-receiving system 2100 and is no longer using the waste-receiving system 2100. Thus, the process 2700 may move to block 2718.

At block 2718, the waste-receiving system 2100 (e.g., the receptacle 2120) is moved to a closed (or retracted) position. The waste-receiving system 2100 may be moved to the closed (or retracted) position in a manner as described herein with respect to FIGS. 23, 24, 25, 26A, and 26B.

As illustrated in FIG. 27A, the process 2700 may skip block 2712. For example, instead of using a timer to determine when to check whether an individual is detected by the proximity sensor 2505, the waste-receiving system 2100 can simply monitor the signals outputted by the proximity sensor 2505 once the waste-receiving system 2100 is moved to the open (or extended) position and move the waste-receiving system 2100 to the closed (or retracted) position as soon as a signal is received from the proximity sensor 2505 indicating that an object is no longer detected.

FIG. 27B illustrates another example algorithm process 2750 of controlling the position of the waste-receiving system 2100 using voice recognition. The process 2750 may be performed by the controller 2368 of the waste-receiving system 2100, as described above. The process 2750 can be implemented, in part or entirely, by a component of the controller 2368 or implemented elsewhere in the waste-receiving system 2100, for example by one or more processors executing logic or computer-executable instructions in controller 2368. In some embodiments, controller 2368 includes one or more processors in electronic communication with at least one computer-readable memory storing instructions to be executed by the at least one processor of controller 2368, where the instructions cause the waste-receiving system 2100 to implement the process 2750. The process 2750 starts at block 2752.

At block 2752, a second utterance is detected. For example, the second utterance may be detected by the microphone. The microphone may convert the detected utterance into an audio signal and transmit the audio signal to the controller 2368. The controller 2368 may perform speech recognition on the audio signal to determine one or more keywords uttered by an individual. Alternatively, the controller 2368 can transmit the audio signal to a remote system via a wired or wireless connection (e.g., via one or more cables, via a wireless transceiver that uses a Wi-Fi protocol, a Bluetooth protocol, etc.), and the remote system can perform speech recognition on the audio signal to determine one or more keywords uttered by the individual. The controller 2368 can compare an uttered keyword to a stored keyword associated with moving the waste-receiving system 2100 to a closed position to determine whether the uttered keyword matches the stored keyword (e.g., if the controller 2368 performs the speech recognition or if the remote system provides the results of the speech recognition to the controller 2368 via the wired or wireless connection). Alternatively, the controller 2368 can transmit an indication of the uttered keyword(s) to the remote system, the remote system can perform the comparison, and the remote system can provide the results of the comparison to the controller 2368 (e.g., if the controller 2368 performs the speech recognition), or the remote system can perform the comparison and provide the results of the comparison to the controller 2368 (e.g., if the remote system perform the speech recognition).

At block 2754, the controller 2368 determines whether an uttered keyword matches the stored keyword associated with moving the waste-receiving system 2100 to a closed position or receives results from the remote system indicating whether an uttered keyword matches the stored keyword. In response to an uttered keyword matching the stored keyword, the process 2750 moves to block 2758. In response to an uttered keyword not matching the stored keyword, the process 2750 moves to block 2756.

At block 2756, the waste-receiving system 2100 continues listening for an utterance given that the uttered keywords did not match the stored keyword associated with moving the waste-receiving system 2100 to a closed position. The process 2750 then reverts back to block 2752 once a new utterance is detected. If, however, an uttered keyword matches another stored keyword associated with moving the waste-receiving system 2100 to another position, the process 2750 may execute operations that cause the movement to occur.

At block 2758, it is determined whether the waste-receiving system 2100 is currently in a closed position. If the waste-receiving system 2100 is currently in a closed position, the process 2750 moves to block 2756. Otherwise, if the waste-receiving system 2100 is not currently in a closed position, the process 2750 moves to block 2760.

At block 2760, the waste-receiving system 2100 (e.g., the receptacle 2120) is moved to a closed (or retracted) position. The waste-receiving system 2100 may be moved to the closed (or retracted) position in a manner as described herein with respect to FIGS. 23, 24, 25, 26A, and 26B.

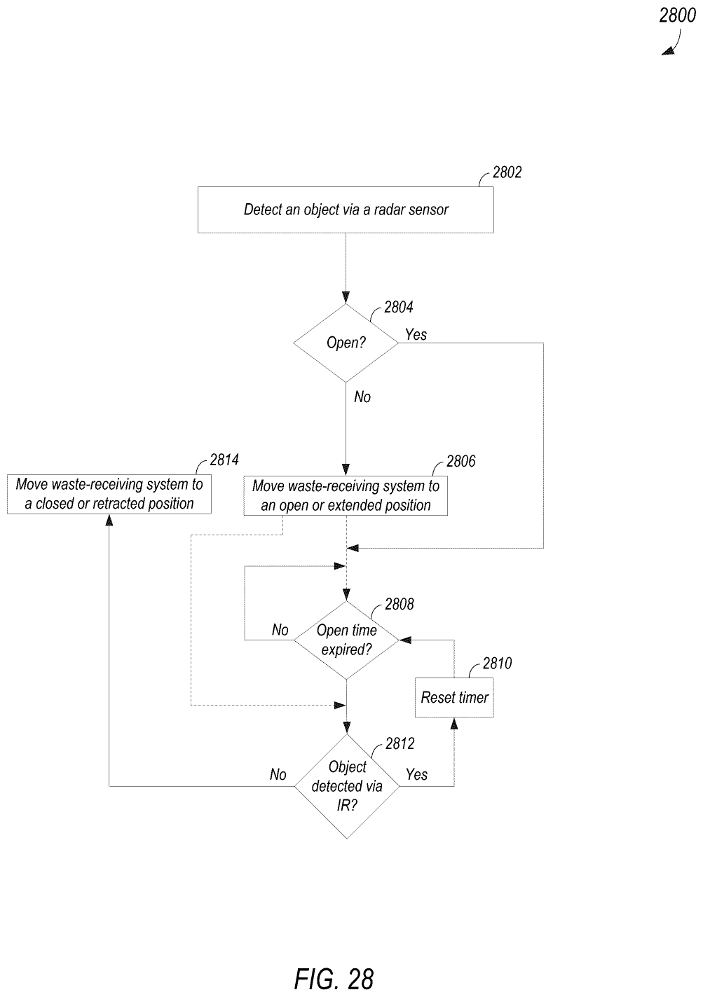

FIG. 28 illustrates an example algorithm process 2800 of controlling the position of the waste-receiving system 2100 using radar. The process 2800 may be performed by the controller 2368 of the waste-receiving system 2100, as described above. The process 2800 can be implemented, in part or entirely, by a component of the controller 2368 or implemented elsewhere in the waste-receiving system 2100, for example by one or more processors executing logic or computer-executable instructions in controller 2368. In some embodiments, controller 2368 includes one or more processors in electronic communication with at least one computer-readable memory storing instructions to be executed by the at least one processor of controller 2368, where the instructions cause the waste-receiving system 2100 to implement the process 2800. The process 2800 starts at block 2802.

At block 2802, an object is detected via a radar sensor. For example, an object like an individual's foot may be detected by the radar sensor 2395 in an open space underneath the outer cover or door 2103 when the waste-receiving system 2100 is in a closed position.

At block 2804, it is determined whether the waste-receiving system 2100 is currently in an open position. If the waste-receiving system 2100 is currently in an open position, the process 2800 moves to block 2808 (or block 2812). Otherwise, if the waste-receiving system 2100 is not currently in an open position, the process 2800 moves to block 2806.

At block 2806, the waste-receiving system 2100 is moved to an open (or extended) position. The waste-receiving system 2100 may be moved to the open (or extended) position in a manner as described herein with respect to FIGS. 23, 24, 25, 26A, and 26B. The process 2800 then moves to either block 2808 or block 2812.

Once the waste-receiving system 2100 is in the open (or extended) position, the waste-receiving system 2100 may use a timer in conjunction with signals from the proximity sensor 2505 to determine when to move the waste-receiving system 2100 to a closed or retracted position. For example, the waste-receiving system 2100 may start a timer when the waste-receiving system 2100 is moved to the open (or extended) position. At block 2808, a determination is made as to whether the timer that started when the waste-receiving system 2100 was moved to the open (or extended) position has expired. If the timer has expired, the process 2800 moves to block 2812. Otherwise, if the timer has not expired, the process 2800 reverts back to block 2808.

At block 2812, a determination is made as to whether an object is detected by the proximity sensor 2505. If an object (e.g., an individual's hand, arm, torso, head, etc.) is detected by the proximity sensor 2505, this may indicate that an individual is standing near the waste-receiving system 2100 and using the waste-receiving system 2100. Thus, the process 2800 may move to block 2810 and the timer may be reset. Once the timer is reset, the process 2800 may revert back to block 2808. Otherwise, if no object is detected by the proximity sensor 2505, this may indicate that the individual is not standing near the waste-receiving system 2100 and is no longer using the waste-receiving system 2100. Thus, the process 2800 may move to block 2814.

At block 2814, the waste-receiving system 2100 is moved to a closed (or retracted) position. The waste-receiving system 2100 may be moved to the closed (or retracted) position in a manner as described herein with respect to FIGS. 23, 24, 25, 26A, and 26B.

As illustrated in FIG. 28, the process 2800 may skip block 2808. For example, instead of using a timer to determine when to check whether an individual is detected by the proximity sensor 2505, the waste-receiving system 2100 can simply monitor the signals outputted by the proximity sensor 2505 once the waste-receiving system 2100 is moved to the open (or extended) position and move the waste-receiving system 2100 to the closed (or retracted) position as soon as a signal is received from the proximity sensor 2505 indicating that an object is no longer detected.

Thus, the waste-receiving system 2100 may use a radar sensor 2395 to detect an object in a first location (e.g., the open space) to determine whether to move into an open or extended position and may use a proximity sensor 2505 to detect an object in a second location (e.g., an area above a top surface of the outer cover or door 2103) to determine whether to move into a closed or retracted position.

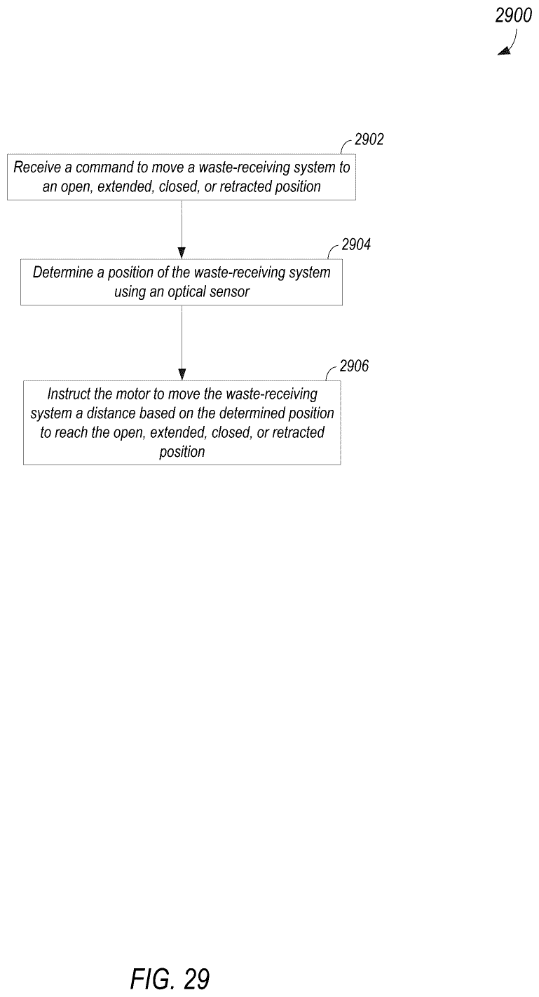

FIG. 29 illustrates an example algorithm process 2900 of controlling the position of the waste-receiving system 2100 using an optical sensor. The process 2900 may be performed by the controller 2368 of the waste-receiving system 2100, as described above. The process 2900 can be implemented, in part or entirely, by a component of the controller 2368 or implemented elsewhere in the waste-receiving system 2100, for example by one or more processors executing logic or computer-executable instructions in controller 2368. In some embodiments, controller 2368 includes one or more processors in electronic communication with at least one computer-readable memory storing instructions to be executed by the at least one processor of controller 2368, where the instructions cause the waste-receiving system 2100 to implement the process 2900. The process 2900 starts at block 2902.

At block 2902, a command is received to move a waste-receiving system to an open, extended, closed, or retracted position. For example, a command to move the waste-receiving system 2100 to an open or extended position may be received in response to an object (e.g., an individual's foot, leg, hand, etc.) being detected by the radar sensor 2395. As another example, a command to move the waste-receiving system 2100 to a closed or retracted position may be received in response to the same object or a different object (e.g., an individual's hand, arm, torso, head, leg, foot, etc.) being detected by the proximity sensor 2505. The process 2900 then moves to block 2904.

At block 2904, a position of the waste-receiving system is determined using an optical sensor. For example, an optical sensor 2605 may indicate whether an object is detected perpendicular to a particular vertical, horizontal, or lateral opening or marker 2615. In response to a first optical sensor 2605 indicating that an object is detected perpendicular to a first opening or marker 2615 and a second optical sensor 2605 that is adjacent to the first optical sensor 2605 or the first optical sensor 2605 indicating that an object is not detected perpendicular to a second opening or marker 2615 adjacent to the first opening or marker 2615, the waste-receiving system 2100 can determine its position (e.g., a rear edge of the base 2108) to be adjacent or perpendicular to the first opening or marker 2615. The waste-receiving system 2100 can optionally use stored data to determine whether the determined position corresponds to an open position, an extended position, a closed position, a retracted position, or any other position between a fully open position and a fully closed position. The waste-receiving system 2100 can use the determined position to determine a direction in which the waste-receiving system 2100 would need to move to reach the position indicated in the command and/or to determine the distance between the determined position and the position indicated in the command. The process 2900 then moves to block 2906.

At block 2906, the motor is instructed to move the waste-receiving system a distance based on the determined position to reach the open, extended, closed, or retracted position. For example, the motor 2264 can be instructed to move the waste-receiving system 2100 in the determined direction (e.g., the waste-receiving system 2100 can actuate the motor 2264 in the determined direction) until the waste-receiving system 2100 determines, via a signal provided by an optical sensor 2605 associated with the position indicated in the command, that the optical sensor 2605 detects an object perpendicular to a vertical, horizontal, or lateral opening or marker 2615 associated with the position indicated in the command (at which point the waste-receiving system 2100 may cease actuating the motor 2264). As another example, the motor 2264 can be instructed to move the waste-receiving system 2100 in the determined direction and for a set time that is calculated based on the determined distance and the RPM of the motor 2264 (e.g., the waste-receiving system 2100 can actuate the motor 2264 for the set time, at which point the waste-receiving system 2100 may cease actuating the motor 2264).

The processes 2700, 2750, 2800, and/or 2900 are not mutually exclusive and may be executed by the same waste-receiving system 2100 during a single operating session. In other words, the same waste-receiving system 2100 may be capable of moving itself in response to a voice command, detection of an object via the radar sensor 2395, detection of an object via the proximity sensor 2505, and/or subsequent to manual movement of the waste-receiving system 2100 by an individual. For example, at a first time, an individual may use voice recognition to cause the waste-receiving system 2100 to move to an open, extended, closed, or retracted position, as described with respect to processes 2700 and 2750. In order to effectuate the movement, the waste-receiving system 2100 may rely on signals output by one or more optical sensors 2605, as described with respect to process 2900. At a second time, an individual may place a foot or another object in control of the individual in the open space such that the radar sensor 2395 detects an object and causes the waste-receiving system 2100 to move to an open or extended position. In order to effectuate the movement, the waste-receiving system 2100 may rely on signals output by one or more optical sensors 2605, as described with respect to process 2900. At a third time, an individual may manually move the waste-receiving system 2100 into an open, extended, closed, retracted, or other position. The waste-receiving system 2100 may execute some or all of the process 2900 to determine a position to which the individual moved the waste-receiving system 2100. The waste-receiving system 2100 may then automatically move the waste-receiving system 2100 into another position at a later time by executing some or all of the processes 2700, 2750, and/or 2800.

### Terminology and Summary

Although the trashcan assemblies have been disclosed in the context of certain embodiments and examples, it will be understood by those skilled in the art that the present disclosure extends beyond the specifically disclosed embodiments to other alternative embodiments and/or uses of the trashcans and obvious modifications and equivalents thereof. In addition, while several variations of the trashcans have been shown and described in detail, other modifications, which are within the scope of the present disclosure, will be readily apparent to those of skill in the art. For example, a gear assembly and/or alternate torque transmission components can be included. For instance, in some embodiments, the trashcan assembly 20 includes a gear assembly. Some embodiments of the gear assembly include a gear reduction (e.g., greater than or equal to about 1:5, 1:10, 1:50, values in between, or any other gear reduction that would provide the desired characteristics), which can modify the rotational speed applied to the shaft 80, clutch member 84, and/or other components. Some embodiments are discussed above interacting with an object. The object can be a person's body or a portion thereof, something a person is wearing, holding, or manipulating, an article of the environment (e.g., furniture), or otherwise.

For expository purposes, as applicable for the context, the term “lateral” as used herein is defined as a plane generally parallel to the plane or surface of the floor of the area in which the device being described is used or the method being described is performed, regardless of its orientation. The term “floor” floor can be interchanged with the term “ground.” The term “vertical” refers to a direction perpendicular to the lateral as just defined. Terms such as “above,” “below,” “bottom,” “top,” “side,” “higher,” “lower,” “upper,” “upward,” “over,” and “under,” are defined with respect to the horizontal plane.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments.

Although certain embodiments and examples have been described herein, it will be understood by those skilled in the art that many aspects of the receptacles shown and described in the present disclosure may be differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensable.

Any of the methods and tasks described herein may be performed and fully automated by a computer system. The computer system may, in some cases, include multiple distinct computers or computing devices. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, and/or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on general purpose computer hardware, or combinations of both. To illustrate this interchangeability of hardware and software, various illustrative components, blocks, modules, and steps have been described above generally in terms of their functionality. Whether such functionality is implemented as specialized hardware versus software running on general-purpose hardware depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms executed by the controller 70 and described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor device such that the processor device can read information from, and write information to, the storage medium. In the alternative, the storage medium can be integral to the processor device. The processor device and the storage medium can reside in an A SIC. The A SIC can reside in a trashcan assembly. In the alternative, the processor device and the storage medium can reside as discrete components in a trashcan assembly.

Some embodiments have been described in connection with the accompanying drawings. The figures are drawn to scale, but such scale should not be interpreted as limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

The following is claimed:

1. A waste-receiving system comprising:
a waste receptacle;
an electric drive system comprising a motor, the drive system configured to move the waste receptacle between a retracted position within a cabinet to an extended position at least partially outside of the cabinet;
a radar sensor;
a proximity sensor; and
a processor in electronic communication with the radar sensor, the proximity sensor, and the motor, wherein computer-executable code, when executed by the processor, causes the processor to:
obtain a signal from the radar sensor indicating that an object is detected by the radar sensor;
actuate the motor to move the waste receptacle to the extended position;
determine that the proximity sensor does not detect a second object; and
actuate the motor to move the waste receptacle to the retracted position.

2. The waste-receiving system of claim 1, further comprising an outer door and a mount, wherein the mount is coupled to the outer door, the processor, and the proximity sensor.

3. The waste-receiving system of claim 2, wherein the radar sensor comprises a transmit antenna and a receive antenna, and wherein the transmit antenna is oriented to emit a signal below the outer door when the waste receptacle is in the retracted position.

4. The waste-receiving system of claim 3, further comprising a casing positioned interior to the cabinet and a base coupled to the casing, wherein the radar sensor is coupled to a front bottom surface of the base.

5. The waste-receiving system of claim 4, wherein the radar sensor is exposed to an exterior of the waste-receiving system.

6. The waste-receiving system of claim 4, further comprising a protective cover that encloses the radar sensor such that the radar sensor is hidden from view when the waste receptacle is in the retracted position.

7. The waste-receiving system of claim 2, wherein the proximity sensor comprises a transmit antenna and a receive antenna, and wherein the transmit antenna is oriented to emit a signal upward from a top surface of the mount.

8. The waste-receiving system of claim 1, further comprising a base and sliding rails coupled to the base.

9. The waste-receiving system of claim 8, wherein the sliding rails comprise an optical sensor and a marker associated with the optical sensor.

10. The waste-receiving system of claim 9, wherein the computer-executable code, when executed, further causes the processor to:
determine a current position of the waste receptacle based on a signal provided by the optical sensor; and
actuate the motor to move the waste receptacle to the extended position based on the current position.

11. The waste-receiving system of claim 10, wherein the computer-executable code, when executed, further causes the processor to:
obtain the signal from the optical sensor that indicates that a first receiver of the optical sensor detected a first reflected signal;
obtain a second signal from a second optical sensor adjacent to the optical sensor that indicates that a second receiver of the second optical sensor did not detect a second reflected signal; and
determine that the current position of the waste receptacle corresponds to a location of the marker.

12. The waste-receiving system of claim 10, wherein the computer-executable code, when executed, further causes the processor to:
obtain the signal from the optical sensor that indicates that a first receiver of the optical sensor detected a first reflected signal;
obtain a second signal from the optical sensor that indicates that a second receiver of the optical sensor that is adjacent to the first receiver and that is associated with a second marker did not detect a second reflected signal; and
determine that the current position of the waste receptacle corresponds to a location of the marker.

13. The waste-receiving system of claim 10, wherein the computer-executable code, when executed, further causes the processor to:
determine a distance between the current position and the extended position;
determine a time to reach the extended position from the current position based on the distance and a rotations per minute of the motor; and
actuate the motor for the determined time.

14. The waste-receiving system of claim 10, wherein the computer-executable code, when executed, further causes the processor to:
determine a second optical sensor associated with the extended position; and
actuate the motor until the second optical sensor provides a second signal indicating that a second object is detected by the second optical sensor.

15. The waste-receiving system of claim 1, wherein the computer-executable code, when executed, further causes the processor to determine that the waste receptacle is in the retracted position prior to actuation of the motor to move the waste receptacle to the extended position.

16. The waste-receiving system of claim 1, wherein the computer-executable code, when executed, further causes the processor to start a timer in response to actuation of the motor to move the waste receptacle to the extended position.

17. The waste-receiving system of claim 16, wherein the computer-executable code, when executed, further causes the processor to determine that the proximity sensor does not detect a second object in response to the timer expiring.

18. The waste-receiving system of claim 1, wherein the proximity sensor comprises a time-of-flight sensor.

19. The waste-receiving system of claim 1, wherein the proximity sensor comprises an infrared sensor.

20. The waste-receiving system of claim 1, wherein the object comprises a foot of an individual, and wherein the second object comprises one of a torso, a hand, or an arm of the individual.
